(19) United States
(12) Patent Application Publication
(10) Pub. No.: US 2024/0144296 A1
(43) Pub. Date: May 2, 2024

(54) METHODS, SYSTEMS, ARTICLES OF MANUFACTURE, AND APPARATUS TO PROVIDE VISUALIZATIONS OF VOLUME SHIFT ANALYSIS

(71) Applicant: Nielsen Consumer LLC, Chicago, IL (US)

(72) Inventors: Craig DeClerck, Chicago, IL (US); Todd Karmel, Smithtown, NY (US); Isabel Wang, Lincolnshire, IL (US); Alexandru Ionut Ionescu, Craiova (RO); Nathanael Daubert, Chicago, IL (US)

(21) Appl. No.: 17/977,967

(22) Filed: Oct. 31, 2022

(51) Int. Cl. G06Q 30/02; G06F 3/04842; G06F 3/04845

(52) U.S. Cl. CPC G06Q 30/0201; G06F 3/04842; G06F 3/04845

(57) ABSTRACT

Methods, apparatus, systems, and articles of manufacture are disclosed to provide data visualizations of shifting analysis. An example apparatus includes memory; machine readable instructions; and processor circuitry to at least one of instantiate or execute the machine readable instructions to generate a report based on shift analysis data that compares first market data and second market data to identify volume shift trends among products and retailers; generate a first interface based on the report for presentation to a display, the first interface including a data visualization to represent the volume shift trends among the products and the corresponding retailers; and in response to detecting a request to adjust the first interface, apply an interaction rule to generate a second interface for presentation to the display, the interaction rule based on the request.

### FIELD OF THE DISCLOSURE

This disclosure relates generally to market research and, more particularly, to methods, systems, articles of manufacture, and apparatus to provide visualizations of volume shift analysis.

### BACKGROUND

Market research entities desire to provide manufacturers and retailers with a complete picture of the complex marketplace and actionable information that companies can use to grow their businesses. To do so, market research entities collect and analyze market data to extract actionable insights for a company and provide better knowledge as to how that company pairs up against competitors and similar markets based on the market data. To provide the manufacturers and retailers with access to a rich set of analytics, some market research entities deliver such insights via visualizations representing the insights.

### BRIEF DESCRIPTION OF THE DRAWINGS

FIG. 1 is a block diagram of an example environment in which examples disclosed herein may be implemented.

FIG. 2 illustrates an example report interface corresponding to a shift analysis report interface that may be presented to a market participant in accordance with teachings of this disclosure.

FIG. 3 is a block diagram of the example interactive shift analysis circuitry of FIG. 1 constructed in accordance with teachings of this disclosure.

FIG. 4 is a block diagram of the example database engine circuitry of FIG. 1 constructed in accordance with teachings of this disclosure.

FIGS. 5-17 illustrate example implementations of an example chord chart that may be included in a report interface in accordance with teachings of this disclosure.

FIGS. 18-21 illustrate example implementations of an example net incrementality bubble chart and an example net incrementality table that may be included in a report interface in accordance with teachings of this disclosure.

FIGS. 22-28 are flowcharts representative of example machine readable instructions and/or example operations that may be executed by example processor circuitry to implement the interactive shift analysis circuitry of FIGS. 1 and 3.

FIG. 29 is a flowchart representative of example machine readable instructions and/or example operations that may be executed by example processor circuitry to implement the user interface circuitry of FIG. 1.

FIG. 30 is a block diagram of an example processing platform including processor circuitry structured to execute the example machine readable instructions and/or the example operations of FIG. 29 to implement the user interface circuitry of FIG. 1.

FIG. 31 is a block diagram of an example processing platform including processor circuitry structured to execute the example machine readable instructions and/or the example operations of FIGS. 22-28 to implement the interactive shift analysis circuitry of FIGS. 1 and 3.

FIG. 32 is a block diagram of an example implementation of the processor circuitry of FIG. 31.

FIG. 33 is a block diagram of another example implementation of the processor circuitry of FIG. 31.

FIG. 34 is a block diagram of an example software distribution platform (e.g., one or more servers) to distribute software (e.g., software corresponding to the example machine readable instructions of FIGS. 22-28 and/or FIG. 29) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. As used herein “substantially real time” refers to occurrence in a near instantaneous manner recognizing there may be real world delays for computing time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

In recent years, the need for data and analytics has risen in the retail and/or manufacturing realm due to fast paced markets and increased competition. Market data and analytics can deliver actionable insights for a company and provide better knowledge as to how that company pairs up against competitors and similar markets based on collected market data. A market research entity may store large datasets that include records related to one or more types of market data such as, but is not limited to, product-related data, purchase-related data, and consumer-related data. Analysis of the market data can allow the market research entity and/or a market participant (e.g., retailers, manufacturers, etc.) to generate actionable insights, convert the market data into business intelligence, learn more about customer habits, and/or make various management decisions based on empirical information rather than heuristics. Competitive shifting analysis (e.g., shift analysis), for example, enables a market participant(s) to identify and evaluate shifting sales volume(s) within a market(s). Competitive shifting analysis can enable the market participant to understand sources of such sales volume changes (e.g., where growth is coming from or decline is going to) and to make informed decisions on business strategies as they experience fluctuations in sales over a period of time.

The market researcher entity can rely on relatively large numbers (e.g., billions) of behavioral datapoints when formulating one or more market insights. Typically, as the number of available datapoints related to a market of interest and/or a product of interest increases, the confidence in the market predictions based on such datapoints increases. However, such large amounts of datapoints can make ascertaining insights difficult or impossible, even when the datapoints are provided in a data structure. Accordingly, the market research entity may offer access to a platform(s) (e.g., an application(s)) that provides users with a rich set of analytics through data visualizations. Data visualization as disclosed herein refers to graphical representations of data and/or other information that can help simplify complex/robust datapoints and present the data in more digestible ways. A graphical representation of complicated data can enable a market participant to diagnose problems with its business strategy and improve its approach. Data visualizations are becoming an invaluable tool for market participants because data strings are transformed into a universal language that people can understand. Data visualization tools and technologies are crucial to analyze large amounts of information to make data-driven decisions.

A desired but difficult to deliver report type includes data visualization of competitive shifting analysis between both products and retailers in a consolidated view that can depict volume shift trends across multiple items. A product as disclosed herein refers to an item or a service offered for sale while a brand refers to a product or service offered by a specific company (e.g., Charmin®, etc.). Shift analysis enables the development of targeted strategies based on sources of fluctuations in sales volumes for one or more products and/or whether such gains or losses are more significant than expected. For example, the market participant may desire to understand whether consumers are switching to/from competitive brands, increasing or decreasing overall category purchasing, and/or whether consumers are entering or leaving the category. These key insights enable informed decision-making when developing promotional, pricing, and other business strategies. In some examples, recognizing volume shift trends can translate into increased profits for a market participant, while failing to identify new volume shift trends result in catastrophic consequences for the market participant. As such, attaining effective data visualization for volume shift trends in a timely manner is a crucial part of running a successful business. However, because data visualization of competitive shifting analysis between both products and retailers is a challenging report to synthesize into a single, consolidated view, a significant gap currently exists in the ability of market participants to react.

Prior to examples disclosed herein, efficient, accurate, and cost effective competitive shifting analysis of multiple products and multiple retailers would be impractical, if not impossible. Conventional techniques for data visualization of shift analysis are one-dimensional, providing for data visualization of only product shifting or only retailer shifting. The conventional techniques are unable to illustrate volume shifting of products relative to retailers. Market participants are often forced to make sense of shifting analysis by manually examining data in large tables or by attempting to make sense of a plurality of reports, relying on human judgment to mentally aggregate the multiple reports to decipher insights. Such approaches are very tedious and time consuming, as well as inaccurate due to the large amount of data needed to generate valuable insights across a market. In some examples, the amount of data to review makes manual review of the data to generate insights impractical. These shortcomings have significantly limited market participants' ability to properly analyze competitive market shifting trends.

Methods, systems, articles of manufacture, and apparatus are disclosed herein to provide data visualization(s) of competitive shifting (e.g., switching) analysis for multiple products across multiple retailers. In particular, disclosed herein are example methods, systems, articles of manufacture, and apparatus that enable a market participant to more quickly and efficiently identify volume shifts and to differentiate between volume shifts that are healthy (e.g., normal) versus volume shifts that may need course correction. Example data visualization systems disclosed herein generate an example super shifting competitive analysis report (e.g., shift analysis report) for display to a market participant or other requestor. As disclosed herein, a market participant requestor refers to a market participant or another person or machine that requests a shift analysis report. Example shift analysis reports disclosed herein can include (but are not limited to) an example chord chart and an example net incrementality chart, which is pivotable to an example net incrementality table.

Example data visualization systems disclosed herein enable production of the example chord chart, which is a multi-dimensional data visualization that enables visual placement of products relative to retailers. Example chord charts disclosed herein provide a unique presentation of competitive shifting analysis that depicts two or more retailers, two or more products, and chords (e.g., connections, associations, mappings, chord mappings, trend lines, etc.) among the products and/or retailers representing volume shift trends (e.g., flows of sales to and/or from items). Example chord charts disclosed herein are pivotable, enabling visualization of products nested within retailers and retailers nested within products. Certain examples enable market participants to quickly and efficiently understand whether a volume shift was primarily from other products within a store, or from products being sold by competitive retailers/manufacturers.

Example chord charts disclosed herein allow for plotting of a multiple retailers and multiple products in a manner that is less reliant on specific depictions of each shift analysis datapoint by visually representing certain data by means of a visual characteristic. Example chords disclosed herein, for example, may include a visual characteristic to represent flow away from an item and/or flow towards an item. The visual characteristic can be, but is not limited to, a specific color(s), a gradient, an arrow, variation in thickness, and/or another visual indication of a direction of flow. In other words, the example chords are visualizations representing inflows and outflows of sales volumes. Certain example chord charts can exponentially increase a number of connection datapoints that can be visually examined relative to one-dimensional data visualization techniques.

Example chord charts disclosed herein are adjustable, enabling an interactive visualization of volume shift trends that allows market participants the flexibility to examine shifting trends holistically, as well as the ability to target specific gains/losses of a specific product. Examining multiple chords at once, for example, can provide the market participant with a snapshot of overall trends. Certain example chord charts include a pin functionality (e.g., feature) that enables isolation of a specific item(s) (e.g., a focus item) including isolation of example chords extending from the pinned focus item(s). Pinning a focus item enables evaluation of gains and losses only from items that compete with the focus item (herein referred to as competitive items). In some examples, the pin feature can be used to depict gains/losses (e.g., chords) for the pinned focus item relative to a specific retailer and/or relative to multiple retailers.

Certain example chord charts include a drill down feature that can be used to render additional information relative to a data point(s), such as relative to a product or a chord. In response to detecting a request to drill down into a specific item(s) (e.g., focus item), example methods, system, articles of manufacture, and apparatus disclosed herein provide a secondary chart (e.g., pop-up chart, menu) having a data visualization that identifies competitive items from which the focus item received shifting gains/losses. In some examples, the example drill down feature provides more granularity for the focus item by rendering the example pop up chart that shows actual data points corresponding to the focus item.

Certain examples include an example net-shifting/incrementality visualization that plots available product/retailer combinations in relation to their net shifting versus net incrementality metrics. Example net-shifting/incrementality visualizations disclosed herein are in the form of a bubble chart (e.g., net incrementality chart) that is pivotable (e.g., convertible) to an example sortable table (e.g., net incrementality table). In some examples, the example net incrementality chart and/or the example net incrementality table enable the market participant to identify a product(s) that is overperforming or underperforming with respect to a universe (e.g., US Food). As disclosed herein, the universe refers to stores in a country by channel (e.g., food, drug, mass merchandize, etc.), by store type (e.g., bars/pubs/cafes, convenience stores, drug stores, e-commerce, restaurants, small supermarkets, large supermarkets, etc.), or by trade type (e.g., modem trade, traditional trade, mixed trade, etc.). Certain example net incrementality charts enable presentation of information related to a specific datapoint by providing the additional information in response to detecting an input hover of the datapoint. The additional information may include net-shifting data, incrementality data, and/or total sales for that datapoint. In some examples, the additional information may be provided by the net incrementality table.

Existing technologies, systems and/or methods of analyzing market data include mining through billions of data points to find and/or otherwise calculate key insights that help market participants optimize their in-market strategies. To enable adequate data collection and analysis in a manner that satisfies statistical confidence, technological tools must be utilized in view of human limitations (e.g., mere pen and paper approaches). Accordingly, the technical field of market research is entrenched in technological tools to perform any number of analysis efforts that would make such efforts impractical for market analysts to perform on a manual basis (e.g., using human beings with pen and paper). For example, current market analysis methods generate hundreds of business intelligence (BI) reports and/or tools for a market analyst to manually review to develop a cohesive plan of action. A market analyst utilizes computational tools in an effort to apply one or more traditional BI tools relevant to an analysis effort. Despite recent improvements in computing system processing capabilities, such traditional BI tools will likely miss and/or otherwise fail to reveal hidden insights that are hidden in the BI reports.

Example shift analysis reports disclosed herein include visual components representing volume shift trends that, when combined, uniquely meet the needs of market participants. Disclosed examples plot a relatively large amount of market data for multiple products and/or retailers within a consolidated view, enabling market participant to visually understand overall volume shift trends and to drill down into specific volume shift datapoints. Example shift analysis reports disclosed herein provide a particular set of rules to automate a visualization(s) to reveal relationships that otherwise are hidden in a sea of data. Example methods, systems, articles of manufacture, and apparatus disclosed herein allow new conclusions to be drawn from data that otherwise would not be readily apparent with traditional techniques. Disclosed systems, methods, apparatus, and articles of manufacture are accordingly directed to one or more improvement(s) in the technological field of market research.

Further, traditional techniques for market shift analysis are one dimensional, requiring a computer to generate multiple reports to generate actionable insights. Example disclosed herein provide a multi-dimensional data visualization(s) that enables visual placement of products nested within retailers and retailers nesting within products with chords among the products and/or retailers representing volume shift trends. Accordingly, disclosed systems, methods, apparatus, and articles of manufacture are accordingly directed to one or more improvement(s) in the operation of a machine such as a computer or other electronic and/or mechanical device. Effects of examples disclosed herein provide improvements to the technical field of market research, and also facilitate improvements to computing resources to advance green energy initiatives.

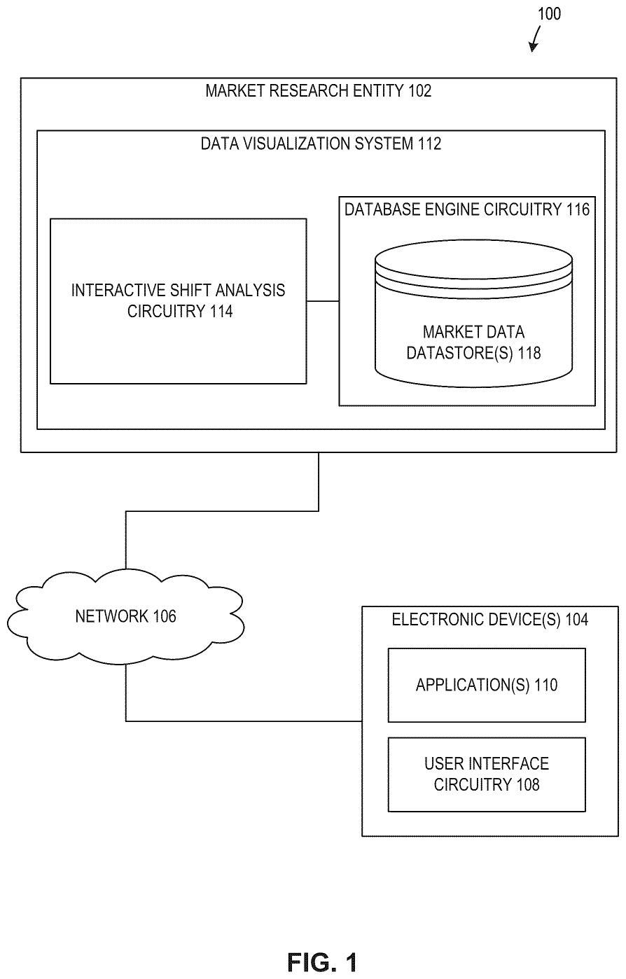

FIG. 1 is a block diagram of an example environment 100 constructed in accordance with teachings of this disclosure for providing data visualization of competitive shifting analysis. The environment 100 of FIG. 1 includes an example market research entity 102, which is an entity that collects and analyzes market data to generate actionable insights. In some examples, the market research entity 102 of FIG. 1 is implemented by one or more servers. For example, the market research entity 102 can be a physical processing center including servers. In some examples, at least some functionality of the market research entity 102 is implemented via an example cloud and/or Edge network (e.g., AWS®, etc.). For example, the market research entity 102 may include a cloud-based architecture that integrates data assets and analytics into a platform. In some examples, the market research entity 102 is absent. For example, the functionality of the market research entity 102 may implemented by any suitable device or combination of devices.

The environment 100 includes an example electronic device(s) 104, which is communicatively coupled to the market research entity 102 via an example network 106. In the example of FIG. 1, the network 106 is the Internet. However, the example network 106 may be implemented using any other network over which data can be transferred. The example network 106 may be implemented using any suitable wired and/or wireless network(s) including, for example, one or more data buses, one or more Local Area Networks (LANs), one or more wireless LANs, one or more cellular networks, one or more private networks, one or more public networks, among others. In additional or alternative examples, the network 106 is an enterprise network (e.g., within businesses, corporations, etc.), a home network, among others.

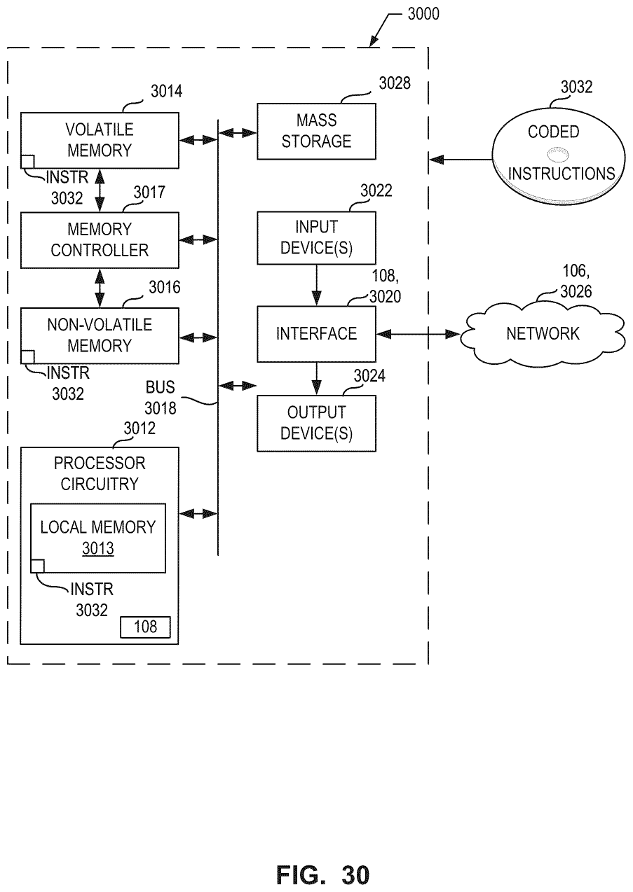

The electronic device(s) 104 of FIG. 1 is an electronic device associated with a market participant (e.g., a manufacturer, a retailer, etc.) or person(s) that desires insights related to a market of interest. The electronic device 104 can be implemented using, for example, a personal computing (PC) device (e.g., a laptop, a smartphone, an electronic tablet, a hybrid or convertible PC, etc.) that is capable of processing information (e.g., text, graphics and/or video information) to be displayed on a display device associated with the electronic device 104. In some examples, the electronic device 104 is implemented by example processor platform 3000 of FIG. 30.

The electronic device(s) 104 includes example user interface circuitry 108, which is structured to enable a user (e.g., the market participant) to interact with the electronic device 104. For example, the user interface circuitry 108 can include a graphical user interface (GUI), an application display, etc., presented to a user on a display screen in circuit with and/or otherwise in communication with the electronic device 104. In some examples, the user interface circuitry 108 enables the electronic device 104 to obtain information from the market participant and provide information to the market participant. The user interface circuitry 108 obtains information from the market participant via an example input device (e.g., input device(s) 3022 of FIG. 30) such as (but not limited to) a touchscreen, a mouse, a keyboard, and/or any other type(s) of input device. For example, the market participant may select an application to be launched, input data or requests, etc. via the input device 3022. The user interface circuitry 108 provides information to the market participant via an example output device (e.g., output device(s) 3024 of FIG. 30), such as (but not limited to) a display screen(s), a monitor(s), a projector(s), a television(s), etc. For example, the market participant may be able to view and/or interact with data visualization provided in a shift analysis report via the output device 3024.

The electronic device(s) 104 includes an example application(s) 110, which can be an application that executes on the electronic device 104. For example, the application 110 can be an application corresponding to example interactive shift analysis circuitry 114 (discussed in further detail below). In some examples, the market participant interacts with the electronic device 104 by accessing one or more applications 110 (e.g., a web browser, a word processing application, a data processing application, etc.) executed by processor circuitry (e.g., processor circuitry 3012 of FIG. 30) of the electronic device 104. The market participant can view and interact with digital content associated with the one or more applications 110 (e.g., digital images, webpages, videos, electronic documents, etc.) via the output device 3024 discussed above. In some examples, the market participant communicates with the market research entity 102 via the user interface circuitry 108 and/or the application(s) 110 of the electronic device 104.

The market research entity 102 of FIG. 1 includes an example data visualization system 112, which is structured to generate data visualizations for presentation to a market participant requestor. The data visualization system 112 is structured to process a request received from the market participant requestor(s) (e.g., via the electronic device 104), and to provide a resultant interactive visualization to the electronic device 104 for render. The data visualization system 112 can be implemented in any suitable manner. In some examples, the data visualization system 112 is implemented as an application (e.g., program, software, algorithm). In some examples, the data visualization system 112 is implemented by a service oriented architecture (SOA), which is a software architecture that enables use of loosely coupled software services/applications to support one or more requirements of, for example, a business and/or disjoint processes. The data visualization system 112 may be implemented by resources on a network (e.g., network 106 and/or another network) that may be made available as independent services to users and/or via other non-networked approaches. To implement such an SOA, software developers may construct a portal (e.g., an interface for consuming various services/applications) that utilizes or provides access to one or more other applications, thereby allowing the user(s) to retrieve results (e.g., based on queries). In some examples, the data visualization system 112 implements an example platform (e.g., platform as a service, etc.) through which market participants can request and view data visualizations. For example, the data visualization system 112 may enable market participant requestors access to granular, accurate market data alongside other business critical datasets in one platform.

The example data visualization system 112 of FIG. 1 includes example interactive shift analysis circuitry 114 and example database engine circuitry 116. The interactive shift analysis circuitry 114 is structured to generate an example shift analysis report based on a request from a market participant requestor. The shift analysis report can include shift analysis data generated from market data and an interactive report interface(s) that includes an example chord chart, an example net incrementality chart, and/or an example net incrementality table. In some examples, the interactive shift analysis circuitry 114 provides front-end prompts to present to the market participant requestor that requests information (e.g., input selection(s), user selection(s), etc.) needed to build the shift analysis report. For example, the front-end prompts request inputs regarding types of data the market participant requestor desires to view in the shift analysis report, such as (but not limited to) retailers and products, a current period and comparison period, a market, etc. Based on the input selection(s), the interactive shift analysis circuitry 114 obtains corresponding market data and/or shift analysis data from the database engine circuitry 116. The database engine circuitry 116 may process the requested data to create an example data structure of shift analysis data that the interactive shift analysis circuitry 114 uses to generate the shift analysis report. The shift analysis report may include shift analysis data, raw data on which the shift analysis data is based, and/or graphical user interface data that can be used to render a report interface to the market participant requestor (e.g., via the electronic device 104 and components thereof).

In some examples, a market participant may utilize the user interface circuitry 108 and the application(s) 110 of the electronic device 104 to access information provided by the interactive shift analysis circuitry 114. For example, the market participants requestor may utilize a web browser application 110 to request a shift analysis report from the interactive shift analysis circuitry 114. Further, the market participant requestor may interact with the shift analysis report by inputting selections via the input device 3022 and the user interface circuitry 108. The application 110 may convert the input selection to a request that is transmitted to the interactive shift analysis circuitry 114. The interactive shift analysis circuitry 114 may process the request, and provide a response to the market participant requestor via the network 106.

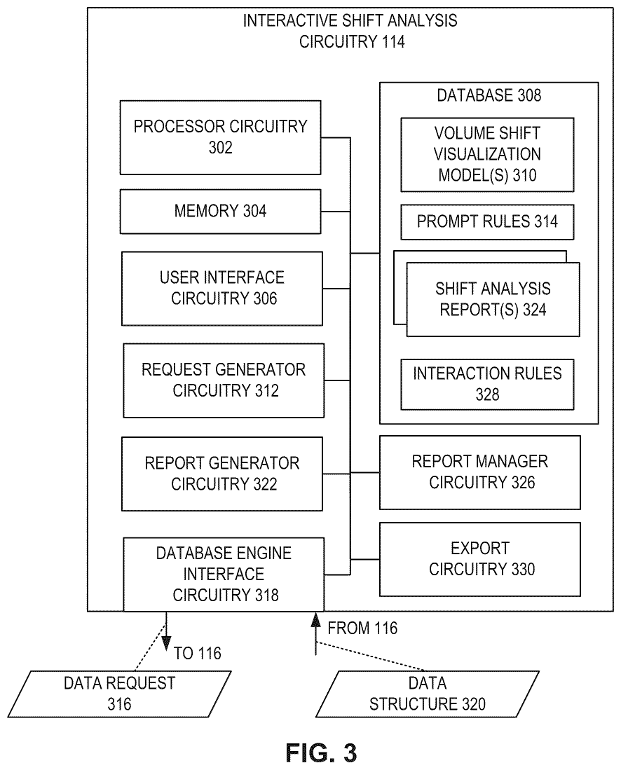

The interactive shift analysis circuitry 114 is communicatively coupled to the database engine circuitry 116, which is a data processing engine. In some examples, the database engine circuitry 116 implements a back-end aggregation system. The database engine circuitry 116 of FIG. 1 includes an example market data datastore(s) 118, which is structured to store market data. An example implementation of the interactive shift analysis circuitry 114 is also depicted in FIG. 3.

The market data stored in the market data datastore(s) 118 may include (but is not limited to) purchase-related data, product-related data, consumer-related data (e.g., consumer panel data), etc. In some examples, the market data datastore(s) 118 includes a plurality of products with corresponding details including, but not limited to, unique product codes (e.g., universal product codes (UPCs), international article numbers (EANs), etc.), product-level hierarchy information, product descriptions, market breakdown(s), total weekly sales value and units sold, distribution values, etc. In some examples, products stored in the market data datastore(s) 118 are associated with more than 5,000 product facts (e.g., characteristics, data, etc.) with detailed and enhanced data, including volume, share, distribution, price, promotion, etc.

In some examples, the market data datastore(s) 118 includes panel data from more than 250,000 households across 25 countries. Consumer panels are groups of individuals that have agreed to provide their purchase data and/or other types of data, such as demographic data, to the market research entity 102. A consumer panel member (e.g., a panelist) can record individual and/or household purchases (e.g., purchase data) from various retailers and transmit the purchase data to the marketing research entity 102 for analysis. In some examples, consumer panel data that is stored in the market data datastore(s) 118 enables UPC-level product granularity by including robust item characteristic coding. In some examples, the consumer panel data enables tracking of individual and/or household purchasing behavior over time across all purchases (e.g., products) and outlets (e.g., retailers, stores, etc.), including e-commerce. In some examples, the consumer panel data captures consumer purchases across online and offline channels to provide a complete view of changing omnichannel behaviors, enabling an understanding movements across categories, brands, and retailers. In some examples, the market data datastore(s) 118 includes analyzed and/or processed data (e.g., based on raw data that was collected from a plurality of sources).

In some examples, the market data datastore(s) 118 includes primary dimensions such as a market dimension, a product dimension, a facts dimension, and a time dimension. The primary dimensions in such examples may include sub-dimensions. The market dimension can include an indication of where purchases are made (e.g., country, region, province, city, etc.) and can be organized according to characteristics of stores within each market, such as channels, geographical areas, etc. The product dimension can include characteristics and/or attributes used to arrange products, such as product classifications (e.g., category, manufacturer, brand) and/or physical attributes of the products (e.g., segments) (e.g., size, flavor, packaging type). The facts dimension can include metrics for specific markets and periods, such as how much product is sold, value, value share, price, etc. In some examples, the facts (e.g., metrics) are captured to facilitate analysis of performance across products, markets, and/or time. The time dimension can include an indication of when a product was sold (e.g., purchased by a consumer) and data periods. Data periods indicate how frequently data is received from a source (e.g., monthly, bimonthly, weekly, etc.). In some examples, the dimensions of the market data datastore(s) 118 are organized in hierarchies, enabling data access through logical groupings.

The market data datastore(s) 118 may be a single datastore or may be implemented by any number and/or type(s) of datastores. Furthermore, the data stored in the market data datastore(s) 118 may be in any data format such as, for example, binary data, comma delimited data, tab delimited data, structured query language (SQL) structures, an executable (e.g., an executable binary, a configuration image, etc.), etc. In some examples, the market data datastore(s) 118 is implemented as a data as a service (DaaS) platform.

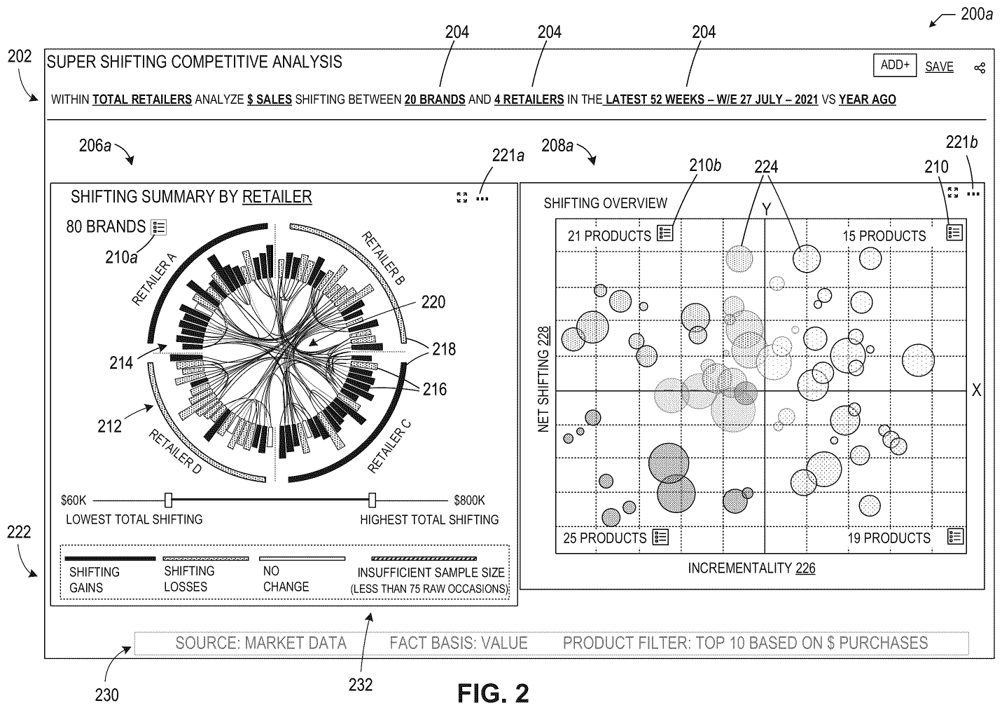

FIG. 2 illustrates an example report interface 200a corresponding to an example shift analysis report (e.g., shift analysis report 324 of FIG. 3) that may be generated by the example interactive shift analysis circuitry 114 of FIG. 1 in accordance with teachings of this disclosure. The report interface 200a is based on graphical user interface data associated with the shift analysis report 324, which may be generated using an example volume shift visualization model (e.g., example volume shift visualization model(s) 310 of FIG. 3). In some examples, report interface 200a can be adjusted based on requests from the market participant requestor. In some examples, the report interface 200a of FIG. 2 is a default user interface that is provided to the market participant requestor and can be adjusted (e.g., by the interactive shift analysis circuitry 114) based on user input selections (e.g., input selections).

The report interface 200a of FIG. 2 includes an example data summary (e.g., sentence, etc.) 202, which includes example front-end prompt selections (e.g., input selections) 204. The data summary 202 describes which market data on which the shift analysis report and the report interface 200a are based. The data summary 202 is defined by the input selections 204, which are user selections (e.g., answers, inputs) to front-end prompts generated by the interactive shift analysis circuitry 114 prior to generating the shift analysis report.

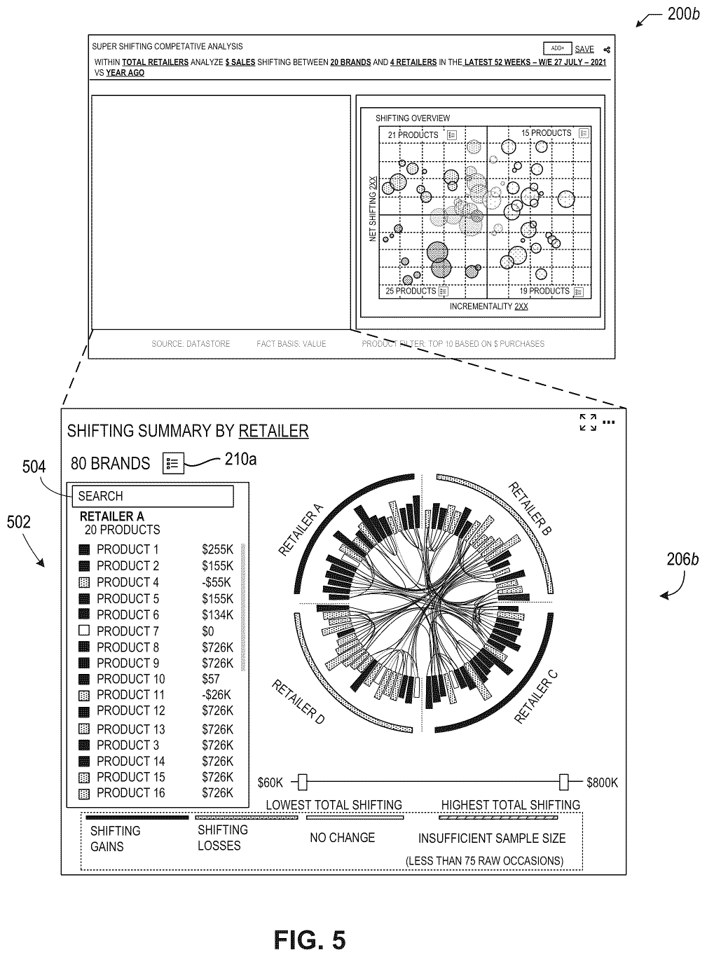

The report interface 200a of FIG. 2 includes an example chord chart 206a and an example net incrementality chart 208a. The chord chart 206a and the net incrementality chart 208a are interactive, enabling the market participant to interact with the charts 206a, 208a to view or otherwise identify additional or alternative information. For example, the market participant requestor may hover over a specific shift analysis datapoint (e.g., using the input device 3022) and, in response, the interactive shift analysis circuitry 114 may provide more granular information relative to that shift analysis datapoint. The report interface 200a includes one or more example legend request icons 210a-b, which, when selected by the market participant requestor, allows the market participant requestor to view which retailers and/or products are plotted in the chart(s) 206a, 208a. For example, in response to detecting the legend request icon 210a selection (e.g., via a request), the interactive shift analysis circuitry 114 provides a secondary visualization that includes respective retailers and/or products in the chart(s) 206a, 208a (discussed below in relation to FIG. 5).

The chord chart 206a provides an advanced data visualization(s) that enables the market participant requestor to view multiple products and retailer ships in one view to understand volume shift trends in consumer purchasing behavior. For example, a consumer(s) may consistently purchase a first product from a first retailer within a first period, but may switch to purchasing a second product that competes with the first product from a second retailer the competes with the first retailer in a subsequent period. The chord chart 206a easily enables the market participant to understand those interactions and other shifting behavior(s) between two periods in one, consolidated view. In some examples, the chord chart 206a significantly increases the usability and value of the shift analysis report 324.

The chord chart 206a of FIG. 2 includes an example outer group (e.g., level, ring, etc.) 212 and an example inner group (e.g., level, ring, etc.) 214. The inner group 214, which includes a plurality of example inner elements (e.g., bars, sections, portions, etc.) 216, is nested within the outer group 212, which includes a plurality of example outer elements 218. The chord chart 206a also includes a plurality of example chords 220. In some examples, each chord 220 connects two inner elements 216. However, the chord(s) 220 can connect more inner elements 216 in additional or alternative examples. As disclosed herein, a market entity refers to an inner element(s) 216, an outer element(s) 218, and/or a chord(s) 220.

In the illustrated example of FIG. 2, the chord chart 206a presents a retailer focused view. That is, the chord chart 206a of FIG. 2 illustrates a retailer focus that displays products nested within retailers. The outer group 212 corresponds to retailers, with the outer elements 218 representing different retailers, and the inner group 214 corresponds to products, with the inner elements 216 representing different products. The chords 220 of FIG. 2 represent inflows and/or outflows relative to the products represented by the inner elements 216. However, the chord chart 206a is pivotable to a product focus view, enabling the inner group 214 and the outer group 212 to pivot relative to one another. The report interface 200a includes one or more example pivot request icons 221a-b, which, when selected by the market participant requestor, allows the market participant requestor to pivot a chart(s) 206a, 208a. For example, in response to detecting the pivot request icon 221a selection (e.g., via a request), the interactive shift analysis circuitry 114 may pivot the chord chart 206a from a retailer focused view to a product focused view.

After a pivot of the chord chart 206a, the outer group 212 may correspond to the products, with the outer elements 218 representing the different products, and the inner group 214 may correspond to the retailers, with the inner elements 216 representing the different retailers. That is, the pivoted chord chart 206a may illustrate retailers nested within products, with the chords 220 representing inflows and/or outflows of product sales relative to the retailers represented by the inner elements 216.

As noted above, the chord(s) 220 may include a visual characteristic that represents a direct of volume change flow. In some examples, the inner elements 216 and the outer elements 218 include a visual characteristic that indicates whether the element 216, 218 experienced a shifting gain or a shifting loss. The report interface 200a includes an example legend (e.g., glossary) 222 that identifies the different visual characteristics and their corresponding meanings. In the illustrated example of FIG. 2, a solid black element 216, 218 indicates a shifting gain, a black dotted element 216, 218 indicates a shifting loss, and a solid white element 216, 218 indicates no shifting. Thus, Retailer A and Retailer C experienced a shifting gain while Retailer B and Retailer D experienced a shifting loss. In some examples, the shifting gain may be associated with a blue color while the shifting loss may be associated with an orange color (e.g., or vice versa) because blue and orange can be easier for people that are visually impaired to identify. In some examples, a chord 220 may include a first color (e.g., blue) as it extends from a first element 216, and transition to a second color (e.g., orange) as the chord 220 approaches a second element 216. For example, the blue color of the chord 220 may represent a volume shift towards the first element 216 while the orange color of the chord 220 may represent a volume shift away from the second element 216. However, it is understood that other colors, patterns, and/or other visual characteristics can be utilized in additional or alternative examples. Further, the elements 216, 218 can include similar or different characteristics relative to the chords 220.

In the illustrated example of FIG. 2, the chord chart 206a is circular in shape and includes four separate sections (e.g., quadrants). However, the chord chart 206a is not limited to such a configuration. The chord chart 206a can include any suitable shape and/or be sectioned in any suitable manner that enables nesting of products within retailers and retailers within products with trend lines identifying associations among the retailer and the products.

The report interface 200a includes the example net incrementality chart (e.g., bubble chart) 208a, which provides a volume shift overview in a bubble chart format. The net incrementality chart 208a includes a plurality of example bubbles 224 that represent different products. The bubble(s) 224 are associated with example measures of net incrementality 226 and example measures of net shifting 228, which are plotted in an example x-axis and an example y axis, respectively. As disclosed herein, incrementality refers to sales volume shifts for a retailer/product that truly add to overall revenue, rather than simply reallocating revenue from one product to another. Identifying net shifting relative to incrementality can provide a fuller picture of which products are successful in a retail setting.

The report interface 200a also includes an example footer 230, which is to identify information related to the shift analysis report. The footer 230 of FIG. 2 identifies a data source for data used to generate the shift analysis report, a fact basis on which the shift analysis report is based, and whether a product filter was utilized. However, the footer 230 can include additional or alternative information in other examples.

The report interface 200a also includes an example robustness flag 232, which is structured to alert the market participant requestor as to a level of robustness of the market data used to generate the shift analysis report. For example, the level of robustness may be based on an amount of raw occasions (e.g., occurrences) of a transaction that were identified in the market data. The robustness flag 232 enables the market participant requestor to determine whether to use the shift analysis data presented in the report interface 200a. For example, the market participant requestor provide specific front-end prompts input selections 204, which may limit an amount of market data available to generate the shift analysis report. The robustness flag 232 can alert the market participant requestor if the market data was not very robust.

In some examples, the robustness flag 232 includes a color (e.g., red, orange, yellow, etc.), a written warning (e.g., insufficient sample size, do not use data, use with caution, etc.), and/or a number of raw occasions. In some examples, a number of raw occasions between 0 and 120 corresponds to a red robustness flag 232. The red robustness flag 232 may indicate that the market participant request should not use the sample. In some examples, a number of raw occasions between 120 and 240 corresponds to an orange robustness flag 232. The orange robustness flag 232 may indicate that the market participant request should use the data with caution. In some examples, a number of raw occasions between 240 and 400 corresponds to a yellow robustness flag 232. The yellow robustness flag 232 may indicate that the market participant can use the sample with caution. In some examples, a number of raw occasions over 400 may indicate the market data is robust. In some examples, the number of raw occasions refers to a lowest raw occasion count from a first period (e.g., a current period) and a second period (e.g., a comparison period). For example, if the number of raw occasions in the first period is 70 and the number of raw occasions in the second period is 250, the number of raw occasions for the robustness flag 232 would be 70 raw occasions.

FIG. 3 is a block diagram of the example interactive shift analysis circuitry 114 of FIG. 1 constructed in accordance with teachings of this disclosure to enable visualization of volume shift trends among products and retailers in a consolidated view. The interactive shift analysis circuitry 114 of FIG. 3 may be instantiated (e.g., creating an instance of, bring into being for any length of time, materialize, implement, etc.) by processor circuitry such as a central processing unit executing instructions. Additionally or alternatively, the interactive shift analysis circuitry 114 of FIG. 3 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 3 may, thus, be instantiated at the same or different times. Some or all of the circuitry may be instantiated, for example, in one or more threads executing concurrently on hardware and/or in series on hardware. Moreover, in some examples, some or all of the circuitry of FIG. 3 may be implemented by microprocessor circuitry executing instructions to implement one or more virtual machines and/or containers.

The interactive shift analysis circuitry 114 includes example processor circuitry 302, which is structured to execute machine readable instructions (e.g., software) including, for example, user applications, an operating system, etc. The example processor circuitry 302 is a semiconductor-based hardware logic device. The processor circuitry 302 may implement a central processing unit (CPU), may include any number of cores, and may be implemented, for example, by commercially available processing circuitry. In some examples, the processor circuitry 302 is communicatively coupled to additional processing circuitry.

The interactive shift analysis circuitry 114 includes example memory 304, which is structured to store data such as (but not limited to) programs, peripheral component data, an operating system, data packets received by an application, etc. In some examples, the memory 304 can store various data to be used by the processor circuitry 302 to perform functions, such as those disclosed herein. In some examples, the memory 304 can be implemented using volatile memory device(s) such as dynamic random access memory, static random access memory, dual in-line memory module, etc. In some examples, the memory 304 is implemented using persistent memory technologies, such as memristors and phase change memory. In some examples, the memory 304 is implemented as non-volatile memory (e.g., flash memory, a hard disk drive (HDD), etc.). In some examples, the memory 304 can be one or more memory systems that include various types of computer memory.

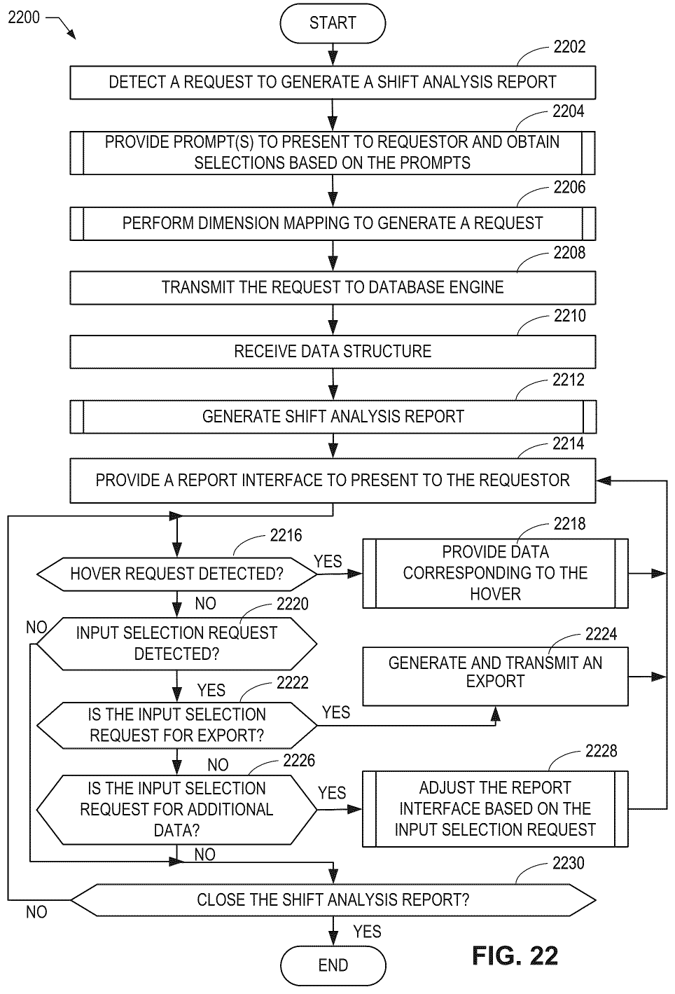

The interactive shift analysis circuitry 114 includes example user interface circuitry 306, which is structured to facilitate communication between the interactive shift analysis circuitry 114 and an electronic device (e.g., electronic device 104, etc.). In some examples, the user interface circuitry 306 is instantiated by processor circuitry executing user interface instructions and/or configured to perform operations such as those represented by the flowcharts of FIG. 22-28. In some examples, the user interface circuitry 306 of FIG. 3 implements an example application programming interface (API). For example, the user interface circuitry 306 may be an example representational state transfer (REST) API. The user interface circuitry 306 may be used receive requests from a market participant requestor (e.g., via the electronic device 104) and/or transmit data to the market participant requestor for rendering on the electronic device 104. As disclosed herein, providing data (e.g., a front-end prompt, a report interface, a secondary visual, etc.) to the market participant requestor refers to transmitting a data packet corresponding to the data for presentation to a display (e.g., at the electronic device 104). In some examples, providing the data includes generating the data.

The interactive shift analysis circuitry 114 includes an example database 308, which is structured to store data such as (but not limited to) data visualization models, rules, instructions, etc. For examples, the database 308 can be used to store example volume shift visualization model(s) 310 that can be used to generate a shift analysis report (e.g., shift analysis report 324). The example database 308 can be implemented by any memor(ies), storage device(s) and/or storage disc(s) for storing data such as, for example, flash memory, magnetic media, optical media, etc. Furthermore, the data stored in the database 308 may be in any data format such as, for example, binary data, comma delimited data, tab delimited data, SQL structures, image data, etc.

The interactive shift analysis circuitry 114 includes example request generator circuitry 312, which is structured to obtain information from a market participant requestor and generate a data request based on the information. In some examples, the request generator circuitry 312 is instantiated by processor circuitry executing request generator instructions and/or configured to perform operations such as those represented by the flowchart of FIGS. 22-24. The request generator circuitry 312 of FIG. 3 is structured to provide a prompt(s) (e.g., information prompt(s), front-end prompt, etc.) for exposure to the market participant requestor and to obtain input selections that define which market data to include in the shift analysis report 324. The front-end prompts may include information needed to populate the example volume shift visualization model(s) 310, such as (but are not limited to) a geography, a demographic, a fact, comparison periods, products, and retailers. In some examples, the request generator circuitry 312 implements a front-end prompt system.

The request generator circuitry 312 is structured to perform dimension mapping to map the front-end prompts to respective dimensions within the market data datastore(s) 118 of the database engine circuitry 116 (e.g., the back-end aggregation system). That is, the request generator circuitry 312 identifies interactions between a front end (e.g., front end prompt system) and a back end (e.g., the back-end aggregation system) by mapping the front-end prompts to respective back-end prompts used in a back-end aggregation system. In some examples, the mapping is between front-end terminology and back-end terminology, enabling shift analysis data returned on the front end to be aligned with market participant requestor expectations. Table 1, below, illustrates example dimension mapping between the front-end terminology and the back-end terminology. In Table 1, prompt name refers to the front-end terminology and source of prompt refers to the back-end terminology.

TABLE 1
Dimension Mapping

| PROMPT NAME | SOURCE OF PROMPT |
|---|---|
| Shifting Universe | Total Line (Issue) |
| Product(s) | Product(s) |
| Retailer(s) | Outlet(s) |
| Geography(ies) | Market(s) |
| Demographic(s) | Demo Group(s) |
| Fact(s) | Fact(s) |
| Cycle | Period(s) |

In some examples, the request generator circuitry 312 utilizes example prompt rules 314 during a front-end prompt process. The prompt rules 314 may define types of information needed to implement the volume shift visualization model(s) 310, define rules for the front-end prompts, and/or define dimension mapping to a back-end aggregation system. For example, each front-end prompt may include a single selection or allow for multiple selections, which may be defined in the prompt rules 314. In some examples, the prompt rules 314 indicate whether a front-end prompt includes a maximum number of allowable selections. In some examples, one or more front-end prompts may be open prompts, enabling access to a full dimension in the market data datastore(s) 118. In some examples, one or more front end prompts may be closed prompts, leaving the market participant requestor with restricted utility in making selections. In some examples, the prompt rules 314 indicate whether a front-end prompt is an open prompt or a closed prompt.

The interactive shift analysis circuitry 114 includes example database engine interface circuitry 318. The database engine interface circuitry 318 of FIG. 3 is structured to facilitate communication between the interactive shift analysis circuitry 114 and the example database engine circuitry 116 of FIG. 1. In some examples, the database engine interface circuitry 318 enables the request generator circuitry 312 to communicate with the database engine circuitry 116 and/or the market data datastore(s) 118. For example, the database engine interface circuitry 318 may enable the request generator circuitry 312 to query the market data datastore(s) 118 during the front-end prompt process.

The request generator circuitry 312 may provide a shifting universe prompt that prompts the market participant requestor to select a pivotable shifting universe. The shifting universe prompt defines a total category on which to base the competitive shifting analysis and is needed to correctly determine an “All Other Products” line. The shifting universe prompt is an open, single selection prompt that allows the market participant requestor to select a retailer focus (e.g., retail shifting, shifting universe retailer, etc.) or a product focus (e.g., brand shifting, shifting universe product). In some examples, if the input selection for the shifting universe prompt is a retailer, the data visualization will be based on an example retail shifting focus model that provides an example retail shifting focus view that is pivotable to an example product shifting focus view. In some examples, if the input selection for the shifting universe prompt is a product, the data visualization will be based on a product shifting focus model that provides an example product shifting focus view that is pivotable to a retail shifting focus view.

The request generator circuitry 312 may provide a comparison prompt, a focus prompt, and either a product prompt or a retailer prompt, which may be dictated by the input selection for the shifting universe prompt. For example, if a retailer focus is selected for the shifting universe, the request generator circuitry 312 may provide a comparison retailer prompt, a focus retailer prompt, and a product prompt. The comparison retailer prompt may be an open, multi-selection prompt that requests one or more mutually exclusive retailers of interest. The retailer focus prompt may be a closed, single selection prompt based on the input selections to the comparison retailer prompt. The product prompt may be an open-multi selection prompt that allows to the market participant to select one or more products.

On the other hand, if a product focus is selected for the shifting universe, the request generator circuitry 312 may provide a comparison product prompt, a focus product prompt, and a retailer prompt. The comparison product prompt may be an open, multi-selection prompt that requests one or more mutually exclusive product of interest. The product focus prompt may be a closed, single selection prompt based on users selections to the comparison product prompt. The retailer prompt may be an open-multi selection prompt that allows to the market participant to select one or more retailers.

The request generator circuitry 312 may map the shifting universe prompt to a total line dimension in a market dimension of the back-end aggregation system. That is, the shifting universe on the front end may be referred to as the total line at the back end. The total line may refer to a total line for a product (e.g., total cola sales) if a product focus is selected or to a total line for a retailer (e.g., total outlet) if a retailer focus is selected. The request generator circuitry 312 may map the comparison prompt and the focus prompt to a “to product” dimension in the back-end aggregation system. The request generator circuitry 312 may map the retailer prompt to an outlet dimension in the back-end aggregation system and the product prompt to a product dimension in the back-end aggregation system. In some examples, the retailer and product dimensions are combined to form product/retailer product lines. Purchase data used to populate the shift analysis report 324 may be limited to the input selections made within the front-end prompts. For example, is a user chooses Retailer A and Retailer B, a scope of transactions may be limited to only transaction made within Retailer A and Retailer B.

The request generator circuitry 312 may provide a geography prompt that prompts the market participant requestor to select a geography (e.g., a geographical area). The geography prompt may be an open, single selection prompt that allows a market participant to select a geography of interest, such as (but not limited to) a country (e.g., the U.S.), a specific geographic area (e.g., Midwest), etc. In some examples, the geography prompt may include a default selection (e.g., U.S. total) that can be changed by the market participant requestor. The request generator circuitry 312 may map the geography(ies) to a market(s) in a market dimension of the back-end aggregation system. That is, the geography prompt name on the front end may refer to a market at the back end.

The request generator circuitry 312 may provide a demographic prompt that prompts the market participant requestor to select a demographic corresponding to a panel or panel member(s). The demographic prompt may be an open, single selection prompt that allows a market participant to select a demographic. In some examples, the demographic prompt may include a default selection (e.g., total panel) that can be changed by the market participant requestor. The request generator circuitry 312 may map the demographic(s) to a demo group in a panel dimension of the back-end aggregation system. That is, the demographic prompt name on the front end may refer to a demographic and/or demo group at the back end.

The request generator circuitry 312 may provide a fact prompt that prompts the market participant requestor to select a fact of interest. The fact prompt may be a closed, single selection prompt that allows a market participant to select a fact of interest from a static list of facts. For example, the fact may include (but is not limited to) value, volume, units, units (multi), etc. In some examples, the fact prompt may include a default selection (e.g., value). The request generator circuitry 312 may map the fact(s) to a fact dimension in the back-end aggregation system.

The request generator circuitry 312 may provide a cycle prompt that prompts the market participant requestor to select two periods of time for comparison. For example, the period of time can refer to a quarter, a year, and/or another period of time. The geography prompt is an open, mutli-selection prompt that allows a market participant requestor to select a current period and a comparison period. In some examples, the two periods cannot overlap. For example, the current period may be a most-recent year (e.g., 52 weeks) while the comparison period may be a year prior to the most-recent year. In some examples, the cycle prompt may include a message that suggests a comparison period be greater than 26 weeks. In some examples, the two periods need to be equal in length. In some examples, the cycle prompt may include a default selection (e.g., latest year versus a preceding year) that can be changed by the market participant requestor. The request generator circuitry 312 may map the cycle to a two periods in a time dimension in the back-end aggregation system.

In some examples, the request generator circuitry 312 renders the front-end prompts in the form of a Madlib. In some examples, the input selections are used to fill the Madlib, which generates an example data summary (e.g., data summary 202 of FIG. 2). For example, the Madlib selections may include [Shifting Universe], [Product], [Retailer], [Fact], and [Period], and/or [Geography]. Table 2, below, illustrates example Madlibs that may be used to generate the example data summary 202 based on the input selections to the front-end prompts.

TABLE 2
Example Madlibs for Data Summaries

| | |
|---|---|
| Brand Shifting | Within [Shifting universe] analyze [fact] shifting |
| | between [product] for [Retailer] in the [Current |
| | period] vs [Comparison period] |
| Retail Shifting | Within [Shifting universe] analyze [fact] shifting |
| | between [Retailer] for [Product] in the [Current |
| | period] vs [Comparison period] |

An example data summary for super shifting competitive analysis may read: “Within Total Retailers analyze $ Sales shifting between 20 Brands and 4 retailers in the Latest 52 weeks—W/E 27 Jul. 2021 vs. Year ago” where W/E refers to “week ending.”

Based on the input selections, the request generator circuitry 312 generates an example data request 316 by mapping the front end prompts to dimensions and terminology used in the database engine circuitry 116 of FIG. 1. The data request 316 may be written or otherwise developed by the request generator circuitry 312 based on the input selections to the front-end prompts and includes, for example, a shifting universe model on which to base the data request 316, product identifiers, retail identifiers, a market identifier, a demographic of interest, and two periods of time from which to retrieve market data. The request generator circuitry 312 may transmit the data request 316 to the database engine circuitry 116 via the database engine interface circuitry 318. Further, the interactive shift analysis circuitry 114 may receive an example data structure 320 that includes shift analysis data from the database engine circuitry 116 via the database engine interface circuitry 318. For example, the data structure 320 may be a data cube, but can be another data structure(s) in additional or alternative examples.

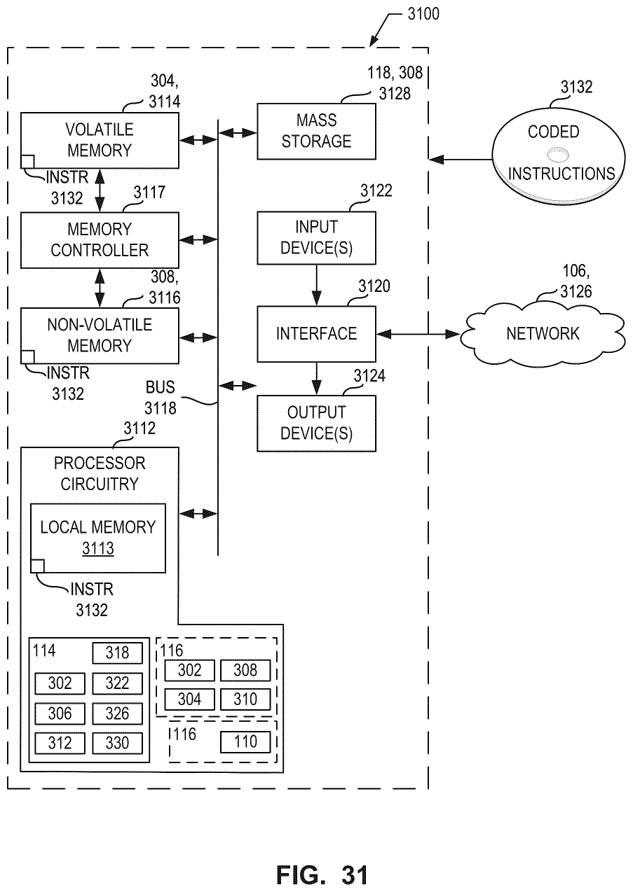

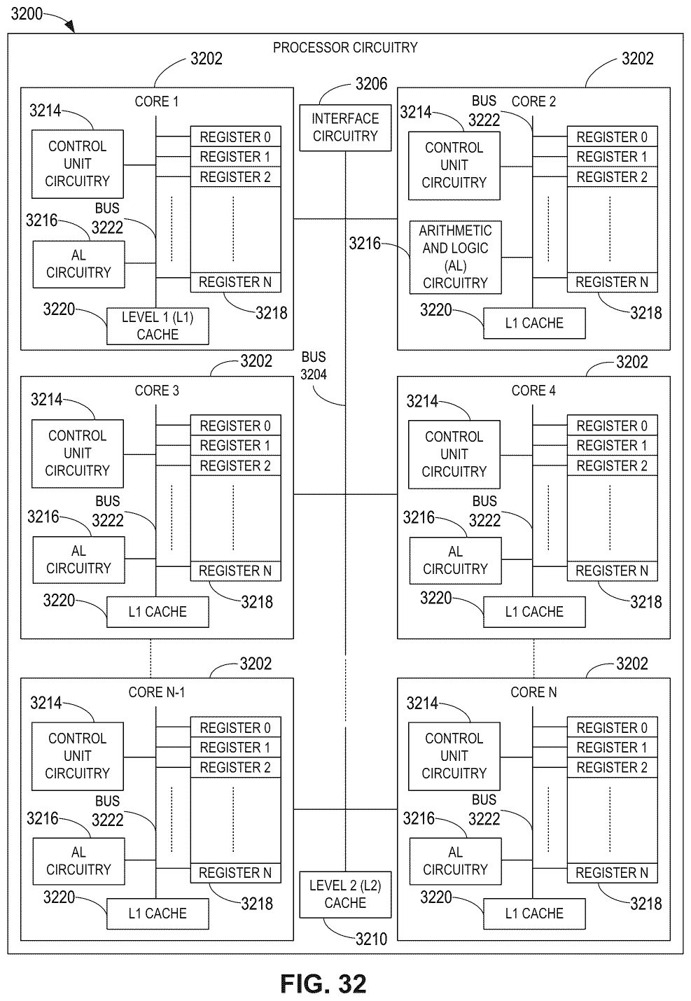

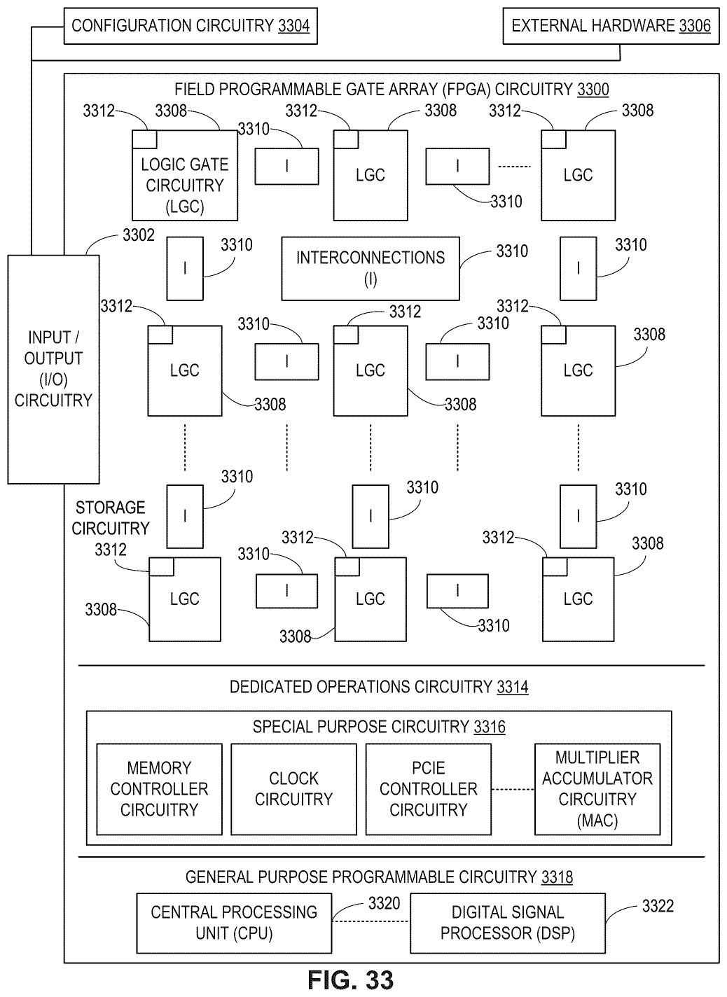

In some examples, the interactive shift analysis circuitry 114 includes means for obtaining shift analysis data. For example, the means for obtaining shift analysis data may be implemented by request generator circuitry 312. In some examples, the request generator circuitry 312 may be instantiated by processor circuitry such as the example processor circuitry 3112 of FIG. 31. For instance, the request generator circuitry 312 may be instantiated by the example microprocessor 3200 of FIG. 32 executing machine executable instructions such as those implemented by at least blocks 2204-2210, 2302-2340, 2402-2422 of FIGS. 22-24. In some examples, the request generator circuitry 312 may be instantiated by hardware logic circuitry, which may be implemented by an ASIC, XPU, or the FPGA circuitry 3300 of FIG. 33 structured to perform operations corresponding to the machine readable instructions. Additionally or alternatively, the request generator circuitry 312 may be instantiated by any other combination of hardware, software, and/or firmware. For example, the request generator circuitry 312 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

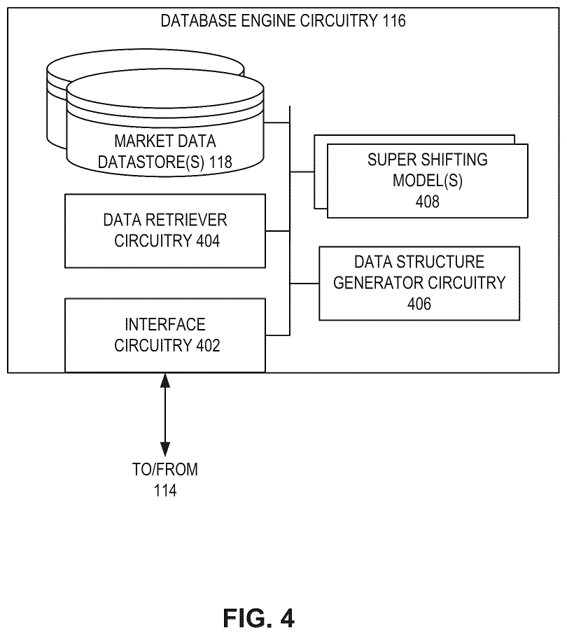

FIG. 4 is a block diagram of the example database engine circuitry 116 of FIG. 1 structured in accordance with teachings of this disclosure to generate a data structure. The database engine circuitry 116 of FIG. 4 may be instantiated by processor circuitry such as a CPU executing instructions. Additionally or alternatively, the database engine circuitry 116 of FIG. 4 may be instantiated by an ASIC or an FPGA structured to perform operations corresponding to the instructions. It should be understood that some or all of the circuitry of FIG. 4 may, thus, be instantiated at the same or different times. Some or all of the circuitry may be instantiated, for example, in one or more threads executing concurrently on hardware and/or in series on hardware. Moreover, in some examples, some or all of the circuitry of FIG. 4 may be implemented by microprocessor circuitry executing instructions to implement one or more virtual machines and/or containers.

In some examples, the database engine circuitry 116 is implemented by the example processor platform 3000 of FIG. 30. In some examples, the database engine circuitry 116 is implemented as a client-server relationship in which the database engine circuitry 116 exports data from the market data datastore(s) 118 for analysis. The database engine circuitry 116 includes example interface circuitry 402, which is structured to obtain an example data request (e.g., data request 316) from the interactive shift analysis circuitry 114 (e.g., and/or the electronic device 104) and to generate an example data structure (e.g., data structure 320) based on the data request 316.

The database engine circuitry 116 includes example data retriever circuitry 404, which is structured to access data from the market data datastore(s) 118. In some examples, the data retriever circuitry 404 includes means for obtaining data (sometimes referred to herein as data obtaining means). The data retriever circuitry 404 of FIG. 4 is structured to receive the data request 316 and to retrieve market data from the market data datastore(s) 118 based on the data request 316. In some examples, the data retriever circuitry 404 harmonizes, normalizes and/or otherwise formats the market data accessed from the market data datastore(s) 118. For example, the data retriever circuitry 404 may deduplicate the market data obtained from the market data datastore(s) 118.

The database engine circuitry 116 includes example data structure generator circuitry 406, which is structured to generate an example data structure 320. In some examples, the market data retrieved by the data retriever circuitry 404 are provided as inputs to an example shift analysis model(s) 408. The shift analysis model(s) 408 processes these inputs to generate shift analysis data. In some examples, the data structure generator circuitry 410 generates the data structure 320 by arranging the shift analysis data output by the shift analysis model(s) 408 into a structured format. In some examples, the shift analysis model(s) 408 enables structuring of the retrieved market data into tables and/or other data structures and describes relationships between the tables and/or other data structures. In some examples, the data structure generator circuitry 410 and/or the shift analysis model(s) 408 arrange the shift analysis data in a data cube. The data cube refers to a multi-dimensional data structure that includes arrays of values. That is, the data structure generator circuitry 406 obtains raw data, performs computations to generate shift analysis data, and structures the shift analysis in an organized format. In doing so, the interactive shift analysis circuitry 114 can query the shift analysis data instead of querying the database engine circuitry 116 to compute the shift analysis data from scratch each time.

Data cubes arrange relevant information together, such as storing sales of specific products at different store locations over some period of time. Such an arrangement allows for more flexible analysis, such as identifying trends about a specific product or evaluating store performance. The data cube may include metrics (e.g., types of shift analysis data) that include one or more commonly accessed dimensions. The data cube can include 2 or more dimensions having equal or unequal lengths. It is understood, however, that the shift analysis data can be structured in any suitable format or combination of formation in additional or alternative examples, such as (but not limited to) tables, matrices, hierarchies, lists, graphs, and/or trees.

While an example manner of implementing the database engine circuitry 116 of FIG. 1 is illustrated in FIG. 4, one or more of the elements, processes, and/or devices illustrated in FIG. 4 may be combined, divided, re-arranged, omitted, eliminated, and/or implemented in any other way. Further, the example interface circuitry 402, the example data retriever circuitry 404, the example data structure generator circuitry 406, and/or, more generally, the example database engine circuitry 116 of FIG. 1, may be implemented by hardware alone or by hardware in combination with software and/or firmware. Thus, for example, any of the example interface circuitry 402, the example data retriever circuitry 404, the example data structure generator circuitry 406, and/or, more generally, the example database engine circuitry 116, could be implemented by processor circuitry, analog circuit(s), digital circuit(s), logic circuit(s), programmable processor(s), programmable microcontroller(s), GPU(s), DSP(s), ASIC(s), programmable logic device(s) (PLD(s)), and/or field programmable logic device(s) (FPLD(s)) such as FPGAs. Further still, the example database engine circuitry 116 of FIG. 1 may include one or more elements, processes, and/or devices in addition to, or instead of, those illustrated in FIG. 4, and/or may include more than one of any or all of the illustrated elements, processes and devices.

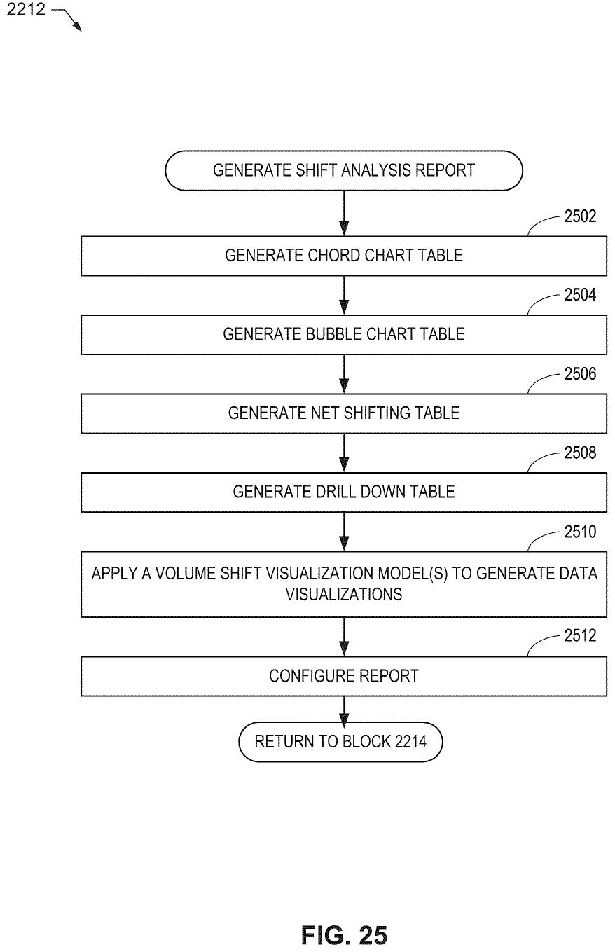

Referring again to FIG. 3, the interactive shift analysis circuitry 114 includes example report generator circuitry 322, which is structured to generate an example shift analysis report 324. In some examples, the report generator circuitry 322 is instantiated by processor circuitry executing report generator instructions and/or configured to perform operations such as those represented by the flowchart of FIGS. 22 and 25. The report generator circuitry 322 may obtain the data structure 320 that includes the shift analysis data. In some examples, the report generator circuitry 322 identifies, for each of the visualizations (e.g., the chord chart 206a, the net incrementality chart 208a, etc.), specifications (e.g., dimensions, facts, fact specifications) needed to generate the respective visualizations. The specifications may include (but are not limited to) what the specification is to be named in the chart 206a, 208a, etc., a corresponding back end fact identifier for the specification, and what is a number format for the specification. In some examples, the specifications may differ based on the input selection to the fact prompt. Tables 3-5, below, illustrate tables that include example specifications, including name in report absolute (e.g., abs.) change, and format of absolute change. In particular, table 3 illustrates example specifications for an example chord chart 206a.

TABLE 3
Chord Chart Specifications Table

| | | |
|---|---|---|
| Name in | | Format - |
| Report | Abs. change | abs. change |

Value selected as Fact

| | | |
|---|---|---|
| Net | shifting_value_net_peri- | $####,#### |
| Shifting | od_shifting_total_o | |

Volume selected as Fact

| | | |
|---|---|---|
| Net | shifting_volume_net_peri- | ####,#### |
| Shifting | od_shifting_total_o | |

Units selected as Fact

| | | |
|---|---|---|
| Net | shifting_units_net_peri- | ####,#### |
| Shifting | od_shifting_total_o | |

Units Multi selected as Fact

| | | |
|---|---|---|
| Net | shifting_unit_multi_net_peri- | ####,#### |
| Shifting | od_shifting_total_o | |

Table 4 illustrates example specifications for an example net incrementality chart and/or an example net incrementality table.

TABLE 4
Bubble Chart and Net Shifting Table Specifications Table

| | | |
|---|---|---|
| Name in | | Format - |
| Report | Abs. change | abs. change |

Value selected as Fact

| | | |
|---|---|---|
| Net Shifting | shifting_value_net_period_shifting_total_o | $####,#### |
| Incrementality | shifting_value_net_change_incrementality | $####,#### |
| Total Sales | shifting_value_gains_grand_total_o | $####,#### |

Volume

| | | |
|---|---|---|
| Net Shifting | shifting_volume_net_period_shifting_total_o | ####,#### |
| Incrementality | shifting_volume_net_change_incrementality | ####,#### |
| Total Sales | shifting_volume_gains_grand_total_o | ####,#### |

Units

| | | |
|---|---|---|
| Net Shifting | shifting_units_net_period_shifting_total_o | ####,#### |
| Incrementality | shifting_units_net_change_incrementality | ####,#### |
| Total Sales | shifting_units_gains_grand_total_o | ####,#### |

Units Multi

| | | |
|---|---|---|
| Net Shifting | shifting_unit_multi_net_period_shifting_total_o | ####,#### |
| Incrementality | shifting_units_multi_net_change_incrementality | ####,#### |
| Total Sales | shifting_units_multi_gains_grand_total_o | ####,#### |

Table 5 illustrates example specifications for an example drill down legend.

TABLE 5
Drill Down Specifications Table

| | | |
|---|---|---|
| Name in | | Format - |
| Report | Abs. change | abs. change |

Value selected as Fact

| | | |
|---|---|---|
| Net | shifting_value_net_peri- | $####,#### |
| Shifting | od_shifting_total_o | |

Volume selected as Fact

| | | |
|---|---|---|
| Net | shifting_volume_net_peri- | ####,#### |
| Shifting | od_shifting_total_o | |

Units selected as Fact

| | | |
|---|---|---|
| Net | shifting_units_net_peri- | ####,#### |
| Shifting | od_shifting_total_o | |

Units Multi selected as Fact

| | | |
|---|---|---|
| Net | shifting_unit_multi_net_peri- | ####,#### |
| Shifting | od_shifting_total_o | |

The report generator circuitry 322 may generate the shift analysis report 324 by populating specifications tables using data from the data structure 320. In some examples, the report generator circuitry 322 applies data from the data structure 320 and/or the specification tables as inputs to one or more volume shift visualization model(s) 310. It is noted that the specifications tables can be different in additional or alternative examples depending on the shift analysis report 324 and/or the volume shift visualization model(s) 310. The consumer volume shift visualization model(s) 310 processes these inputs to generate the shift analysis report 324 that includes (but is not limited to) shift analysis data, graphical interface data, and/or an example interaction rule(s) (e.g., interaction rule(s) 328, discussed below). In some examples, the chord chart specifications may include a consistent delimiter between products and retailers to allow segmentation of product lines into retailers versus product groupings. In some examples, the report generator circuitry 322 may generate the shift analysis report 324 and a first (e.g., default) report interface (e.g., report interface 200a of FIG. 2).

In some examples, the interactive shift analysis circuitry 114 includes means for generating a shift analysis report that includes graphical user interface data that can be used to render a report interface to the market participant requestor. For example, the means for generating a shift analysis report may be implemented by report generator circuitry 322. In some examples, the report generator circuitry 322 may be instantiated by processor circuitry such as the example processor circuitry 3112 of FIG. 31. For instance, the report generator circuitry 322 may be instantiated by the example microprocessor 3200 of FIG. 32 executing machine executable instructions such as those implemented by at least blocks 2212, 2502-2512 of FIGS. 22 and 25. In some examples, the report generator circuitry 322 may be instantiated by hardware logic circuitry, which may be implemented by an ASIC, XPU, or the FPGA circuitry 3300 of FIG. 33 structured to perform operations corresponding to the machine readable instructions. Additionally or alternatively, the report generator circuitry 322 may be instantiated by any other combination of hardware, software, and/or firmware. For example, the report generator circuitry 322 may be implemented by at least one or more hardware circuits (e.g., processor circuitry, discrete and/or integrated analog and/or digital circuitry, an FPGA, an ASIC, an XPU, a comparator, an op-amp, a logic circuit, etc.) structured to execute some or all of the machine readable instructions and/or to perform some or all of the operations corresponding to the machine readable instructions without executing software or firmware, but other structures are likewise appropriate.

Based at least in part on the amount of information provided by the shift analysis report 324, data visualizations in an example report interface 200a can be visually intense. To increase its usability, the shift analysis report 324 is adjustable (e.g., interactive) to allow the market participant requestor to view the shift analysis report 324 in a manner that is more palatable to a specific individual or group of individuals. Accordingly, the interactive shift analysis circuitry 114 includes example report manager circuitry 326, which is structured to adjust graphical user interface data corresponding to a first report interface (e.g., report interface 200a of FIG. 2) to generate a second report interface (e.g., report interface 200b of FIG. 5).

The database 308 of FIG. 3 includes the example interaction rule(s) 328, which include a set(s) of rules that define functions provided by a report interface (e.g., report interface 200a-r) and/or the shift analysis report 324. The interaction rule(s) 328 determine a response output by the report manager circuitry 326 in response to a request corresponding to an input selection caused by the market participant requestor. For example, the interaction rule(s) 328 may map a input selection point and/or icon within a report interface 200a-r to a corresponding adjustment needed to generate another report interface 200a-r. In some examples, the interaction rule(s) 328 are used to build corresponding interaction rule(s) 328 into the shift analysis report 324 and/or the report interface 200a-r. In some examples, the report manager circuitry 326 uses the interaction rule(s) 328 to process a request caused by the market participant requestor.

In some examples, the report interface 200a-r, the shift analysis report 324, and/or one or more interaction rule(s) 328 are transmitted to the electronic device 104 for presentation to the market participant requestor. In some such examples, the electronic device 104 and/or an application 110 thereon may be tasked with managing the report interface 200a. In some examples, only the report interface 200a-r is transmitted to the electronic device 104 for presentation to the market participant requestor. In some examples, the generated shift analysis report(s) 324 may be stored in the database 308 and/or in the memory 304. For example, the shift analysis report 324 may be stored in the database 308, which the report manager circuitry 326 may retrieve in response to detecting a request to adjust the report interface 200a-r. The report manager circuitry 326 may adjust the graphical user interface data based on the shift analysis report 324 in response to detection of a request from the market participant requestor to provide another report interface 200a-r.

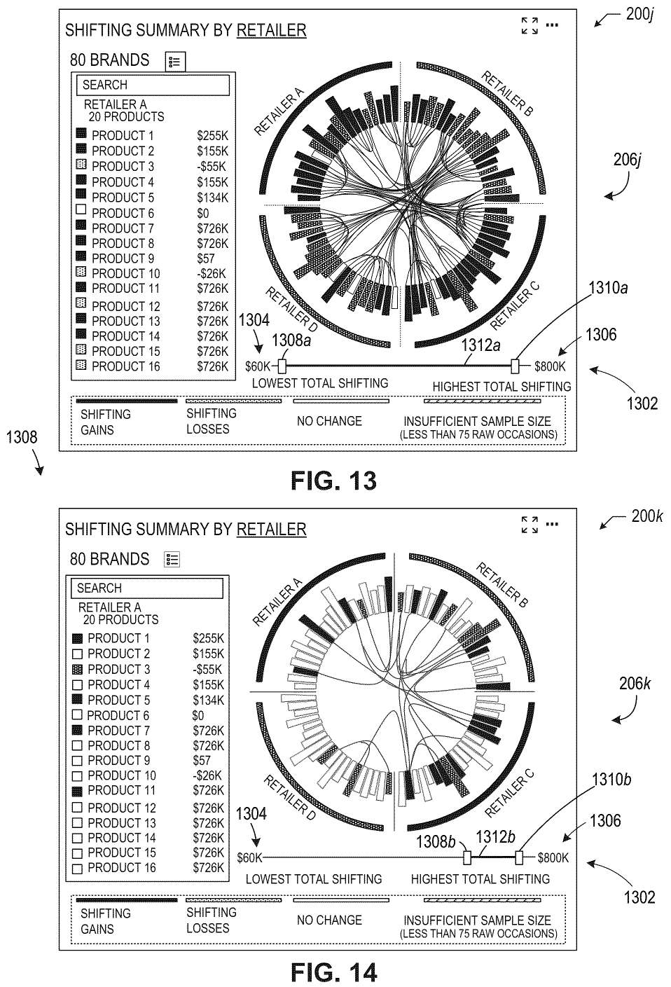

In some examples, the market participant requestor can view additional information about a specific product(s) and/or pin a product(s) in the report interface 200a-r (discussed below in relation to FIGS. 5-12). In some examples, the market participant requestor may be able to request a change in a level of shifting provided by the report interface 200a-r (discussed below in relation to FIGS. 13-14). The report manager circuitry 326 is structured to adjust the report interface 200a-r based on a requested adjustment. In some examples, the report manager circuitry 326 is instantiated by processor circuitry executing report manager instructions and/or configured to perform operations such as those represented by the flowchart of FIGS. 22 and 26-28. Example implementations of the report manager circuitry 326 are discussed below in relation to FIGS. 5-21.

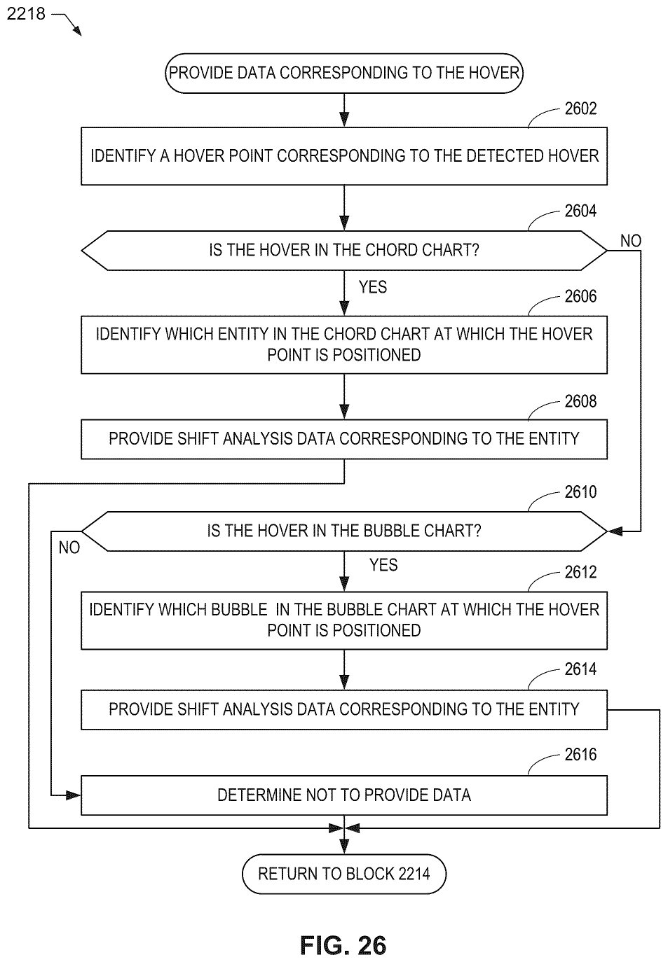

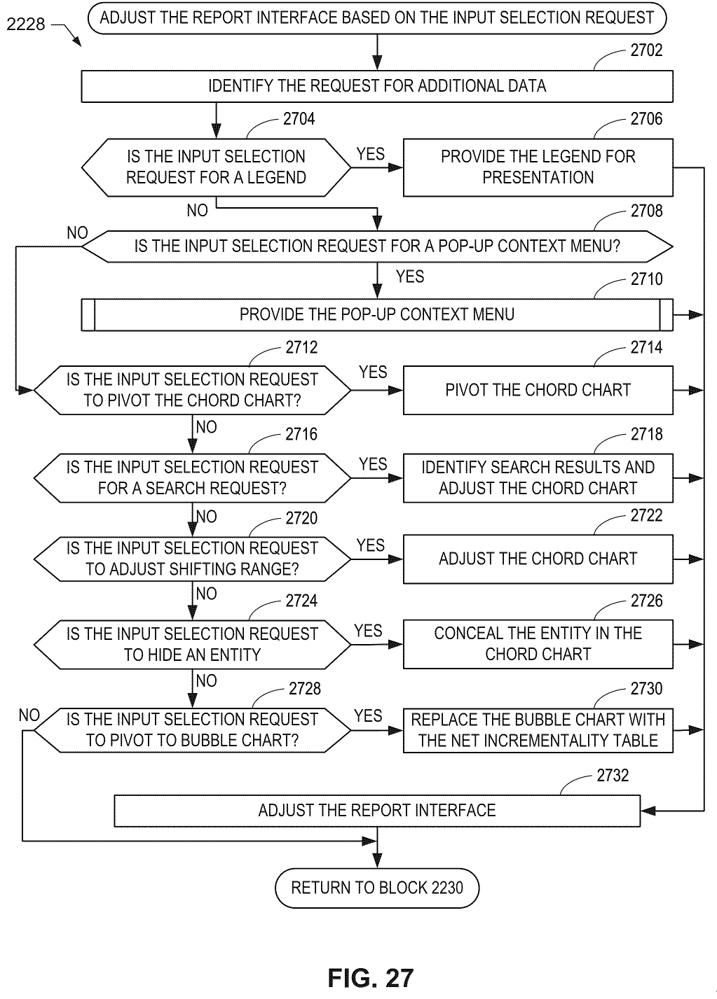

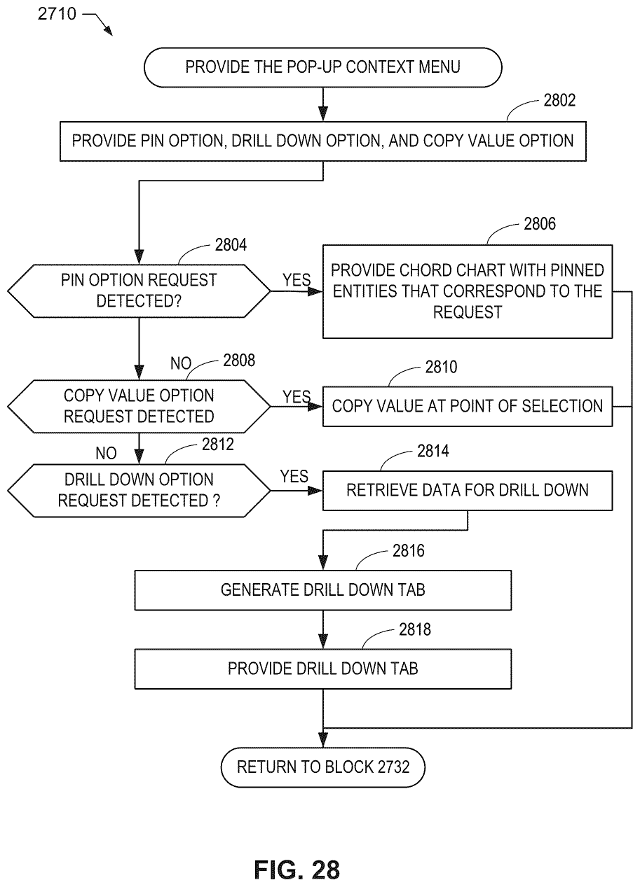

In some examples, the interactive shift analysis circuitry 114 includes means for managing an interactive report interface. For example, the means for managing an interactive report interface may be implemented by report manager circuitry 326. In some examples, the report manager circuitry 326 may be instantiated by processor circuitry such as the example processor circuitry 3112 of FIG. 31. For instance, the report manager circuitry 326 may be instantiated by the example microprocessor 3200 of FIG. 32 executing machine executable instructions such as those implemented by at least blocks 2214-2222, 2226-2230 of FIGS. 22, 2602-2616 of FIG. 26, 2702-2732 of FIG. 27, and 2802-2818 of FIG. 28. In some examples, the report manager circuitry 326 may be instantiated by hardware logic circuitry, which may be implemented by an ASIC, XPU, or the FPGA circuitry 3300 of FIG. 33 structured to perform operations corresponding to the machine readable instructions. Additionally or alternatively, the report manager circuitry 326 may be instantiated by any other combination of hardware, software, and/or firmware. For example, the report manager circuitry 326 may be implemented by at least one or more hardware circuits (e.g., processor circuitry, discrete and/or integrated analog and/or digital circuitry, an FPGA, an ASIC, an XPU, a comparator, an op-amp, a logic circuit, etc.) structured to execute some or all of the machine readable instructions and/or to perform some or all of the operations corresponding to the machine readable instructions without executing software or firmware, but other structures are likewise appropriate.

The interactive shift analysis circuitry 114 includes example export circuitry 330, which is structured to prepare the shift analysis report 324 for export and/or to export at least a portion of the shift analysis report 324. For example, the export circuitry 330 may prepare the shift analysis report 324 for export to a printing application, a word processing application (e.g., Microsoft® Word®, etc.), a presentation application (e.g., Microsoft® PowerPoint®, etc.), a spreadsheet application (e.g., Microsoft® Excel®, etc.), and/or other software or hardware. In some examples, the export circuitry 330 is instantiated by processor circuitry executing export instructions and/or configured to perform operations such as those represented by the flowchart of FIG. 22.

In some examples, the export circuitry 330 generates an example export by converting the shift analysis report 324 into the export, and transmits the export to another component. The export may include (but is not limited to) a title of the shift analysis report 324, a data summary 202, one or more data visualizations 206, 208, 1902, shift analysis data and/or other data corresponding to the shift analysis report 324, a footer 230, and a robustness flag 232. In some examples, the export defaults to a default report interface 200a. However, the export circuitry 330 may define other defaults in additional or alternative examples. In some examples, the market participant requestor can change the export to a different view before transmission to another component.

In some examples, the export is transmitted to a slide of a presentation application. In some examples, the export is transmitted to one or more tabs of a spreadsheet application. For example, a first tab may include one or more of the data visualizations and a second tab may include the shift analysis data corresponding to the shift analysis report 324 and/or raw data corresponding to the shift analysis data. However, the export can be prepared and transmitted in any suitable manner in other examples.

In some examples, due to the complexity of the data visualization and/or limitation of the component receiving the shift analysis report 324, the export circuitry 330 is limited in how the shift analysis report 324 can be converted and exported. For example, the chord chart 206a may not be exportable to a word processing application, a presentation application, a spreadsheet application, etc. as an object because the application(s) may not support (e.g., be configured for or compatible with) such an object. In some examples, the export circuitry 330 may convert one or more aspects of the shift analysis report 324 to an image.

In some examples, the interactive shift analysis circuitry 114 includes means for exporting a shift analysis report. For example, the means for exporting a shift analysis report may be implemented by export circuitry 330. In some examples, the export circuitry 330 may be instantiated by processor circuitry such as the example processor circuitry 3112 of FIG. 31. For instance, the export circuitry 330 may be instantiated by the example microprocessor 3200 of FIG. 32 executing machine executable instructions such as those implemented by at least blocks 2224 of FIG. 22. In some examples, the export circuitry 330 may be instantiated by hardware logic circuitry, which may be implemented by an ASIC, XPU, or the FPGA circuitry 3300 of FIG. 33 structured to perform operations corresponding to the machine readable instructions. Additionally or alternatively, the export circuitry 330 may be instantiated by any other combination of hardware, software, and/or firmware. For example, the export circuitry 330 may be implemented by at least one or more hardware circuits (e.g., processor circuitry, discrete and/or integrated analog and/or digital circuitry, an FPGA, an ASIC, an XPU, a comparator, an op-amp, a logic circuit, etc.) structured to execute some or all of the machine readable instructions and/or to perform some or all of the operations corresponding to the machine readable instructions without executing software or firmware, but other structures are likewise appropriate.

FIGS. 5-21 illustrate other example report interfaces 200b-r that may generated by the interactive shift analysis circuitry 114 to be rendered by the electronic device 104. The report interfaces 200b-r discussed below are based on an example shift analysis report 324 that includes shift analysis data and/or other data used to generate the report interfaces 200b-r. The different report interfaces 200b-r illustrated in FIGS. 5-21 are based on the same shift analysis report 324 and illustrate responses of the report manager circuitry 326 to requests from the market participant requestor transmitted by the electronic device 104. For example, the market participant requestor may utilize an input device 3022 to hover over a data point and/or provide an input at a specific point in the report interface(s) 200b-r, which is transmitted to the report manager circuitry 326 as a request. In response to detecting the request, the report manager circuitry 326 generates and transmits another report interface 200b-r to the market participant for render by the electronic device 104.

FIGS. 5-21 may not illustrate an entirety of each report interface(s) 200b-r, but rather a portion of the report interface 200b-r that is associated with a respective request. That is, for the sake of simplicity, FIGS. 5-21 illustrate a data visualization that may be adjusted by the report manager circuitry 326 in response to a request, while the other data visualizations are assumed to remain constant. However, it is understood that portions of the report interfaces 200b-r other than those illustrated in FIGS. 5-21 may be presented to the market participant requestor.

FIG. 5 illustrates another example report interface 200b including an expanded view of another example chord chart 206b, which may be adjusted relative to the example chord chart 206a of FIG. 2. As noted above, the report interface 200a of FIG. 2 includes the example legend request icon 210a, which enables the market participant requestor to request a secondary visualization in the form of a legend. When the legend request icon 210a is selected by the market participant requestor, a corresponding request may be transmitted to the report manager circuitry. In response to detecting the legend request icon 210a selection, the report manager circuitry 326 generates and provides an example legend 502 for display on the electronic device 104. In some examples, the legend 502 allows the market participant requestor to view data corresponding to one or more entities 216, 218, 220 plotted in the chord chart 206b. For example, the legend 502 of FIG. 5 illustrates example products, example retailers, and respective example net shifting values corresponding to the inner element(s) 216, the outer element(s) 218, and the chord(s) 220 in the chord chart 206b. In some examples, the legend 502 of the report interface 200b includes an example search bar 504 that enables the market participant requestor to search for a particular brand to further refine the chord chart 206b. The search bar 504 may enable the market participant requestor to search for other information in additional or alternative examples, such as a product or a retailer.

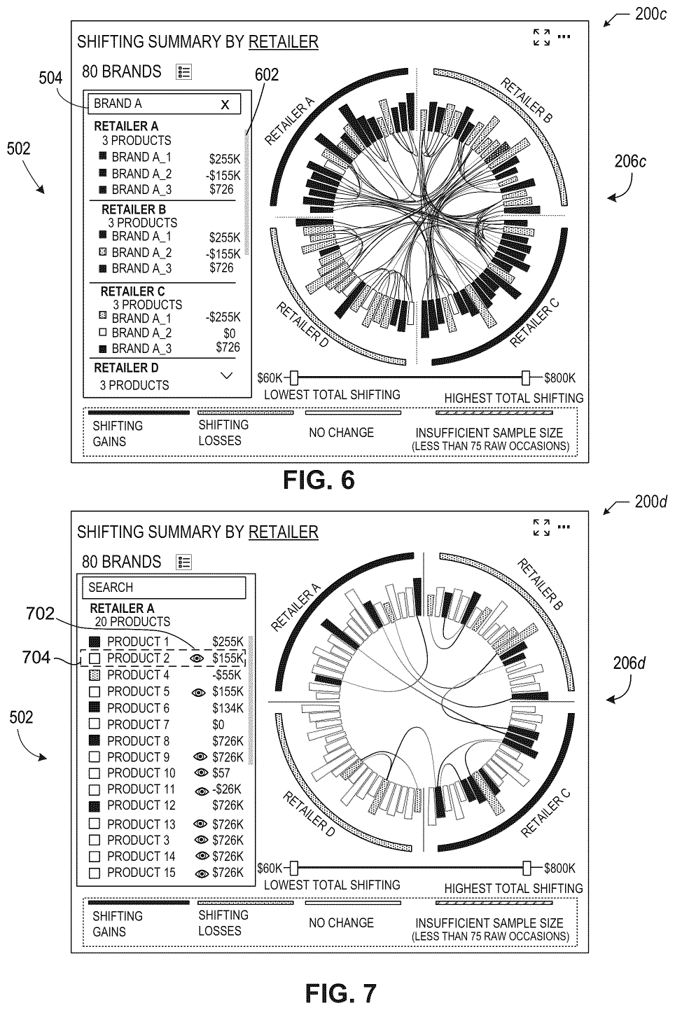

FIG. 6 illustrates another example chord chart 206c corresponding to another example report interface 200c, which may be adjusted relative to the example chord chart 206b of FIG. 5. Specifically, the report interface 200c illustrates results of (e.g., a response to) an example search request for an example brand (e.g., Brand A). The chord chart 206c may be generated and provided by the report manager circuitry 326 in response to detecting the request to search for Brand A submitted by the market participant requestor. As illustrated in chord chart 206c of FIG. 6, the search for Brand A refines which products and corresponding shift analysis data are depicted in the legend 502 and in the entities 216, 218, 220 in the chord chart 206b illustrated in FIG. 5. Specifically, the legend 502 includes a first product (e.g., Brand A_1), a second product (e.g., Brand A_2), and a third product (e.g., Brand A_3). As illustrated in FIG. 6, at least Retailer A, Retailer B, and Retailer C sell Brand A_1 and Brand A_3 and at least Retailer A and Retailer B sell Brand A_2 (e.g., Brand A_2 for Retailer C illustrates $0 in net shifting). The market participant requestor may be able to view the products corresponding to Brand A relative to Retailer D by utilized an example scroll bar 602 in the legend 502.

FIG. 7 illustrates another example chord chart 206d corresponding to an example report interface 200d, which may be adjusted relative to the example chord chart 206b of FIG. 5. As illustrated in FIG. 7, the report interface 200d includes an example entity conceal request icon 702a, which enables the market participant requestor to request removal or concealment of shift analysis data for one or more market entities 216, 218, 220 plotted in the chord chart 206d. In some examples, positioning the input device 3022 in an example product area 704 in the legend 502 that corresponds to a product (e.g., Product 2) causes the entity conceal request icon 702a to appear. When the entity conceal request icon 702a is selected by the market participant requestor, a corresponding request may be transmitted to the report manager circuitry 326. In response to detecting the entity conceal request icon 702a selection, the report manager circuitry 326 generates and provides the chord chart 206d, which is refined relative to the chord chart 206a of FIG. 2. In other words, report manager circuitry 326 removes or otherwise conceals shift analysis data corresponding to the request from respective entities 216, 218, 220 in the chord chart 206d.

As illustrated in FIG. 7, a plurality of inner elements 216 no longer include visual characteristics indicative of shifting gains/losses and associated chords 220 are no longer visible. The products corresponding to the concealed entities 216, 218, 220 are illustrated in the legend 502. For example, the input selection to remove or conceal shift analysis data for a product may cause the entity conceal request icon 702 to remain visible in the respective product area 704 in the legend 502. In some examples, removing or otherwise concealing one or more entities 216, 218, 220 enables isolation of other entities 216, 218, 220 corresponding to products and/or retailers that are of a particular interest to the market participant requestor.

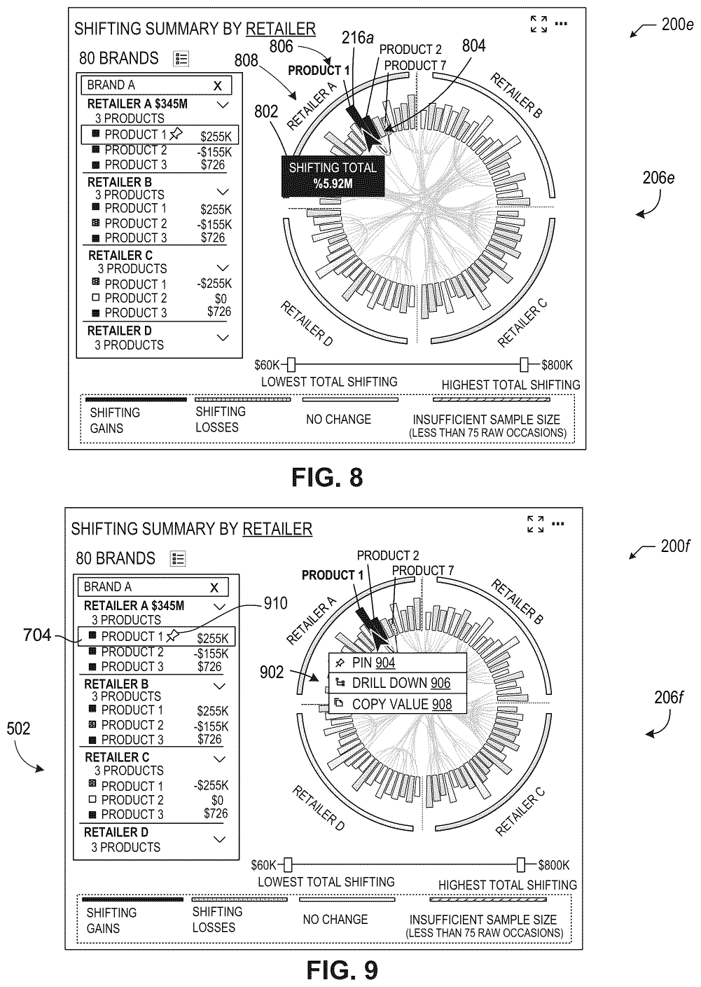

FIG. 8 illustrates another example chord chart 206e corresponding to an example report interface 200e, which may be adjusted relative to the chord chart 206b of FIG. 5. As noted above, the report interface 200e includes an example hover feature that enables the market participant requestor to request a secondary visualization in the form of a pop-up visual. The chord chart 206a of FIG. 8 illustrates a hover feature of the shift analysis report 324 provided by the interactive shift analysis circuitry 114. By positioning and retaining the input device 3022 relative to (e.g., over) a specific entity 216a, 218a, 220a (e.g., a focus entity) for a threshold period of time (e.g., 1 second), the market participant requestor can request an example pop-up visual 802 that illustrates data corresponding to the focus entity 216a, 218a, 220a and/or isolate or otherwise exaggerate the focus entity 216a, 218a, 220a and other entities 216, 218, 220 connected with the focus entity 216a, 218a, 220a.

In response to detecting a hover request, the report manager circuitry 326 may provide the pop-up visual 802 that illustrates shift analysis data corresponding to the focus entity 216a, 218a, 220a. For example, if the hover request corresponds to a product as sold by a retailer, the pop-up visual 802 may provide an example net shifting total value corresponding to that product relative to that retailer. If the hover request corresponds to a retailer, the pop-up visual 802 may provide a net shifting value corresponding to that retailer. If the hover request corresponds to a chord 220, the pop-up visual 802 may provide a change in net shifting between the inner elements 216 the chord 220 associates. In additional or alternative examples, in response to detecting the hover request, the report manager circuitry 326 may fade (e.g., visually play down) visual characteristics of entities 216, 218, 220 that are not associated with the focus entity 216a, 218a, 220a (e.g., except for a pinned focus item(s), discussed below). In some examples, the hover feature enables the market participant requestor to view data that are showing either gaining or losses in shifting and the actual net shifting value it.

In the illustrated example of FIG. 8, the hover request corresponds to an example hover point 804 that is associated with a specific inner element 216a (e.g., focus entity). The focus entity 216a is associated with an example first product (e.g., Product 1) 806 as sold by an example first retailer (e.g., Retailer A) 808. In response to detecting the hover request and identifying the hover point 804, the report manager circuitry 326 is structured to exaggerate entities 216, 218, 220 that correspond to the focus entity 216a, to fade other entities 216, 218, 220 that do not include data corresponding to the focus entity 216a, and to provide the pop-up visual 802, which includes an example shifting total value for the focus entity 216a. As illustrated in FIG. 8, chords 220 extending from the focus entity 216a remain exaggerated as well as inner elements 216 into which the chords 220 extend. In some examples, the market participant request may desire to pin the focus entity 216a, drill down into the focus entity 216a, or copy the respective net shifting value presented in the pop-up visual 802.

FIG. 9 illustrates another example chord chart 206f corresponding to an example report interface 200f, which may be adjusted relative to the chord chart 206e of FIG. 8. By providing an input selection at the hover point 804, the market participant requestor is able to request a secondary visualization in the form of an example pop-up context menu 902. The pop-up context menu 902 of FIG. 9 includes an example pin option 904, an example drill down option 906, and an example copy value option 908.

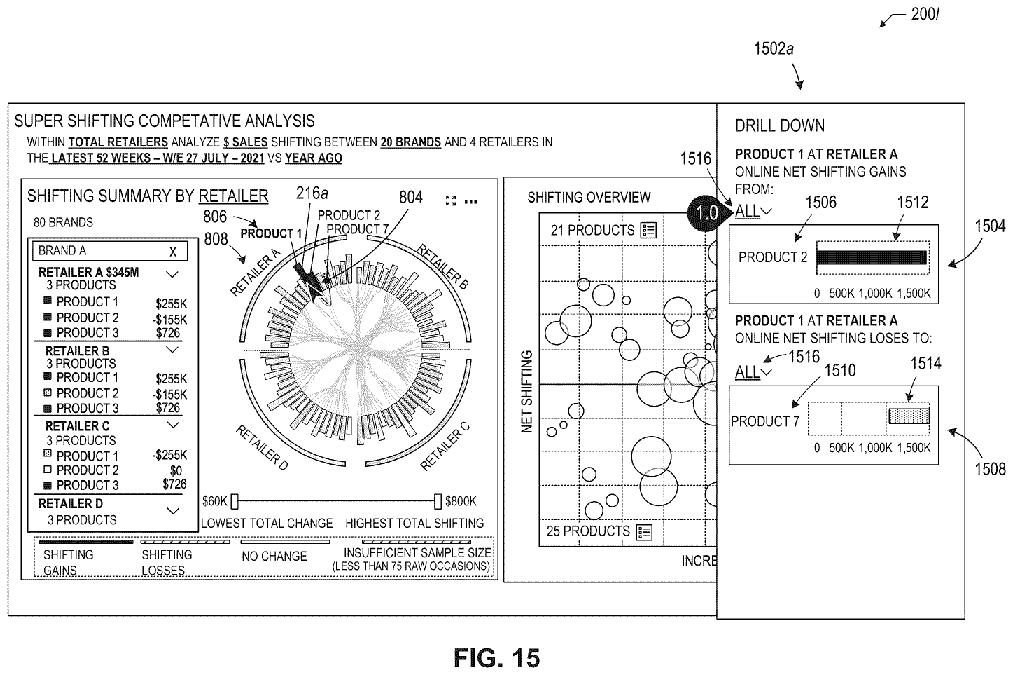

The pin option 904 allows the market participant request to request that a focus entity 216a, 218a, 220a and entities associated therewith remain emphasized. The drill down option 906 enables the market participant request to request a secondary visualization in the form of a pop-up chart (e.g., pop-up chart 1502 of FIG. 15). The pin option 904 and/or the drill down option 906 may be useful when the market participant requestor desires to understand the click-through itself because they are interactive to some level where the market participant requestor can see what is expected when it comes to pinning and drilling. In some examples, the market participant requestor can provide an input selection for a pin option via an example pin request icon 910 that adjacent a respective product area 704 in the legend 502. The copy value option 908 enables the market participant requestor to store a net shifting value in the respective pop-up visual 802 of FIG. 8.

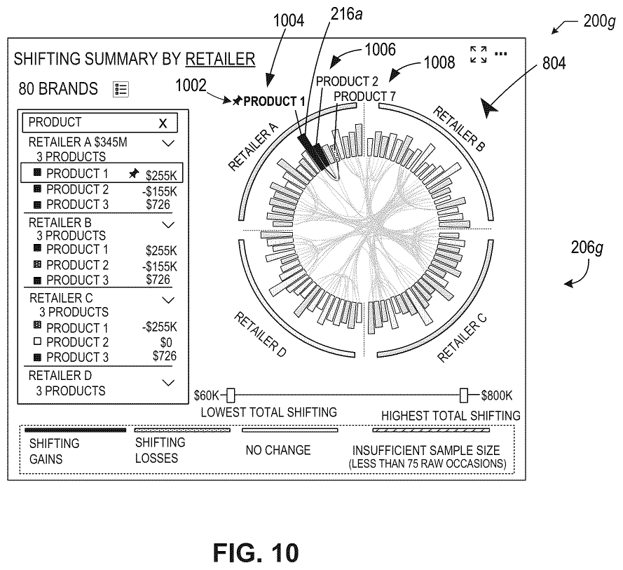

FIG. 10 illustrates another example chord chart 206g corresponding to an example report interface 200g, which may adjusted from the example chord chart 206e of FIG. 9 to illustrate the pin feature. When the pin option 904 or the pin request icon 910 is selected by the market participant requestor, a corresponding request may be transmitted to the report manager circuitry 326. In response to detecting the pin option 904 or the pin request icon 910 selection, the report manager circuitry 326 provides the chord chart 206g for display on the electronic device 104. The chord chart 206g illustrates an example pinned item icon 1002 positioned adjacent Product 1 806 of FIG. 8. The pinned item icon 1002 indicates that the Product 1 806 is pinned, converting the Product 1 806 from a focus item (e.g., corresponding to a focus entity 216a) to an example pinned item 1004.

The pin feature works as a stay in place, allowing the market participant requestor to view the shifting to and from the pinned item 1004. As illustrated in FIG. 10, the focus entity 216a corresponding to the pinned item 1004 remains exaggerated, as well as inner elements 216 corresponding to the pinned item 1004, such as example Product 2 1006, example product 7 1008, and chords 220 extending between the pinned item 1004, Product 2 1006, and Product 3 1008, even when the hover point 804 moves. Pinning a focus item enables evaluation of gains and losses only from competitive items associated with the pinned item 1004, 1104. While the focus item remains pinned, the market participant requestor is able to view other connections by hovering over other entities 216, 218, 220 (e.g., converting those entities 216, 218, 220 to focus entities 216a, 218a, 220a during a hover).

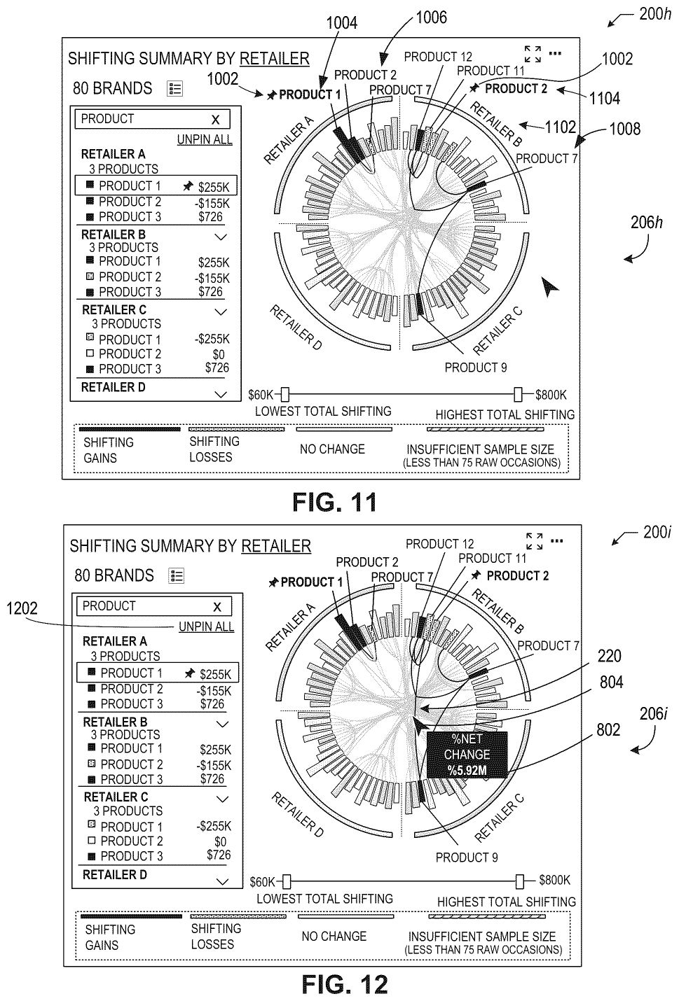

As illustrated in FIG. 11, the market participant requestor may be able to pin multiple entities 216, 218, 220 to lock visual connections of shifting gain/loss associated with the pinned items 1004, 1104. FIG. 11 illustrates another example chord chart 206h corresponding to an example report interface 200h, which is adjusted relative to the example chord chart 206g of FIG. 10. For example, the pinned item icon 1002 is positioned adjacent Product 1 806 relative to Retailer A 808 as well as adjacent Product 2 1006 relative to an example second retailer (e.g., Retailer B) 1102, indicating that Product 1 806 and Product 2 1006 are pinned. Thus, the report interface 200h of FIG. 11 exaggerates shifting to and from Product 1 806, which is a first pinned product 1004, and shifting to a from Product 2 1102, which is a second pinned product 1104.

While Product 1 806 and Product 2 1006 are pinned, the market participant requestor is able to hover over additional entities 216, 218, 220 to identify other shift analysis data from which to draw insights. In some examples, when multiple inner elements 216 are under lock, the market participant requestor may hover over a specific connection and to see a value representing a net change between the two entities. For example, the market participant requestor can utilize the hover feature by hovering the input device 3022 relative to a chord 220 to request shift analysis data associated with the respective chord 220.

FIG. 12, for example, illustrates another example chord chart 206i corresponding to an example report interface 200i, which is adjusted from the example chord chart 206h of FIG. 11. As illustrated in FIG. 12, in response to detecting the hover request and identifying the hover point 804, the report manager circuitry 326 may provide net shifting data corresponding to the chord 220 to appear in the pop-up visual 802. In some examples, the legend 502 includes an example unpin all icon 1202. The unpin all icon 1202 can be used by the market participant requestor to unpin each pinned focus item 1004, 1104 in the chord chart 206i, an example result (e.g., response) of which is illustrated in FIG. 13.

FIG. 13 illustrates another example chord chart 206j corresponding to an example report interface 200j, which is adjusted from the example chord chart 206i of FIG. 12. For example, in response to detecting an unpin all request, the report manager circuitry 326 may cause faded entities 216, 218, 220 to return to their full visual characteristic. Accordingly, FIG. 13 is similar to the chord chart 206b of FIG. 5.

In some examples, the market participant requestor is able to change (e.g., adjust, select, etc.) a level of shifting illustrated in the chord chart 206k. For example, the chord chart 206k of FIG. 13 includes an example slider tool icon 1302, which is structured to enable the market participant requestor to view and select net shifting values and, in turn, a net shifting range. The slider tool icon 1302 includes an example low net shifting edge 1304 that represents an example lowest net shifting value in the shift analysis data and an example high net shifting edge 1306 that represents an example highest net shifting value in the shift analysis data. The slider tool icon 1302 also includes an example low net shifting value indicator 1308a and an example high net shifting value indicator 1310a, which are positioned on an example net shifting range bar 1312a. The low net shifting value indicator 1308a represents a lowest net shifting value to be represented in the chord chart 206k, the high net shifting value indicator 1310a represents a highest net shifting value to be represented in the chord chart 206k, and the net shifting range bar 1312a represents a range of net shifting values represents in the chord chart 206k (e.g., defined by an area of the net shifting range bar 1312a between the low net shifting value indicator 1308a and the high net shifting value indicator 1310a.

In the illustrated example of FIG. 13, the low net shifting edge 1304 represents an example lowest net shifting value in the shift analysis data of approximately $60,000 and the high net shifting edge 1306 represents an example high net shifting value in the shift analysis data of approximately $800,000. The low net shifting value indicator 1308a of FIG. 13 represents a low net shifting value of approximately $100,000. Thus, the lowest net shifting value to be represented in the chord chart 206j is approximately $100,000. The high net shifting value indicator 1310a represents a high net shifting value of approximately $750,000 and, thus, the highest net shifting value to be represented in the chord chart 206j is approximately $750,000. The net shifting range bar 1312a represents a range of net shifting values between approximately $100,000 and $750,000. As disclosed herein, an approximate value refers to a value within 10% of the stated value.

FIG. 14 illustrates another example chord chart 206k corresponding to an example report interface 200k, which is adjusted relative to the example chord chart 206j of FIG. 13. The low net shifting edge 1304 and the high net shifting edge 1306 of FIG. 14 are the same as in FIG. 13 because FIGS. 13 and 14 are based on the same shift analysis data. However, as illustrated in FIG. 14, the market participant requestor can change the level of shifting represented in the report interface 200k to adjust which products are presented. For example, in response to detecting a sliding of the slider tool icon 1302, the report manager circuitry 326 provides the report interface 200k of FIG. 13.

The chord chart 206k of FIG. 14 illustrates a smaller net shifting range represented by the net shifting range bar 1312b. The low net shifting value indicator 1308b of FIG. 14 represents a low net shifting value of approximately $600,000. Thus, the lowest net shifting value to be represented in the chord chart 206k is approximately $600,000. The high net shifting value indicator 1310b represents a high net shifting value of approximately $750,000 and, thus, the highest net shifting value to be represented in the chord chart 206k is approximately $750,000. The net shifting range bar 1312b represents a range of net shifting values between approximately $600,000 and $750,000.

FIG. 15 illustrates another example report interface 200l, which is adjusted from the example report interface 200f of FIG. 9 to illustrate the drill down feature. As noted above, the market participant requestor is able to request the pop-up context menu 902 of FIG. 9 by providing the input selection at the hover point 804. The pop-up context menu 902 of the report interface 200f of FIG. 9 includes the drill down option 906, which enables the market participant requestor to an example pop-up chart 1502a. When the drill down option 906 is selected by the market participant requestor, a corresponding request may be transmitted to the report manager circuitry 326. In response to detecting the drill down option 906 request, the report manager circuitry 326 provides the report interface 200l for display on the electronic device 104. The pop-up chart 1502a of FIG. 15 appears adjacent the chord chart 206f and over the net incrementality chart 208a. However, the pop-up chart 1502a may appear elsewhere in the report interface 200l in additional or alternative examples.

The pop-up chart 1502a of FIG. 15 corresponds to Product 1 806 relative to Retailer A 808 and represented by a focus entity 216a. The pop-up chart 1502a allows the market participant requestor to view additional data corresponding to the focus entity 216a. The pop-up chart 1502a of FIG. 15 illustrates sources of shifting gains and shifting losses for corresponding to Product 1 806 relative to Retailer A 808. For example, the pop-up chart 1502a includes an example shifting gain bar chart 1504 illustrating an example top competitive item 1506 from which the focus item 806 gained volume and an example shifting loss bar chart 1508 illustrating an example top competitive item 1510 from which the focus item 806 lost volume. The shifting gain bar chart 1504 includes an example shifting gain bar 1512 that identifies a net shifting value that the focus item 806 gained from the competitive item 1506. The shifting loss bar chart 1508 includes an example shifting loss bar 1514 that identifies a net shifting value that the focus item 806 lost to the competitive item 1510.

In some examples, the example drill down feature provides more granularity for the focus entity 216a by displaying corresponding shift analysis data associated with the focus item 806. The pop-up chart 1502a also illustrates example competitive item request icon 1516 that enables the market participant requestor to view additional competitive items 1506, 1510 from which the focus item 806 lost/gained sales volume.

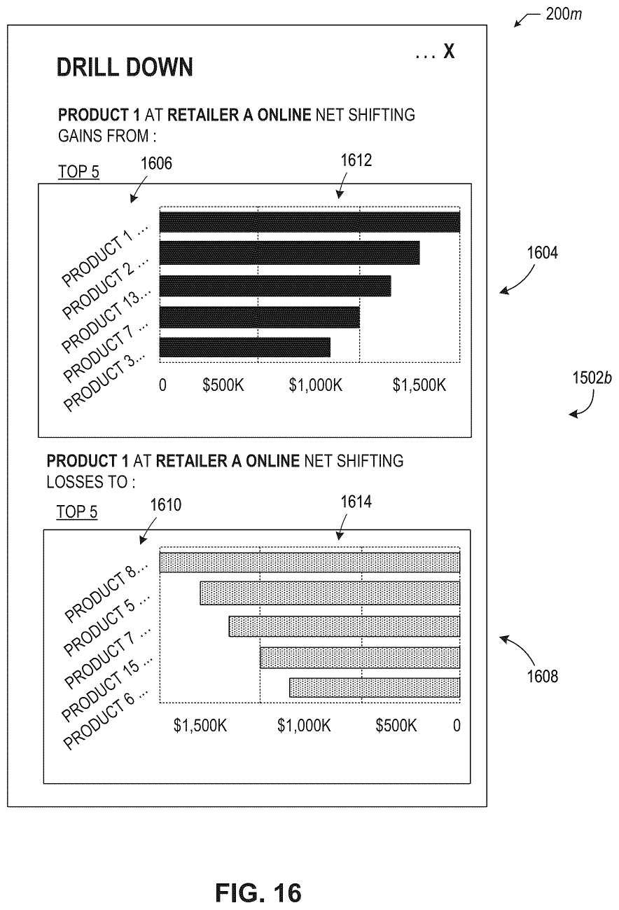

FIG. 16 illustrates another example report interface 200m, which is adjusted from the example report interface 200l of FIG. 15. When the competitive item request icon 1516 is selected by the market participant requestor, a corresponding request may be transmitted to the report manager circuitry 326. In response to detecting the competitive item request icon 1516 selection, the report manager circuitry 326 provides the report interface 200l for display on the electronic device 104. The report interface 200l includes an example pop-up chart 1502b may be adjusted relative to the pop-up chart 1502b of FIG. 15.

The pop-up chart 1502b of FIG. 16 includes an example shifting gain bar chart 1604 illustrating an example ranked list of competitive items 1606 from which the focus item 806 gained volume and an example shifting loss bar chart 1608 illustrating an example ranked list of competitive items 1610 from which the focus item 806 lost volume. The shifting gain bar chart 1604 includes example shifting gain bars 1612 that identify net shifting values that the focus item 806 gained from the competitive items 1606. The shifting loss bar chart 1608 includes example shifting loss bars 1614 that identify net shifting values that the focus item 806 lost to the competitive items 1610.

In some examples, the bar charts 1604, 1608 are sorted bar chart(s) highlighting a number (e.g., 5) of top competitive items from which the focus item received shifting gains/losses. In some examples, the bar charts1604, 1608 are ranked to show the most relevant competitive items 1606, 1610 and net shifting values represented by the bars 1612, 1614 associated with each competitive item 1606, 1610 that either contributed to shifting to the focus item 806 or that contributed to the shifting away from the focus item 806. However, the bar charts 1504, 1508, 1604, 1608 of FIGS. 15-16 can be other types of data structures to provide data visualization of competitive items in additional or alternative examples, such as (but not limited to) a line graph, a pie chart, a column chart, etc.

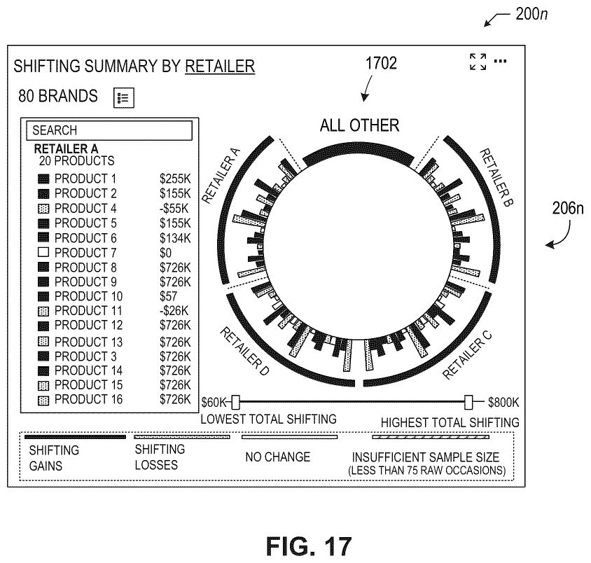

FIG. 17 illustrates another example report interface 200n that may be provided by the interface shift analysis circuitry 114. The report interface 200n of FIG. 17 is similar to the report interface 200a of FIG. 2. However, the report interface 200n of FIG. 17 includes an example All Other 1702 category of products.

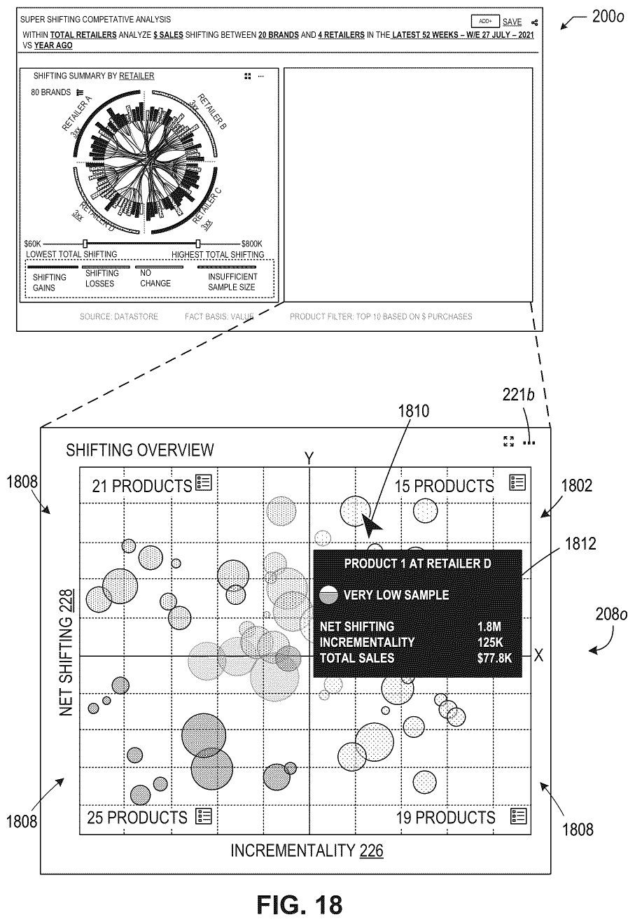

FIG. 18 illustrates another example report interface 200o, which is adjusted from the example report interface 200a of FIG. 2. The report interface 200o includes an example net incrementality chart 208b, which may be adjusted relative to the net incrementality chart 208a of FIG. 2. The net incrementality chart 208b includes the example bubbles 224, each of which represent a product associated with measures net incrementality 226 (e.g., X-axis) relative to net shifting 228 (e.g., Y-axis). In other words, the net incrementality chart 208b plots available product/retailer combinations in relation to their net shifting versus net incrementality metrics to identify those items that are overperforming and underperforming in respect to the universe. Products plotted along the net incrementality 226 axis of FIG. 18 move from low incrementally to higher incrementality in the +X direction. Products plotted along the net shifting 228 axis of FIG. 18 move from low sales velocity to higher sales velocity in the +Y direction.

The net incrementality chart 208b distinguishes four quadrants, including an example first (develop) quadrant 1802, an example second (e.g., rationalize) quadrant 1804, an example third (e.g., nurture) quadrant 1806, and an example fourth (e.g., squeeze) quadrant 1808, each of which may be used to identify a different incrementality strategy. The bubbles 224 representing the products are plotted in the quadrants 1802, 1804, 1806, 1808. The first quadrant 1802 may be used to identify products that provide incremental growth, high sales velocity, and may contribute to category growth. The second quadrant 1804 may be used to identify products that provide high velocity sales with lower incrementality. The third quadrant 1806 may be used to identify products that provide lower sales velocity, but higher incrementality. The fourth quadrant 1808 may be used to identify products that provide low incrementality and low sales velocity. By placing items within a four-quadrant setup, the net incrementality chart 208b can enable the market participant requestor to clearly identify an item's impact relative to other items, and ultimately on a category's overall sales volume.

The net incrementality chart 208b is interactive, enabling the market participant to interact with the net incrementality chart 208a to view or otherwise identify additional or alternative information. As noted above, the report interface 200a-r includes an example hover feature that enables the market participant requestor to request a secondary visualization in the form of a pop-up visual that presents information related to a specific datapoint. For example, the market participant requestor may hover over a specific bubble 224a (e.g., using the input device 3022) and, in response, the interactive shift analysis circuitry 114 may provide more granular information relative to that bubble 224a. By positioning and retaining the input device 3022 at an example hover point 1810 relative to (e.g., over) the bubble 224 a for a threshold period of time, the market participant requestor can request an example pop-up visual 1812 that illustrates data corresponding to the bubble 224a.

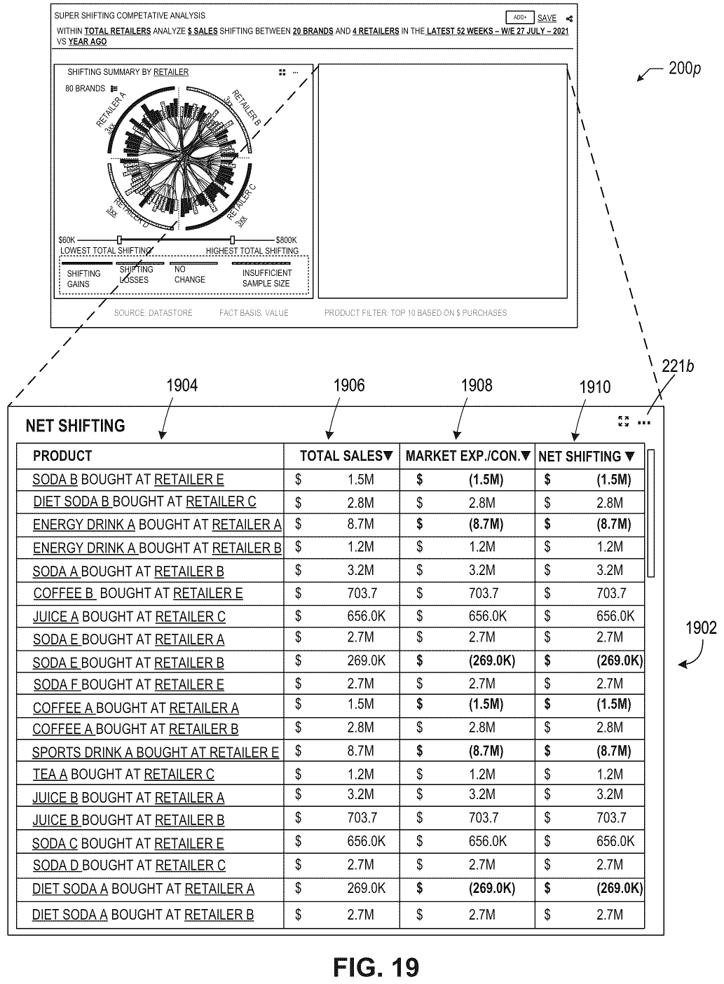

In response to detecting a hover request and identifying the hover point 1810, the report manager circuitry 326 may provide the pop-up visual 1812 that identifies product information for the product represented by the bubble 224a such as (but not limited to) an example net-shifting data value, an example incrementality data value, and/or an example total sales data value. In some examples, the product information is retrieved from an example net incrementality table (e.g., net incrementality table 1902 of FIG. 19).

As noted above, the net incrementality chart 208a-b is pivotable to the net incrementality table 1902. The report interface 200a-r includes an example pivot request icon 221b, which, when selected by the market participant requestor, allows the market participant requestor to pivot the net incrementality chart(s) 208o to the net incrementality table 1902. For example, in response to detecting the pivot request icon 221b selection (e.g., via a request), the report manager circuitry 326 may pivot the net incrementality chart 208o to the net incrementality table 1902 illustrated in FIG. 19.

FIG. 19 illustrates another example report interface 200p, which is adjusted from the example report interface 200o of FIG. 18 to illustrate the pivot function to the net incrementality table 1902. The net incrementality table 1902 identifies shift analysis data plotted in the net incrementality chart 208a-r. For example, the net incrementality table 1902 of FIG. 19 includes an example first (e.g., product/retailer combinations) column 1904 that identifies product/retailer combinations plotted in the net incrementality chart 208a-r. The product/retailer combinations refer to products sold by retailers (e.g., Soda B bought at or otherwise sold by Retailer E, etc.). The combinations are defined by market data used to generate the shift analysis data. The net incrementality table 1902 also includes an example second (e.g., total sales) column 1906 that identifies a total sales value for each product, an example third (e.g., incrementality) column 1908 that identifies market contraction or market expansion value for each product, and an example fourth (e.g., net shifting) column 1910 that identifies a net shifting value for each product.

To return to the net incrementality chart 208a-r, the market participant requestor may use the input device 3022 to select the pivot request icon 221b. In response to detecting the pivot request icon 221b selection (e.g., via a request), the report manager circuitry 326 may pivot the net incrementality table 1902 of FIG. 19 back to the net incrementality chart 208a of FIG. 2.

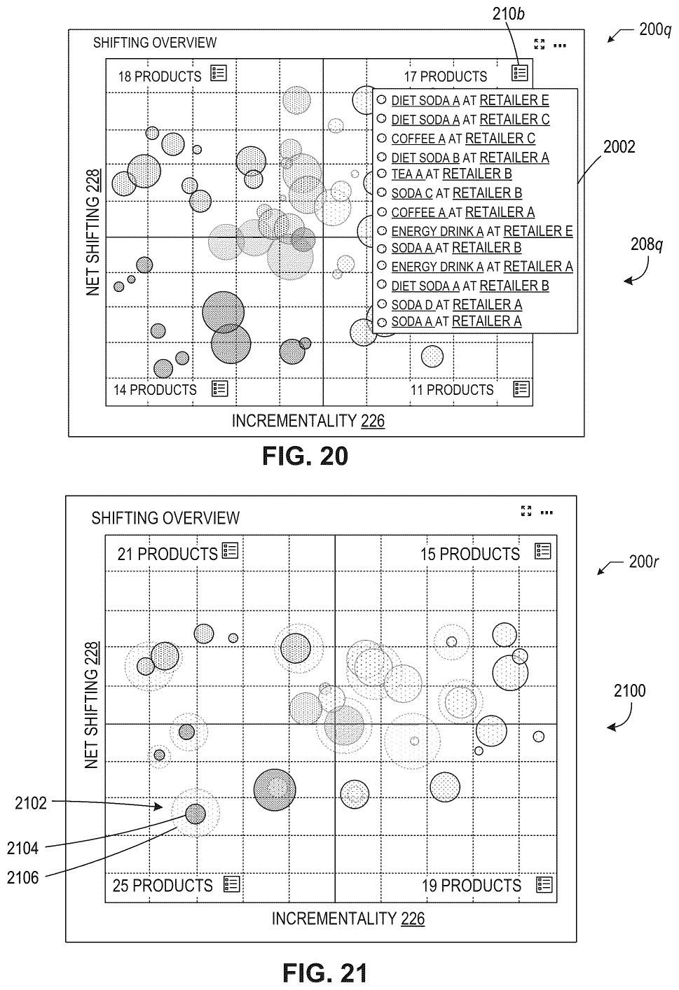

FIG. 20 illustrates another example report interface 200q, which is adjusted from the example report interface 200a of FIG. 2. The report interface 200a-r includes the example legend request icons 210b, which, when selected by the market participant requestor, allows the market participant requestor to view which retailers and/or products are plotted in a quadrant 1802-1808 of the net incrementality chart(s) 208q. For example, a request to provide a legend may be transmitted to the report manager circuitry 326 in response to the market participant requestor selecting the legend request icon 210b. In response to detecting the legend request icon 210b selection, the report manager circuitry 326 provides an example legend 2002 for display on the electronic device 104.

The legend(s) 2002 allows the market participant requestor to view product/retailer combinations plotted in a respective quadrant 1802-1808 of the net incrementality chart 208q. For example, the legend 2002 of FIG. 20 illustrates example product/retailer combinations plotted in the first quadrant 1802 of the net incrementality chart 208q. In some examples, the legend(s) 2002 easily allows the market participant request to identify products that are overperforming, underperforming, or are performing as expected.

FIG. 21 illustrates another example net incrementality chart 2100 including that may be included in another example report interface 200r. The net incrementality chart 2100 includes an example nested bubble(s) 2102 corresponding to a product/retailer combination. For example, the nested bubble(s) 2102 may include an example first bubble 2104 nested within an example second bubble 2106. The first bubble 2104 may represent first metrics for a first product/retailer combination in a first time period and the second bubble 2106 may represent second metrics for the first product/retailer combination in a second time period. The net incrementality chart 2100 of FIG. 21 may enable the market participant requestor to view net shifting and incrementality data for different product/retailer combinations relative to two time periods in one net incrementality chart 2100.

While an example manner of implementing the interactive shift analysis circuitry 114 of FIG. 1 is illustrated in FIG. 3, one or more of the elements, processes, and/or devices illustrated in FIG. 3 may be combined, divided, re-arranged, omitted, eliminated, and/or implemented in any other way. Further, the example processor circuitry 302, the example user interface circuitry 306, the example request generator circuitry 312, the example database engine interface circuitry 318, the example report generator circuitry 322, the example report manager circuitry 326, the example export circuitry 330, and/or, more generally, the example interactive shift analysis circuitry 114 of FIG. 1, may be implemented by hardware alone or by hardware in combination with software and/or firmware. Thus, for example, any of the example processor circuitry 302, the example user interface circuitry 306, the example request generator circuitry 312, the example database engine interface circuitry 318, the example report generator circuitry 322, the example report manager circuitry 326, the example export circuitry 330, and/or, more generally, the example interactive shift analysis circuitry 114, could be implemented by processor circuitry, analog circuit(s), digital circuit(s), logic circuit(s), programmable processor(s), programmable microcontroller(s), GPU(s), DSP(s), ASIC(s), programmable logic device(s) (PLD(s)), and/or field programmable logic device(s) (FPLD(s)) such as FPGAs. Further still, the example interactive shift analysis circuitry 114 of FIG. 1 may include one or more elements, processes, and/or devices in addition to, or instead of, those illustrated in FIG. 3, and/or may include more than one of any or all of the illustrated elements, processes and devices.

Flowcharts representative of example machine readable instructions, which may be executed to configure processor circuitry to implement the interactive shift analysis circuitry 114 of FIGS. 1 and 3, is shown in FIGS. 22-28. The machine readable instructions may be one or more executable programs or portion(s) of an executable program for execution by processor circuitry, such as the processor circuitry 3112 shown in the example processor platform 3100 discussed below in connection with FIG. 31 and/or the example processor circuitry discussed below in connection with FIGS. 31 and/or 32. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 3, many other methods of implementing the example interactive shift analysis circuitry 114 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an op-amp, a logic circuit, etc.) structured to perform the corresponding operation without executing software or firmware. The processor circuitry may be distributed in different network locations and/or local to one or more hardware devices (e.g., a single-core processor (e.g., a single core CPU), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an API, etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 22-28 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 22 is a flowchart representative of example machine readable instructions and/or example operations 2200 that may be executed and/or instantiated by processor circuitry to facilitate identification of volume shift trends that would not be readily apparent using a traditional manual techniques by generating an example shift analysis report to present to a market participant requestor via an example interactive report interface(s). The machine readable instructions and/or the operations 2200 of FIG. 22 begin at block 2202, at which the example interactive shift analysis circuitry 114 detects a request to generate the example shift analysis report 324. For example, a market participant may request the shift analysis report 324 by inputting a selection to generate the shift analysis report 324 via the example user interface circuitry 108 of an the example electronic device 104. The input selection may be transmitted to the interactive shift analysis circuitry 114 as a request.

In response to detecting the request to generate the shift analysis report 324, the example request generator circuitry 312 provides example prompts (e.g., front end prompts) to present to the market participant requestor and obtains input selections based on the prompts (block 2204). For example, the request generator circuitry 312 may generate the prompts to present to the market participant requestor via the user interface circuitry 306. The market participant requestor may view the prompt(s) as rendered by the user interface circuitry 108 on the electronic device 104 and provide input selections to the prompts as input to via the user interface circuitry 108. The request generator circuitry 312 may obtain the input selections from the electronic device 104.

At block 2206, the request generator circuitry 312 performs dimension mapping to generate an example data request 316. For example, the request generator circuitry 312 may map input selections obtained from the market participant requestor to corresponding dimensions in the example market data datastore(s) 118. That is, the request generator circuitry 312 may map the front-end terminology provided in the prompts to back-end terminology used by the example database engine circuitry 116. By performing dimension mapping, the request generator circuitry 312 generates an example data request 316.

The request generator circuitry 312 transmits the data request 316 to the database engine circuitry 116 (block 2208) to request market data and/or shift analysis data to build the shift analysis report 324. For example, the request generator circuitry 312 may transmit the data request 316 to the database engine circuitry 116 via example database engine interface circuitry 318 to obtain shift analysis data from which to generate the shift analysis report 324. The database engine circuitry 116 may receive the data request 316, retrieve corresponding market data from an example market data datastore(s) 118, and/or apply the retrieved market data to an example shift analysis model(s) 408. The database engine circuitry 116 may generate an example data structure 320 based on an output(s) of the shift analysis model(s) 408. The request generator circuitry 312 may obtain the data structure 320 from the database engine circuitry 116 via the database engine interface circuitry 318 (block 2210).

At block 2212, the example report generator circuitry 322 generates the shift analysis report 324. For example, the report generator circuitry 322 may utilize the data structure 320 to define specifications for the shift analysis report 324. For example, the report generator circuitry 322 may populate an example chord chart table, an example net incrementality table(s), and/or an example drill down table with data in the data structure 320. The report generator circuitry 322 may utilize the tables and/or the data structure 320 to build example data visualizations and/or to configure the shift analysis report 324.

At block 2214, the example report manager circuitry 326 provides an example report interface 200a-r for presentation to the market participant requestor. For example, the report manager circuitry 326 may transmit the report interface 200a-r to the electronic device 104 via the user interface circuitry 306 for presentation to the market participant requestor. In some examples, the report manager circuitry 326 may cause the report interface 200a-r to be rendered on the electronic device 104 (e.g., such as if the interactive shift analysis circuitry 114 is implemented as an application 110 executing on the electronic device 104).

At block 2216, the report manager circuitry 326 determines whether a hover request is detected. When the answer to block 2216 is YES, control advances to block 2218 at which the report manager circuitry 326 provides data corresponding to the hover request. For example, the report manager circuitry 326 may provide a net shifting value(s) corresponding to a product in the chord chart 206a-r if a hover point corresponding to the hover request is relative to an inner element 216 or a net shifting change between two inner elements 216 if the hover point is relative to a chord 220. In some examples, the report manager circuitry 326 provides a net shifting value(s), net incrementality value(s), and/or a total sale(s) value in the net incrementality chart 208a-r if the hover point is relative to an example bubble 224. Control then returns to block 2214 at which the report manager circuitry provides another report interface 200a-r to present to the market participant requestor.

When the report manager circuitry 326 does not detect the hover request (e.g., block 2216: NO), the report manager circuitry 326 determines whether an input selection request is detected (block 2220). For example, the input selection request may be detected by receiving a request based on an input selection relative to the report interface 200a-r from the market participant requestor. When the answer to block 2220 is NO, control advances to block 2230.

When the report manager circuitry 326 detects the input selection request (e.g., block 2220: YES), the report manager circuitry 326 determines whether the input selection corresponding to the input selection request is for export of the shift analysis report 324 (block 2222). In the illustrated example of FIG. 22, in the event the example report manager circuitry 326 identifies the selection as a request to export the shift analysis report 324 (e.g., block 2222: YES), control advances to block 2224 at which example export circuitry 330 generates and transmits an example export corresponding to the shift analysis report 324. For example, the export circuitry 330 may generate an image(s) of one or more data visualizations included in the shift analysis report 324. Control then advances to block 2214. On the other hand, when the report manager circuitry 326 does not determine the selection is to export the shift analysis report 324 (e.g., block 2220: NO), control advances to block 2226

At block 2226, the report manager circuitry 326 determines whether the input selection request is for additional data. For example, the additional data may correspond to a secondary menu, a pop-up chart, a pop-up visual, etc. When the report manager circuitry 326 does not identify the input selection request for additional data (e.g., block 2226: NO), control advances to block 2230. On the other hand, when the answer to report manager circuitry 326 identifies the input selection request for additional data (e.g., block 2226: YES), control advances to block 2228 at which the report manager circuitry 326 adjusts the report interface 200a-r based on the input selection request. Control then returns to block 2214.

At block 2230, the report manager circuitry 326 determines whether to close the report interface 200a-r. For example, the report manager circuitry 326 may determine to close the interactive interface 200a-r in response to a lost connection, a request to close the report, etc. If the answer to block 2230 is NO, control returns to block 2214. If the answer to block 2230 is YES, the report manager circuitry 326 closes the report interface 200a-r.

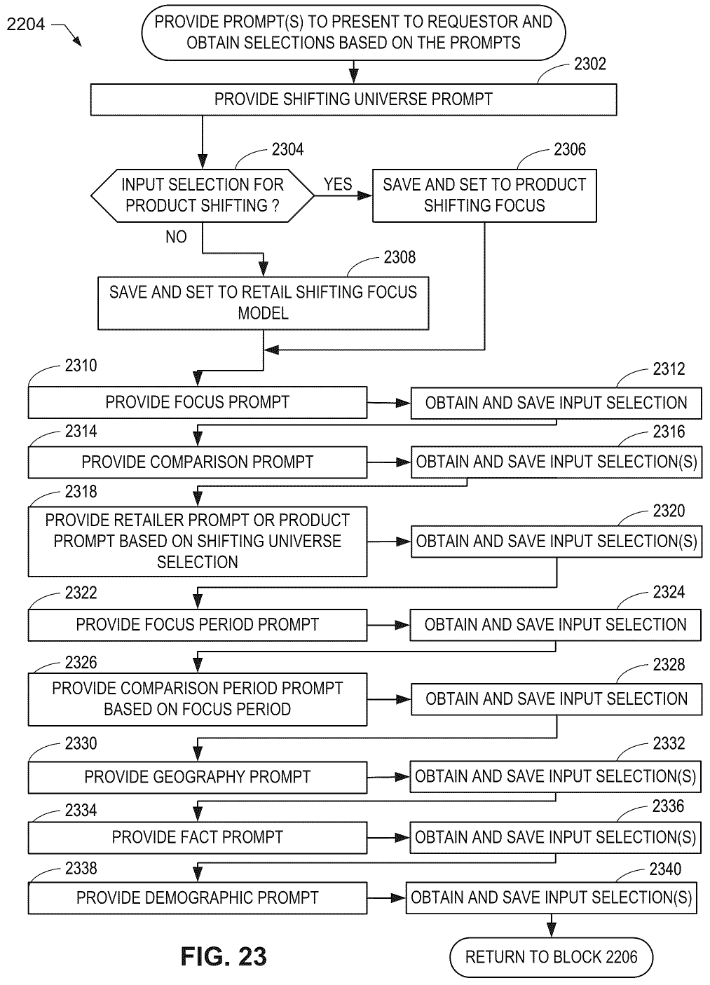

FIG. 23 is a flowchart representative of example machine readable instructions and/or example operations 2204 that may be executed and/or instantiated by processor circuitry to provide prompts to present to the market participant requestor and obtain input selections based on the prompts. The machine readable instructions and/or the operations 2204 of FIG. 23 begin at block 2302, at which the example request generator circuitry 312 provides a shifting universe prompt. The request generator circuitry 312 determines whether an example input selection for the shifting universe prompt is for product shifting. When the input selection is for the product shifting universe, the request generator circuitry 312 saves the input selection and sets the shifting universe to an example product shifting focus (block 2306). Control then advances to block 2310. When the input selection for the shifting universe prompt is not for product shifting, the request generator circuitry 213 saves the input selection and sets the shifting universe to an example retailer shifting focus (block 2308). Control then advances to block 2310.

The request generator circuitry 312 provides an example focus prompt (block 2310) and obtains and saves a corresponding input selection (block 2312). For example, if the shifting universe is set to the retailer shifting focus, the focus prompt may be a focus retailer prompt. On the other hand, if the shifting universe is set to the product shifting focus, the focus prompt may be a focus product prompt.

The request generator circuitry 312 provides an example comparison prompt (block 2314) and obtains and saves a corresponding input selection(s) (block 2316). For example, if the shifting universe is set to the retailer shifting focus, the comparison prompt may be a comparison retailer prompt. On the other hand, if the shifting universe is set to the product shifting focus, the comparison prompt may be a comparison product prompt.

The request generator circuitry 312 provides an example retailer prompt or an example product prompt based on the shifting universe input selection (block 2318) and obtains and saves a corresponding input selection (block 2320). For example, if the shifting universe is set to the retailer shifting focus, the request generator circuitry 312 may provide the product prompt. On the other hand, if the shifting universe is set to the product shifting focus, the request generator circuitry 312 may provide a retailer prompt.

The request generator circuitry 312 provides an example focus period prompt (block 2322) and obtains and saves a corresponding input selection (block 2324). The focus period prompt may request a most recent period of time for comparison. For example, the focus period may be a most-recent year (e.g., 52 weeks). However, the period of time can refer to a quarter, a month, a number of years, and/or another period of time in other examples. In some examples, the focus period prompt includes a default selection of the most-recent year that can be changed by the market participant requestor.

The request generator circuitry 312 provides an example comparison period prompt based on the focus period input selection (block 2326) and obtains and saves a corresponding input selection (block 2328). The comparison period is another period of time that is different than the focus period. In some examples, the comparison period is to be equal in length and non-overlapping with the focus period. In some examples, the comparison period prompt includes a default selection of a year before the most-recent year, which can be changed by the market participant requestor.

The request generator circuitry 312 provides an example geography prompt (block 2330) and obtains and saves a corresponding input selection(s) (block 2332). The geography prompt may be an open, single selection prompt that allows a market participant requestor to select a geography of interest, such as (but not limited to) a country (e.g., the U.S.), a specific geographic area (e.g., Midwest), etc. In some examples, the geography prompt includes a default selection (e.g., U.S. total) that can be changed by the market participant requestor.

The request generator circuitry 312 provides an example fact prompt (block 2334) and obtains and saves a corresponding input selection(s) (block 2336). The fact prompt may be a closed, single selection prompt that allows a market participant requestor to select a fact of interest from a static list of facts, such as value, volume, units, units (multi), etc. In some examples, the fact prompt may include a default selection (e.g., value) that can be changed by the market participant requestor.

The request generator circuitry 312 provides an example demographic prompt (block 2338) and obtains and saves a corresponding input selection(s) (block 2340). The demographic prompt may be an open, single selection prompt that allows a market participant requestor to select a demographic corresponding to a panel or panel member. In some examples, the demographic prompt may include a default selection (e.g., total panel) that can be changed by the market participant requestor. Control then returns to block 2206 of FIG. 22.

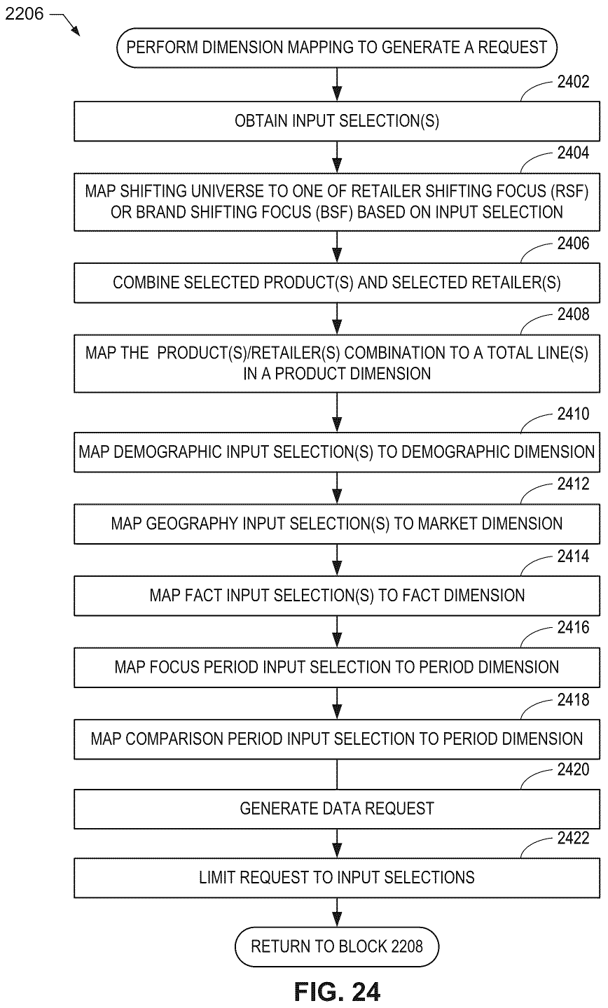

FIG. 24 is a flowchart representative of example machine readable instructions and/or example operations 2206 that may be executed and/or instantiated by processor circuitry to perform dimension mapping to generate an example data request 316. The machine readable instructions and/or the operations 2206 of FIG. 24 begin at block 2402, at which the example request generator circuitry 312 obtains the input selection(s) to the front-end user prompts. The request generator circuitry 312 maps the shifting universe to one of a retailer shifting focus (RSF) or a brand shifting focus (BSF) based on the input selection (block 2404).

The request generator circuitry 312 combines the selected product(s) and selected retailer(s) (block 2406) and maps the product(s)/retailer(s) combination(s) to a total line(s) in a product dimension (block 2408).

The request generator circuitry 312 also maps the demographic input selection(s) to an example demo group dimension (block 2410). For example, the request generator circuitry 312 may map the demographic(s) to a demo group in a panel dimension of a back-end aggregation system. The request generator circuitry 312 also maps the geography input selection(s) to an example market dimension (block 2412). For example, the request generator circuitry 312 may map the geography(ies) to a market(s) in a market dimension of the back-end aggregation system.

The request generator circuitry 312 also maps the fact input selection(s) to an example fact dimension (block 2414). For example, the request generator circuitry 312 may map the fact(s) to a fact dimension in the back-end aggregation system. The request generator circuitry 312 also maps the focus period input selection to an example period dimension (block 2416) and the comparison period input selection to the example period dimension (block 2418). For example, the request generator circuitry 312 may map the two periods to a time dimension in the back-end aggregation system.

At block 2420, the request generator circuitry 312 generates the example data request 316 based on the mappings. For example, based on the input selections to the prompts, the request generator circuitry 312 develop the data request 316 based on mappings of the front end prompts to dimensions and terminology used in the database engine circuitry 116 of FIG. 1. The data request 316 may include, for example, a shifting universe model on which to base the data request 316, product identifiers, retail identifiers, a market identifier, a demographic of interest, and two periods of time from which to retrieve market data. In some examples, the request generator circuitry 312 limits the request to the input selections (block 2422). The is, the request generator circuitry 312 may include a limitation in the data request 316 that limits an amount of market data available to generate the shift analysis report to the input selections to the prompts. Control then returns to block 2208 of FIG. 22.

FIG. 25 is a flowchart representative of example machine readable instructions and/or example operations 2212 that may be executed and/or instantiated by processor circuitry to generates the example shift analysis report. The machine readable instructions and/or the operations 2212 of FIG. 25 begin at block 2502, at which the example report generator circuitry 322 generates an example chord chart table (block 2502), an example bubble chart table (block 2504), an example net shifting table (block 2506), and an example drill down table (block 2508). For example, the report generator circuitry 322 may utilize the data structure 320 provided by the database engine circuitry 116 to populate specification tables.

At block 2510, the report generator circuitry 322 applies an example volume shift analysis visualization model(s) 310 to generate example data visualizations for presentation to the market participant requestor. The report generator circuitry 322 configures the shift analysis report using the data structure 320 and the generated data visualizations.

FIG. 26 is a flowchart representative of example machine readable instructions and/or example operations 2216 that may be executed and/or instantiated by processor circuitry to display data corresponding to a hover request. The machine readable instructions and/or the operations 2216 of FIG. 26 begin at block 2602, at which the example report manager circuitry 326 identifies an example hover point 804, 1810 corresponding to the detected hover request. In the illustrated example of FIG. 26, the report manager circuitry 326 determines whether the hover point 804, 1810 is in the chord chart 206a-r (block 2604). When the hover point 804, 1810 is in the chord chart 206a-r (e.g., block 2604: YES), the report manger circuitry 326 identifies which example entity 216, 218, 220 in the chord chart 206a-r at which the hover point is 802 is positioned (block 2606). For example, the hover point 804 may be at an example outer element 218, an example inner element 216, or an example chord 220. In response to identifying the entity 216, 218, 220, the report manger circuitry 326 provides shift analysis data corresponding to the focus entity 216a, 218a, 220a (block 2608). Control then returns to block 2214 of FIG. 22.

When the report manager circuitry 326 determines the hover point 804, 1810 is not in the chord chart 206a-r, (block 2604: NO), the report manager circuitry 326 determines whether the hover point 804, 1810 is in the net incrementality chart 208a-r (block 2610). When the hover point 1810 is in the net incrementality chart 208a-r (e.g., block 2610: YES), the report manger circuitry 326 identifies which example bubble 224 in the bubble chart 208a-r at which the hover point 1810 is detected (block 2612). In response to identifying the hover point 1810 at the bubble 224a, the report manger circuitry 326 provides shift analysis data corresponding to the bubble 224a, which is retrieved from the net incrementality table 1902 (block 2614).

On the other hand, when the report manager circuitry 326 determines the hover point 804, 1810 is not in the bubble chart 208a-r, (e.g., block 2610: NO), the report manager circuitry 326 determines not to provide additional data (bock 2616). Control then returns to block 2214 of FIG. 22.

FIG. 27 is a flowchart representative of example machine readable instructions and/or example operations 2224 that may be executed and/or instantiated by processor circuitry to adjust the report interface 200a-r based on the input selection request. The machine readable instructions and/or the operations 2224 of FIG. 27 begin at block 2702, at which the example report manager circuitry 326 identifies the input selection request for additional data, which corresponds to a point of selection within the report interface 200a-r. For example, the point of selection may be relative to an example legend request icon 210a, b and correspond to a legend request, to an example pin request icon 910 and correspond to a pin request, etc.

At block 2704 the report manager circuitry 326 determines whether the input selection request is for an example legend 502, 2002. When the input selection request is for the legend 502, 2002 (e.g., block 2704: YES), the report manager circuitry 326 provides the legend 502, 2002 for presentation (block 2706). Control then advances to block 2732 at which the report manager circuitry 326 adjust the report interface 200a-r based on the input selection request.

When the input selection request is not for the legend 502, 2002 (e.g., block 2704: NO), the report manager circuitry 326 determines whether the input selection request is for an example pop-up context menu 902 (block 2708). For example, the market participant requestor may request the pop-up context menu 902 in response to a desire to pin an item, drill down into an item, or to copy a value. When the input selection request is for the pop-up context menu 902 in the chord chart 206a-k (e.g., block 2708: YES), the report manager circuitry 326 provides the pop-up context menu 902. Control then advances to block 2732.

On the other hand, when the input selection request is not for the pop-up context menu 902 (e.g., block 2708: NO), the report manager circuitry 326 determines whether the input selection request is to pivot the chords chart 206a-k (block 2712). For example, the chord chart 206a-r in the report interface 200a-r may depict a retailer focused view. The market participant requestor may input the input selection request to pivot the chord chart 206a-r to a product focused view for presenting in another report interface 200a-r. When the answer to block 2712 is YES, control advances to block 2714 at which the report manager circuitry 326 pivots the chord chart 206a-r. When the answer to block 2712 is NO, control advances to block 2716.

At block 2716, the report manager circuitry 326 determines whether the input selection request is for a search request. For example, the market participant request may utilize an example search bar 504 in an example legend 502 to search for a particular brand to further refine the chord chart 206a-r. The search bar 504 may enable the market participant requestor to search for other information in additional or alternative examples, such as a product or a retailer. When the input selection request is for the search request (block 2716: YES), control advances to block 2718 at which the report manager circuitry 326 identifies search results for the search request and adjusts the chord chart 206a-r accordingly. For example, a search for a brand (e.g., Brand A) may refine which products and corresponding shift analysis data are depicted in the legend 502 and in the entities 216, 218, 220 in the chord chart 206a-r. That is, the legend 502 and the chord chart 206a-r may be adjusted to illustrate products corresponding only to Brand A. Control then advances to block 2732.

When the answer to block 2716 is NO, the report manager circuitry 326 determines whether the input selection request is to adjust a net shifting value range (block 2720). For example, the market participant requestor may request to change a level of shifting illustrated in the chord chart 206a-r by utilizing an example slider icon tool 1302 to adjust an example low net shifting value indicator 1308a, b and/or an example high net shifting value indicator 1310a, b, which, in turn, adjusts an example net shifting range bar 1312a, b representing the range of net shifting values. When the input selection request is a request to adjust the net shifting value range (e.g. block 2720: YES), control advances to block 2722 at which the report manager circuitry 326 adjusts the chord chart 206a-r to reflect the change. For example, the report manager circuitry 326 may remove shift analysis data represented in the chord chart 206a-r in the report interface 200a-r that are outside the new range of net shifting values. Control then advances to block 2732.

When the answer to block 2720 is NO, the report manager circuitry 326 determines whether the input selection request is to hide an example entity 216, 218, 220 (block 2724). For example, the report interface 200a-r may include an example entity conceal request icon 702a that enables the market participant requestor to request removal or concealment of shift analysis data for one or more market entities 216, 218, 220 plotted in the chord chart 206a-r. When the entity conceal request icon 702a is selected by the market participant requestor, a corresponding request may be transmitted to the report manager circuitry 326. When the input selection request is a request to hide the entity 216, 218, 220 (e.g., block 2724: YES), control advances to block 2726 at which the report manager circuitry 326 removes or conceals shift analysis data corresponding to the request from respective entities 216, 218, 220 in the chord chart 206a-r. Control then advances to block 2732.

When the answer to block 2724 is NO, the report manager circuitry 326 determines whether the input selection request is to pivot the bubble chart 208a-r (block 2728). For example, the report interface 200a-r may include an example pivot request icon 221b, which, when selected by the market participant requestor, allows the market participant requestor to request a pivot of the bubble chart(s) 208o to the net incrementality table 1902. When the input selection request is the pivot request corresponding to the bubble chart 208a-r (e.g., block 2728: YES), the report manager circuitry 326 replaces the bubble chart 208a-r with the net incrementality table 1902 (block 2730). When the input selection request is not the pivot request (e.g., block 2728: NO), control returns to block 2230 of FIG. 22.

FIG. 28 is a flowchart representative of example machine readable instructions and/or example operations 2710 that may be executed and/or instantiated by processor circuitry to adjust the shift analysis report according to the selection. The machine readable instructions and/or the operations 2710 of FIG. 28 begin at block 2802, at which the report manager circuitry 326 provides the example pin option 904, the example drill down option 906, and the example copy value option 908 via the pop-up context menu 902.

At block 2804, the report manager circuitry 326 determines whether a pin option request is detected. By selecting the pin option 904, for example, the market participant request to requestor may request that a focus entity 216, 218, 220 and entities associated therewith remain emphasized. When the report manager circuitry 326 detects the pin option request (e.g., block 2804: YES), control advances to block 2806.

At block 2806, the report manager circuitry 326 provides chord chart 206a-r with pinned entities that correspond to the request. For example, the report manager circuitry 326 exaggerates a focus entity 216a corresponding an product to which the pin option request was generated. Further, the report manager circuitry 326 exaggerates chords 220 extending from the focus entity 216a and inner elements 216 to which the exaggerated chords extend 220. Control then returns to block 2732 of FIG. 27.

When the report manager circuitry 326 does not detect the pin option request (e.g., block 2804: NO), control advances to block 2808 at which the report manager circuitry 326 determines whether the copy value option selection is detected. For example, the copy value option 908 enables the market participant requestor request storing of a net shifting value in the respective pop-up visual 802 as a copy function. If the answer to block 2808 is YES, control advances to block 2810 at which the report manager circuitry 326 causes storage of the net shifting value represented in respective pop-up visual 802. Control then returns to block 2732 of FIG. 27. When the answer to block 2808 is NO, control advances to block 2812.

At block 2812, the report manager circuitry 326 determines whether a drill down option request is detected. For example, the drill down option 906 enables the market participant requestor to request an example pop-up chart 1502a, b. When the drill down option request is detected (e.g., block 2812: YES), the report manager circuitry 326 retrieves data for the drill down (block 2814), generates the drill down tab (block 2816) and provides the drill down tab (2818) for presentation to the market participant requestor. An example pop-up chart 1502a, for example, includes an example shifting gain bar chart 1504 illustrating an example top competitive item 1506 from which the focus item 806 gained volume and an example shifting loss bar chart 1508 illustrating an example top competitive item 1510 from which the focus item 806 lost volume, which is based on shift analysis data in the shift analysis report 324. Control then returns to block 2732 of FIG. 27.

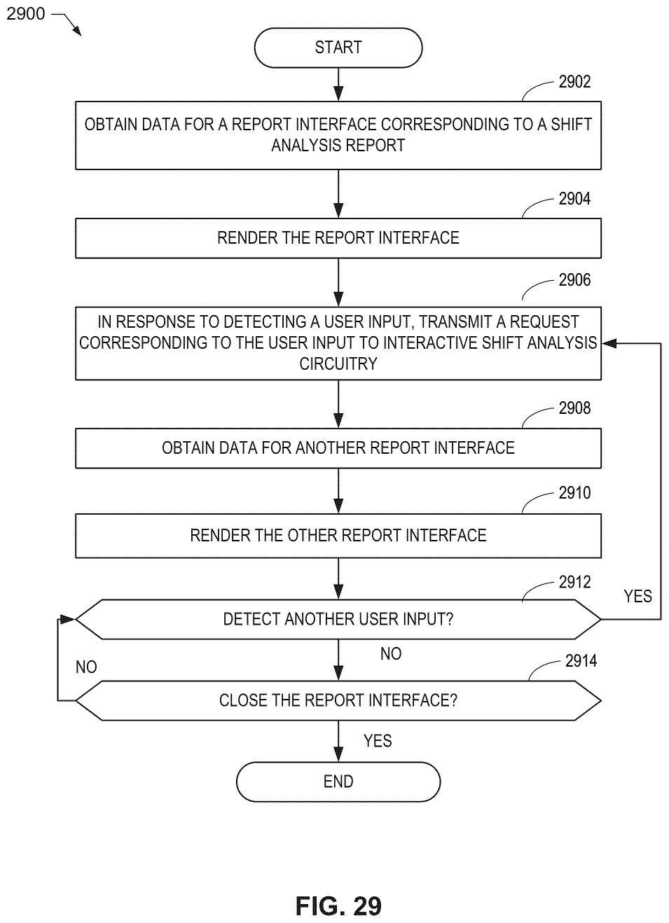

FIG. 29 is a flowchart representative of example machine readable instructions and/or example operations 2900 that may be executed and/or instantiated by processor circuitry to receive data for an example report interface 200a-r corresponding to an example shift analysis report 324. The machine readable instructions and/or the operations 2900 of FIG. 29 begin at block 2902, at which the example user interface circuitry 108 obtains data for an example first example report interface 200a-r. At block 2904, the user interface circuitry 108 renders the first report interface 200a-r. At block 2906, in response to detecting a user input via an input device 3022, the user interface circuitry 108 transmits a request corresponding to the user input to the example interactive shift analysis circuitry 114 via the example network 106. At block 2908, the user interface circuitry 108 obtains data for an example second report interface 200a-r. At block 2910, the user interface circuitry 108 renders the second report interface 200a-r. At block 2912, the user interface circuitry 108 determines whether another user input is detected. When the answer to block 2912 is NO, control returns to block 1912. When the answer to block 2912 is YES, the user interface circuitry 108 determines whether to close the report interface (block 2914). When the answer to block 2914 is NO, control returns to block 2912. When the answer to block 1914 is YES, the user interface circuitry 108 closes the interface report.

FIG. 30 is a block diagram of an example processor platform 3000 structured to execute and/or instantiate machine readable instructions and/or the operations of FIG. 29 to implement the user interface circuitry 108 of FIG. 1. The processor platform 3000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a gaming console, or any other type of computing device.

The processor platform 3000 of the illustrated example includes processor circuitry 3012. The processor circuitry 3012 of the illustrated example is hardware. For example, the processor circuitry 3012 can be implemented by one or more integrated circuits, logic circuits, FPGAs, microprocessors, CPUs, GPUs, DSPs, and/or microcontrollers from any desired family or manufacturer. The processor circuitry 3012 may be implemented by one or more semiconductor based (e.g., silicon based) devices. In this example, the processor circuitry 3012 implements the example user interface circuitry 108.

The processor circuitry 3012 of the illustrated example includes a local memory 3013 (e.g., a cache, registers, etc.). The processor circuitry 3012 of the illustrated example is in communication with a main memory including a volatile memory 3014 and a non-volatile memory 3016 by a bus 3018. The volatile memory 3014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 3016 may be implemented by flash memory and/or any other desired type of memory device. Access to the main memory 3014, 3016 of the illustrated example is controlled by a memory controller 3017.

The processor platform 3000 of the illustrated example also includes interface circuitry 3020. The interface circuitry 3020 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 3022 are connected to the interface circuitry 3020. The input device(s) 3022 permit(s) a user to enter data and/or commands into the processor circuitry 3012. The input device(s) 3022 can be implemented by, for example, an audio sensor, a microphone, a camera (still or video), a keyboard, a button, a mouse, a touchscreen, a track-pad, a trackball, an isopoint device, and/or a voice recognition system.

One or more output devices 3024 are also connected to the interface circuitry 3020 of the illustrated example. The output device(s) 3024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 3020 of the illustrated example, thus, typically includes a graphics driver card, a graphics driver chip, and/or graphics processor circuitry such as a GPU.

The interface circuitry 3020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 3026. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 3000 of the illustrated example also includes one or more mass storage devices 3028 to store software and/or data. Examples of such mass storage devices 3028 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 3032, which may be implemented by the machine readable instructions of FIG. 29, may be stored in the mass storage device 3028, in the volatile memory 3014, in the non-volatile memory 3016, and/or on a removable non-transitory computer readable storage medium such as a CD or DVD.

FIG. 31 is a block diagram of an example processor platform 3100 structured to execute and/or instantiate the machine readable instructions and/or the operations of FIGS. 22-28 to implement the interactive shift analysis circuitry 114 of FIGS. 1 and 3. The processor platform 3100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing device.

The processor platform 3100 of the illustrated example includes processor circuitry 3112. The processor circuitry 3112 of the illustrated example is hardware. For example, the processor circuitry 3112 can be implemented by one or more integrated circuits, logic circuits, FPGAs, microprocessors, CPUs, GPUs, DSPs, and/or microcontrollers from any desired family or manufacturer. The processor circuitry 3112 may be implemented by one or more semiconductor based (e.g., silicon based) devices. In this example, the processor circuitry 3112 implements the example processor circuitry 302, the example user interface circuitry 306, the example request generator circuitry 312, the example database engine interface circuitry 318, the example report generator circuitry 322, the example report manager circuitry 326, the example export circuitry 330, and/or, more generally, the example interactive shift analysis circuitry 114.

The processor circuitry 3112 of the illustrated example includes a local memory 3113 (e.g., a cache, registers, etc.). The processor circuitry 3112 of the illustrated example is in communication with a main memory including a volatile memory 3114 and a non-volatile memory 3116 by a bus 3118. The volatile memory 3114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 3116 may be implemented by flash memory and/or any other desired type of memory device. Access to the main memory 3114, 3116 of the illustrated example is controlled by a memory controller 3117.

The processor platform 3100 of the illustrated example also includes interface circuitry 3120. The interface circuitry 3120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 3122 are connected to the interface circuitry 3120. The input device(s) 3122 permit(s) a user to enter data and/or commands into the processor circuitry 3112. The input device(s) 3122 can be implemented by, for example, an audio sensor, a microphone, a camera (still or video), a keyboard, a button, a mouse, a touchscreen, a track-pad, a trackball, an isopoint device, and/or a voice recognition system.

One or more output devices 3124 are also connected to the interface circuitry 3120 of the illustrated example. The output device(s) 3124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 3120 of the illustrated example, thus, typically includes a graphics driver card, a graphics driver chip, and/or graphics processor circuitry such as a GPU.

The interface circuitry 3120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 3126. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 3100 of the illustrated example also includes one or more mass storage devices 3128 to store software and/or data. Examples of such mass storage devices 3128 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 3132, which may be implemented by the machine readable instructions of FIGS. 22-28, may be stored in the mass storage device 3128, in the volatile memory 3114, in the non-volatile memory 3116, and/or on a removable non-transitory computer readable storage medium such as a CD or DVD.

FIG. 32 is a block diagram of an example implementation of the processor circuitry 3112 of FIG. 31. In this example, the processor circuitry 3112 of FIG. 31 is implemented by a microprocessor 3200. For example, the microprocessor 3200 may be a general purpose microprocessor (e.g., general purpose microprocessor circuitry). The microprocessor 3200 executes some or all of the machine readable instructions of the flowcharts of FIGS. 22-28 to effectively instantiate the circuitry of FIGS. 1 and/or 3 as logic circuits to perform the operations corresponding to those machine readable instructions. In some such examples, the circuitry of FIGS. 1 and/or 3 is instantiated by the hardware circuits of the microprocessor 3200 in combination with the instructions. For example, the microprocessor 3200 may be implemented by multi-core hardware circuitry such as a CPU, a DSP, a GPU, an XPU, etc. Although it may include any number of example cores 3202 (e.g., 1 core), the microprocessor 3200 of this example is a multi-core semiconductor device including N cores. The cores 3202 of the microprocessor 3200 may operate independently or may cooperate to execute machine readable instructions. For example, machine code corresponding to a firmware program, an embedded software program, or a software program may be executed by one of the cores 3202 or may be executed by multiple ones of the cores 3202 at the same or different times. In some examples, the machine code corresponding to the firmware program, the embedded software program, or the software program is split into threads and executed in parallel by two or more of the cores 3202. The software program may correspond to a portion or all of the machine readable instructions and/or operations represented by the flowcharts of FIGS. 22-28.

The cores 3202 may communicate by a first example bus 3204. In some examples, the first bus 3204 may be implemented by a communication bus to effectuate communication associated with one(s) of the cores 3202. For example, the first bus 3204 may be implemented by at least one of an Inter-Integrated Circuit (I2C) bus, a Serial Peripheral Interface (SPI) bus, a PCI bus, or a PCIe bus. Additionally or alternatively, the first bus 3204 may be implemented by any other type of computing or electrical bus. The cores 3202 may obtain data, instructions, and/or signals from one or more external devices by example interface circuitry 3206. The cores 3202 may output data, instructions, and/or signals to the one or more external devices by the interface circuitry 3206. Although the cores 3202 of this example include example local memory 3220 (e.g., Level 1 (L1) cache that may be split into an L1 data cache and an L1 instruction cache), the microprocessor 3200 also includes example shared memory 3210 that may be shared by the cores (e.g., Level 2 (L2 cache)) for high-speed access to data and/or instructions. Data and/or instructions may be transferred (e.g., shared) by writing to and/or reading from the shared memory 3210. The local memory 3220 of each of the cores 3202 and the shared memory 3210 may be part of a hierarchy of storage devices including multiple levels of cache memory and the main memory (e.g., the main memory 3114, 3116 of FIG. 31). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 3202 may be referred to as a CPU, DSP, GPU, etc., or any other type of hardware circuitry. Each core 3202 includes control unit circuitry 3214, arithmetic and logic (AL) circuitry (sometimes referred to as an ALU) 3216, a plurality of registers 3218, the local memory 3220, and a second example bus 3222. Other structures may be present. For example, each core 3202 may include vector unit circuitry, single instruction multiple data (SIMD) unit circuitry, load/store unit (LSU) circuitry, branch/jump unit circuitry, floating-point unit (FPU) circuitry, etc. The control unit circuitry 3214 includes semiconductor-based circuits structured to control (e.g., coordinate) data movement within the corresponding core 3202. The AL circuitry 3216 includes semiconductor-based circuits structured to perform one or more mathematic and/or logic operations on the data within the corresponding core 3202. The AL circuitry 3216 of some examples performs integer based operations. In other examples, the AL circuitry 3216 also performs floating point operations. In yet other examples, the AL circuitry 3216 may include first AL circuitry that performs integer based operations and second AL circuitry that performs floating point operations. In some examples, the AL circuitry 3216 may be referred to as an Arithmetic Logic Unit (ALU). The registers 3218 are semiconductor-based structures to store data and/or instructions such as results of one or more of the operations performed by the AL circuitry 3216 of the corresponding core 3202. For example, the registers 3218 may include vector register(s), SIMD register(s), general purpose register(s), flag register(s), segment register(s), machine specific register(s), instruction pointer register(s), control register(s), debug register(s), memory management register(s), machine check register(s), etc. The registers 3218 may be arranged in a bank as shown in FIG. 32. Alternatively, the registers 3218 may be organized in any other arrangement, format, or structure including distributed throughout the core 3202 to shorten access time. The second bus 3222 may be implemented by at least one of an I2C bus, a SPI bus, a PCI bus, or a PCIe bus

Each core 3202 and/or, more generally, the microprocessor 3200 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 3200 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 33 is a block diagram of another example implementation of the processor circuitry 3112 of FIG. 31. In this example, the processor circuitry 3112 is implemented by FPGA circuitry 3300. For example, the FPGA circuitry 3300 may be implemented by an FPGA. The FPGA circuitry 3300 can be used, for example, to perform operations that could otherwise be performed by the example microprocessor 3200 of FIG. 32 executing corresponding machine readable instructions. However, once configured, the FPGA circuitry 3300 instantiates the machine readable instructions in hardware and, thus, can often execute the operations faster than they could be performed by a general purpose microprocessor executing the corresponding software.

More specifically, in contrast to the microprocessor 3200 of FIG. 32 described above (which is a general purpose device that may be programmed to execute some or all of the machine readable instructions represented by the flowcharts of FIGS. 22-28 but whose interconnections and logic circuitry are fixed once fabricated), the FPGA circuitry 3300 of the example of FIG. 33 includes interconnections and logic circuitry that may be configured and/or interconnected in different ways after fabrication to instantiate, for example, some or all of the machine readable instructions represented by the flowcharts of FIGS. 22-28. In particular, the FPGA circuitry 3300 may be thought of as an array of logic gates, interconnections, and switches. The switches can be programmed to change how the logic gates are interconnected by the interconnections, effectively forming one or more dedicated logic circuits (unless and until the FPGA circuitry 3300 is reprogrammed). The configured logic circuits enable the logic gates to cooperate in different ways to perform different operations on data received by input circuitry. Those operations may correspond to some or all of the software represented by the flowcharts of FIGS. 22-28. As such, the FPGA circuitry 3300 may be structured to effectively instantiate some or all of the machine readable instructions of the flowcharts of FIGS. 22-28 as dedicated logic circuits to perform the operations corresponding to those software instructions in a dedicated manner analogous to an ASIC. Therefore, the FPGA circuitry 3300 may perform the operations corresponding to the some or all of the machine readable instructions of FIGS. 22-28 faster than the general purpose microprocessor can execute the same.

In the example of FIG. 33, the FPGA circuitry 3300 is structured to be programmed (and/or reprogrammed one or more times) by an end user by a hardware description language (HDL) such as Verilog. The FPGA circuitry 3300 of FIG. 33, includes example input/output (I/O) circuitry 3302 to obtain and/or output data to/from example configuration circuitry 3304 and/or external hardware 3306. For example, the configuration circuitry 3304 may be implemented by interface circuitry that may obtain machine readable instructions to configure the FPGA circuitry 3300, or portion(s) thereof. In some such examples, the configuration circuitry 3304 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 3306 may be implemented by external hardware circuitry. For example, the external hardware 3306 may be implemented by the microprocessor 3200 of FIG. 32. The FPGA circuitry 3300 also includes an array of example logic gate circuitry 3308, a plurality of example configurable interconnections 3310, and example storage circuitry 3312. The logic gate circuitry 3308 and the configurable interconnections 3310 are configurable to instantiate one or more operations that may correspond to at least some of the machine readable instructions of FIGS. 22-28 and/or other desired operations. The logic gate circuitry 3308 shown in FIG. 33 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 3308 to enable configuration of the electrical structures and/or the logic gates to form circuits to perform desired operations. The logic gate circuitry 3308 may include other electrical structures such as look-up tables (LUTs), registers (e.g., flip-flops or latches), multiplexers, etc.

The configurable interconnections 3310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 3308 to program desired logic circuits.

The storage circuitry 3312 of the illustrated example is structured to store result(s) of the one or more of the operations performed by corresponding logic gates. The storage circuitry 3312 may be implemented by registers or the like. In the illustrated example, the storage circuitry 3312 is distributed amongst the logic gate circuitry 3308 to facilitate access and increase execution speed.

The example FPGA circuitry 3300 of FIG. 33 also includes example Dedicated Operations Circuitry 3314. In this example, the Dedicated Operations Circuitry 3314 includes special purpose circuitry 3316 that may be invoked to implement commonly used functions to avoid the need to program those functions in the field. Examples of such special purpose circuitry 3316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 3300 may also include example general purpose programmable circuitry 3318 such as an example CPU 3320 and/or an example DSP 3322. Other general purpose programmable circuitry 3318 may additionally or alternatively be present such as a GPU, an XPU, etc., that can be programmed to perform other operations.

Although FIGS. 32 and 33 illustrate two example implementations of the processor circuitry 3112 of FIG. 31, many other approaches are contemplated. For example, as mentioned above, modern FPGA circuitry may include an on-board CPU, such as one or more of the example CPU 3320 of FIG. 33. Therefore, the processor circuitry 3112 of FIG. 31 may additionally be implemented by combining the example microprocessor 3200 of FIG. 32 and the example FPGA circuitry 3300 of FIG. 33. In some such hybrid examples, a first portion of the machine readable instructions represented by the flowcharts of FIGS. 22-28 may be executed by one or more of the cores 3202 of FIG. 32, a second portion of the machine readable instructions represented by the flowcharts of FIGS. 22-28 may be executed by the FPGA circuitry 3300 of FIG. 33, and/or a third portion of the machine readable instructions represented by the flowcharts of FIGS. 22-28 may be executed by an ASIC. It should be understood that some or all of the circuitry of FIGS. 1 and/or 3 may, thus, be instantiated at the same or different times. Some or all of the circuitry may be instantiated, for example, in one or more threads executing concurrently and/or in series. Moreover, in some examples, some or all of the circuitry of FIGS. 1 and/or 3 may be implemented within one or more virtual machines and/or containers executing on the microprocessor.

In some examples, the processor circuitry 3112 of FIG. 31 may be in one or more packages. For example, the microprocessor 3200 of FIG. 32 and/or the FPGA circuitry 3300 of FIG. 33 may be in one or more packages. In some examples, an XPU may be implemented by the processor circuitry 3112 of FIG. 31, which may be in one or more packages. For example, the XPU may include a CPU in one package, a DSP in another package, a GPU in yet another package, and an FPGA in still yet another package.

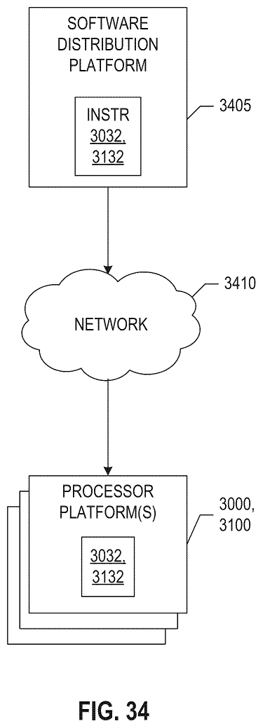

A block diagram illustrating an example software distribution platform 3405 to distribute software such as the example machine readable instructions 3032 of FIG. 30 to hardware devices owned and/or operated by third parties is illustrated in FIG. 34. The example software distribution platform 3405 may be implemented by any computer server, data facility, cloud service, etc., capable of storing and transmitting software to other computing devices. The third parties may be customers of the entity owning and/or operating the software distribution platform 3405. For example, the entity that owns and/or operates the software distribution platform 3405 may be a developer, a seller, and/or a licensor of software such as the example machine readable instructions 3032 of FIG. 30. The third parties may be consumers, users, retailers, OEMs, etc., who purchase and/or license the software for use and/or re-sale and/or sub-licensing. In the illustrated example, the software distribution platform 3405 includes one or more servers and one or more storage devices. The storage devices store the machine readable instructions 3032, which may correspond to the example machine readable instructions 2300 of FIGS. 22-28, as described above. The one or more servers of the example software distribution platform 3405 are in communication with an example network 3410, which may correspond to any one or more of the Internet and/or any of the example networks 106, 3026 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 3032 from the software distribution platform 3405. For example, the software, which may correspond to the example machine readable instructions 2300 of FIGS. 22-28, may be downloaded to the example processor platform 3000, which is to execute the machine readable instructions 3032 to implement the interactive shift analysis circuitry 114. In some examples, one or more servers of the software distribution platform 3405 periodically offer, transmit, and/or force updates to the software (e.g., the example machine readable instructions 3032 of FIG. 30) to ensure improvements, patches, updates, etc., are distributed and applied to the software at the end user devices.

From the foregoing, it will be appreciated that example methods, systems, articles of manufacture, and apparatus have been disclosed that provide for visualization of market shifting analysis using example chord charts. Example chord charts disclosed herein provide a unique presentation of market shifting analysis that depicts two or more retailers, two or more products, and chords mappings among the products and the retailers. Certain example chord charts explode a number of connection datapoints that can be visually examined relative to one-dimensional data visualization techniques. Examples disclosed herein enable plotting a large number of products, enable market participant requestors to visually evaluate and understand volume shift trends and to drill down into specific data points.

Disclosed systems, methods, apparatus, and articles of manufacture improve the efficiency of using a computing device by providing a shift analysis report in a consolidated view. As opposed to conventional techniques that require producing multiple reports for each time of volume shifting (e.g., product shifting, retailer shifting, etc.), disclosed examples enable visualization of overall trends among retailer and products. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture for visualization of market shifting analysis are disclosed herein. Further examples and combinations thereof include the following:
Example 1 includes an apparatus comprising interface circuitry; at least one memory; machine readable instructions; and processor circuitry to at least one of instantiate or execute the machine readable instructions to generate a report based on shift analysis data that compares first market data and second market data to identify volume shift trends among products and retailers; generate a first interface based on the report for presentation to a display, the first interface including a data visualization to represent the volume shift trends among the products and the corresponding retailers; and in response to detecting a request to adjust the first interface, apply an interaction rule to generate a second interface for presentation to the display, the interaction rule based on the request.
Example 2 includes the apparatus of example 1, wherein the first market data corresponds to a first time period and the second market data corresponds to a second time period that is different than the first time period.
Example 3 includes the apparatus of any preceding example, wherein the first market data and the second market data are retrieved from a database based on input selections to prompts, the processor circuitry to at least one of instantiate or execute the machine readable instructions to provide the prompts via a third interface; obtain the input selections corresponding to the prompts; and obtain the shift analysis data from a database engine, the shift analysis data based on a volume shift model applied to the first and second market data.
Example 4 includes the apparatus of any preceding example, wherein the first interface includes icons that, when selected, generate the request to adjust the first interface, ones of the icons associated with respective ones of a set of interaction rules; and wherein the processor circuitry is to at least one of instantiate or execute the machine readable instructions to, in response to detecting a selection for a first icon of the icons, adjust the first interface by applying a first ones of the interaction rules that is associated with the first icon to generate the second interface for presentation to the display.
Example 5 includes the apparatus of any preceding example, wherein the data visualization is a chord chart that identifies sales volume shifts among the products and the corresponding retailers, the chord chart including outer elements representing ones of the products or the corresponding retailers; inner elements nesting within the outer elements, the inner elements representing ones of the products or the corresponding retailers; chords connecting ones of the inner elements, the chords representing the volume shift trends; and wherein each of the outer elements, the inner elements, and the chords include a visual characteristic representative of a corresponding volume shift trend.
Example 6 includes the apparatus of any preceding example, wherein the processor circuitry is to generate the first interface by at least one of instantiating or executing the machine readable instructions to associate first ones of the inner elements with a first color, the first ones of the inner elements associated with a first volume shift trend; associate second ones of the inner elements with a second color that is different than the first color, the second ones of the inner elements associated with a second volume shift trend; and wherein the first volume shift trend corresponds sales growth, and the second volume shift trend corresponds to sales decline.
Example 7 includes the apparatus of any preceding example, wherein the processor circuitry is to at least one of instantiate or execute the machine readable instructions to associate third ones of the inner elements with a third color that is different than the first and second colors, wherein the third ones of the inner elements are not associated with a volume shift.
Example 8 includes the apparatus of any preceding example, wherein the processor circuitry is to generate the first interface by at least one of instantiating or executing the machine readable instructions to associate a first side of a first one of the chords with a first ones of the inner elements based on the shift analysis data, the first side including a first color indicative of sales growth; associate a second side of the first one of the chords with a second one of the inner elements based on the shift analysis data, the second side including a second color indicative of sales decline; and wherein the first ones of the chords indicates that sales volume shifted from the second one of the inner elements to the first one of the inner elements.
Example 9 includes the apparatus of any preceding example, wherein the inner elements correspond to the products and the outer elements correspond to the retailers.
Example 10 includes the apparatus of any preceding example, wherein the request to adjust the first interface is a request to pivot the chord chart, the processor circuitry to apply the interaction rule to generate the second interface by at least one of instantiating or executing the machine readable instructions to adjust the outer elements to represent the products; adjust the inner elements to represent the retailers; and adjust the chords based on the shift analysis data.
Example 11 includes the apparatus of any preceding example, wherein the request to adjust the first interface is a request to display a secondary data visualization that identifies a first portion of the shift analysis data corresponding to the products plotted in the chord chart, the processor circuitry to apply the interaction rule to generate the second interface by at least one of instantiating or executing the machine readable instructions to generate a legend based on the first portion of the shift analysis data; and add the legend to the first interface to generate the second interface.
Example 12 includes the apparatus of any preceding example, wherein the request to adjust the first interface is a request to pin a first inner element representing a first product associated with a first retailer, the processor circuitry to apply the interaction rule to generate the second interface by at least one of instantiating or executing the machine readable instructions to identify first chords of the chords that extend from the first inner element; identify second inner elements of the inner elements that are associated with the first chords; and cause exaggeration of the visual characteristics of the first inner element, the second inner elements, and the first chords.
Example 13 includes the apparatus of any preceding example, wherein the request to adjust the first interface is corresponds to an input hover, the processor circuitry to apply the interaction rule to generate the second interface by at least one of instantiating or executing the machine readable instructions to identify a hover point of the hover; retrieve shift analysis data corresponding to a first volume shift trend associated with the hover point; and add a pop-up visual that identifies the first volume shift trend to the first interface to generate the second interface.
Example 14 includes the apparatus of any preceding example, wherein the data visualization is a bubble chart that plots bubbles representing combinations of the products and the retailers relative to respective net shifting values and incrementality values, and wherein the request to adjust the first interface is a request to pivot the bubble chart, the processor circuitry to apply the interaction rule to generate the second interface by at least one of instantiating or executing the machine readable instructions to replacing the bubble chart with a sortable table, the sortable table to include first shift analysis data that is plotted in the bubble chart.
Example 15 includes a non-transitory machine readable storage medium comprising instructions that, when executed, cause processor circuitry to at least generate a report based on shift analysis data that identifies volume shifts among products and retailers from a first period relative to a second period; generate a report interface based on the report for presentation to a display, the report interface including a data visualization to represent the volume shifts among the products and corresponding retailers; and in response to detecting a request to adjust the report interface, apply a set of interaction rules to adjust the report interface.
Example 16 includes the non-transitory machine readable storage medium of example 15, wherein the shift analysis data is based on first market data corresponding to the first period and second market data corresponding to the second period.
Example 17 includes the non-transitory machine readable storage medium of any preceding example, wherein the first market data and the second market data are retrieved from a datastore based on selections to prompts, the instructions, when executed, cause to processor circuitry to at least provide the prompts via a prompt interface; obtain the selections corresponding to the prompts; and obtain the shift analysis data from a database engine, the shift analysis data based on a volume shift model applied to the first and second market data.
Example 18 includes the non-transitory machine readable storage medium of any preceding example, wherein the report interface includes icons that, when selected, transmit the request to adjust the report interface, ones of the icons associated with respective ones of the set of interaction rules; and wherein the instructions, when executed, cause the processor circuitry to at least, in response to detecting an icon request for a first one of the icons, adjust the report interface by applying a respective first one of the interaction rules.
Example 19 includes the non-transitory machine readable storage medium of any preceding example, wherein the data visualization is a chord chart that identifies sales volume shifts among the products and the corresponding retailers, the chord chart including inner sections representing ones of the products or the corresponding retailers; outer sections surrounding the inner sections, the outer sections representing ones of the products or the corresponding retailers; chord connections associating ones of the inner sections, the chords connections representing the volume shifts; and wherein each of the inner sections, the outer sections, and the chords connections include a visual characteristic representative of a corresponding volume shift direction.
Example 20 includes the non-transitory machine readable storage medium of any preceding example, wherein the instructions, when executed, cause the processor circuitry to generate the report interface by associating first ones of the inner sections with a first color, the first ones of the inner sections associated with a first volume shift direction;
associating second ones of the inner sections with a second color that is different than the first color, the second ones of the inner sections associated with a second volume shift direction; and wherein the first volume shift direction corresponds sales growth, and the second volume shift direction corresponds to sales decline.
Example 21 includes the non-transitory machine readable storage medium of any preceding example, wherein the instructions, when executed, cause the processor circuitry to associate third ones of the inner sections with a third color that is different than the first and second colors, wherein the third ones of the inner sections are not associated with a volume shift.
Example 22 includes the non-transitory machine readable storage medium of any preceding example, wherein the instructions, when executed, cause the processor circuitry to generate the report interface by associating a first side of a first one of the chord connections with a first ones of the inner sections based on the shift analysis data, the first side including a first color indicative of sales growth; associating a second side of the first one of the chord connections with a second one of the inner sections based on the shift analysis data, the second side including a second color indicative of sales decline; and wherein the first ones of the chord connections indicates that sales volume shifted from the second one of the inner sections to the first one of the inner sections.
Example 23 includes the non-transitory machine readable storage medium of any preceding example, wherein the inner sections correspond to the products and the outer sections correspond to the retailers.
Example 24 includes the non-transitory machine readable storage medium of any preceding example, wherein the request to adjust the report interface is a request to pivot the chord chart, the instructions, when executed, to cause the processor circuitry to apply the set of interaction rules to adjust the report interface by adjusting the outer sections to represent the products; adjusting the inner sections to represent the retailers; and adjusting the chord connections based on the shift analysis data.
Example 25 includes the non-transitory machine readable storage medium of any preceding example, wherein the request to adjust the report interface is a request to display a secondary data visualization that identifies a first portion of the shift analysis data corresponding to the products plotted in the chord chart, the instructions, when executed, to cause the processor circuitry to apply the set of interaction rules to adjust the report interface by generating a legend based on the first portion of the shift analysis data; and adding the legend to the report interface.
Example 26 includes the non-transitory machine readable storage medium of any preceding example, wherein the request to adjust the report interface is a request to pin a first inner section representing a first product associated with a first retailer, the instructions, when executed, to cause the processor circuitry to apply the set of interaction rules to adjust the report interface by identifying first chord connections of the chord connections that extend from the first inner section; identifying second inner sections of the inner sections that are associated with the first chord connections; and causing exaggeration of the visual characteristics of the first inner section, the second inner sections, and the first chord connections.
Example 27 includes the non-transitory machine readable storage medium of any preceding example, wherein the request to adjust the report interface corresponds to a detected hover, the instructions, when executed, to cause the processor circuitry to apply the set of interaction rules to adjust the report interface by identifying a hover point of the hover; retrieving shift analysis data corresponding to a first volume shift associated with the hover point; and add a secondary visual that identifies the first volume shift to the report interface.
Example 28 includes the non-transitory machine readable storage medium of any preceding example, wherein the data visualization is a net incrementality chart that plots nodes representing combinations of the products and the retailers relative to respective net shifting values and incrementality values, and wherein the request to adjust the report interface is a request to pivot the net incrementality chart, the instructions, when executed, are to cause the processor circuitry to at least apply the set of interaction rules to adjust the report interface by replacing the net incrementality chart with a net incrementality table, the net incrementality table to include first shift analysis data that is plotted in the net incrementality chart.
Example 29 includes a method for competitive shifting visualization comprising generating a report based on market shift data corresponding to multiple products and multiple retailers, the market shift data based on first market data corresponding to a first time period and second market data corresponding to a second time period that is different than the first time period; rendering the first interface based on the report for presentation on a display, the first interface including an chord chart that identifies volume shift trends among the products and corresponding retailers; and adjusting the first interface in response to detecting a request, the adjusting based on interactions rules that define configurable components of the chord chart.
Example 30 includes the method of example 29, wherein the first market data and the second market data are stored from a database, the method further including obtaining the market shift data by rendering prompts via a second interface; obtaining input selections corresponding to the prompts; and transmitting a request for the market shift data from a database engine, the request based in the input selections to the prompts, the market shift data based on a volume shift model applied to the first and second market data.
Example 31 includes the method of any preceding example, wherein the first interface includes icons representing ones of the requests, ones of the icons associated with respective ones of the interaction rules; and wherein, in response to detecting an icon request corresponding to a first ones of the icon, the adjusting the first interface includes applying a first one of the interaction rules that is associated with the first one of the icons.
Example 32 includes the method of any preceding example, further including generating the first interface.
Example 33 includes the method of any preceding example, wherein the chord chart includes entities representing ones of the volume shift trends, the entities including first entities representing ones of the products or the corresponding retailers; second entities nested within the first entities, the second entities representing ones of the products or the corresponding retailers; third entities connecting ones of the second entities, the third entities representing the volume shift trends; and wherein each of the first entities, the second entities, and the third entities include a visual characteristic representative of a corresponding volume shift trend.
Example 34 includes the method of any preceding example, wherein the generating the first interface includes associating first ones of the second entities with a first color, the first ones of the second entities associated with a first volume shift trend; associate second ones of the second entities with a second color that is different than the first color, the second ones of the second entities associated with a second volume shift trend; and wherein the first volume shift trend corresponds sales growth, and the second volume shift trend corresponds to sales decline.
Example 35 includes the method of any preceding example, wherein the generating the first interface includes associating third ones of the second entities with a third color that is different than the first and second colors, wherein the third ones of the second entities are not associated with a volume shift.
Example 36 includes the method of any preceding example, wherein the generating the first interface includes associating a first side of a first one of the third entities with a first one of the second entities based on the market shift data, the first side including a first color indicative of sales growth; associating a second side of the first one of the third entities with a second one of the second entities based on the market shift data, the second side including a second color indicative of sales decline; and wherein the first one of the third entities indicates a sales volume shift from the second one of the second entities to the first one of the second entities.
Example 37 includes the method of any preceding example, wherein the second entities correspond to the products and the first entities correspond to the retailers.
Example 38 includes the method of any preceding example, wherein the request corresponds to a pivot request relative to the chord chart, and the adjusting the first interface based on the interactions rules includes adjusting the first entities to represent the products; adjusting the second entities to represent the retailers; and adjusting the third entities based on the market shift data.
Example 39 includes the method of any preceding example, wherein the request to adjust the first interface is wherein the request corresponds to a request to display a secondary data visualization that identifies a first portion of the market shift data corresponding to the products plotted in the chord chart, and the adjusting the first interface based on the interactions rules includes generating a legend based on the first portion of the market shift data; and adding the legend to the first interface.
Example 40 includes the method of any preceding example, wherein the request corresponds to a pin request to pin one of the second entities in the chord chart, and the adjusting the first interface based on the interactions rules includes identifying first ones of the third entities that extend from the one of the second entities; identifying second ones of the second entities that are associated with the one of the third entities; and cause exaggeration of the visual characteristics of the first ones of the second entities, the second ones of the second entities, and the one of the third entities.
Example 41 includes the method of any preceding example, wherein the request corresponds to an input hover request relative to the chord chart, and the adjusting the first interface based on the interactions rules includes identifying a hover point of the hover; retrieving market shift data corresponding to a first volume shift trend associated with the hover point; and adding a secondary visual that identifies the first volume shift trend to the first interface.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus comprising:
interface circuitry;
at least one memory;
machine readable instructions; and
processor circuitry to at least one of instantiate or execute the machine readable instructions to:
generate a report based on shift analysis data that compares first market data and second market data to identify volume shift trends among products and retailers;
generate a first interface based on the report for presentation to a display, the first interface including a data visualization to represent the volume shift trends among the products and corresponding retailers; and
in response to detecting a request to adjust the first interface, apply an interaction rule to generate a second interface for presentation to the display, the interaction rule based on the request.

2. (canceled)

3. (canceled)

4. The apparatus of claim 1, wherein the first interface includes icons that, when selected, generate the request to adjust the first interface, ones of the icons associated with respective ones of a set of interaction rules; and
wherein the processor circuitry is to at least one of instantiate or execute the machine readable instructions to, in response to detecting a selection for a first icon of the icons, adjust the first interface by applying a first ones of the interaction rules that is associated with the first icon to generate the second interface for presentation to the display.

5. The apparatus of claim 1, wherein the data visualization is a chord chart that identifies sales volume shifts among the products and the corresponding retailers, the chord chart including:
outer elements representing ones of the products or the corresponding retailers;
inner elements nesting within the outer elements, the inner elements representing ones of the products or the corresponding retailers;
chords connecting ones of the inner elements, the chords representing the volume shift trends; and
wherein each of the outer elements, the inner elements, and the chords include a visual characteristic representative of a corresponding volume shift trend.

6. The apparatus of claim 5, wherein the processor circuitry is to generate the first interface by at least one of instantiating or executing the machine readable instructions to:
associate first ones of the inner elements with a first color, the first ones of the inner elements associated with a first volume shift trend;
associate second ones of the inner elements with a second color that is different than the first color, the second ones of the inner elements associated with a second volume shift trend; and
wherein the first volume shift trend corresponds sales growth, and the second volume shift trend corresponds to sales decline.

7. The apparatus of claim 6, wherein the processor circuitry is to at least one of instantiate or execute the machine readable instructions to associate third ones of the inner elements with a third color that is different than the first and second colors, wherein the third ones of the inner elements are not associated with a volume shift.

8. The apparatus of claim 5, wherein the processor circuitry is to generate the first interface by at least one of instantiating or executing the machine readable instructions to:
associate a first side of a first one of the chords with a first ones of the inner elements based on the shift analysis data, the first side including a first color indicative of sales growth;
associate a second side of the first one of the chords with a second one of the inner elements based on the shift analysis data, the second side including a second color indicative of sales decline; and
wherein the first ones of the chords indicates that sales volume shifted from the second one of the inner elements to the first one of the inner elements.

9. The apparatus of claim 5, wherein the inner elements correspond to the products and the outer elements correspond to the retailers.

10. The apparatus of claim 9, wherein the request to adjust the first interface is a request to pivot the chord chart, the processor circuitry to apply the interaction rule to generate the second interface by at least one of instantiating or executing the machine readable instructions to:
adjust the outer elements to represent the products;
adjust the inner elements to represent the retailers; and
adjust the chords based on the shift analysis data.

11. The apparatus of claim 5, wherein the request to adjust the first interface is a request to display a secondary data visualization that identifies a first portion of the shift analysis data corresponding to the products plotted in the chord chart, the processor circuitry to apply the interaction rule to generate the second interface by at least one of instantiating or executing the machine readable instructions to:
generate a legend based on the first portion of the shift analysis data; and
add the legend to the first interface to generate the second interface.

12. The apparatus of claim 5, wherein the request to adjust the first interface is a request to pin a first inner element representing a first product associated with a first retailer, the processor circuitry to apply the interaction rule to generate the second interface by at least one of instantiating or executing the machine readable instructions to:
identify first chords of the chords that extend from the first inner element;
identify second inner elements of the inner elements that are associated with the first chords; and
cause exaggeration of the visual characteristics of the first inner element, the second inner elements, and the first chords.

13. The apparatus of claim 5, wherein the request to adjust the first interface is corresponds to an input hover, the processor circuitry to apply the interaction rule to generate the second interface by at least one of instantiating or executing the machine readable instructions to:
identify a hover point of the hover;
retrieve shift analysis data corresponding to a first volume shift trend associated with the hover point; and
add a pop-up visual that identifies the first volume shift trend to the first interface to generate the second interface.

14. The apparatus of claim 1, wherein the data visualization is a bubble chart that plots bubbles representing combinations of the products and the retailers relative to respective net shifting values and incrementality values, and wherein the request to adjust the first interface is a request to pivot the bubble chart, the processor circuitry to apply the interaction rule to generate the second interface by at least one of instantiating or executing the machine readable instructions to replacing the bubble chart with a sortable table, the sortable table to include first shift analysis data that is plotted in the bubble chart.

15. A non-transitory machine readable storage medium comprising instructions that, when executed, cause processor circuitry to at least:
generate a report based on shift analysis data that identifies volume shifts among products and retailers from a first period relative to a second period;
generate a report interface based on the report for presentation to a display, the report interface including a data visualization to represent the volume shifts among the products and corresponding retailers; and
in response to detecting a request to adjust the report interface, apply a set of interaction rules to adjust the report interface.

16.-18. (canceled)

19. The non-transitory machine readable storage medium of claim 15, wherein the data visualization is a chord chart that identifies sales volume shifts among the products and the corresponding retailers, the chord chart including:
inner sections representing ones of the products or the corresponding retailers;
outer sections surrounding the inner sections, the outer sections representing ones of the products or the corresponding retailers;
chord connections associating ones of the inner sections, the chords connections representing the volume shifts; and
wherein each of the inner sections, the outer sections, and the chords connections include a visual characteristic representative of a corresponding volume shift direction.

20. The non-transitory machine readable storage medium of claim 19, wherein the instructions, when executed, cause the processor circuitry to generate the report interface by:
associating first ones of the inner sections with a first color, the first ones of the inner sections associated with a first volume shift direction;
associating second ones of the inner sections with a second color that is different than the first color, the second ones of the inner sections associated with a second volume shift direction; and
wherein the first volume shift direction corresponds sales growth, and the second volume shift direction corresponds to sales decline.

21. (canceled)

22. The non-transitory machine readable storage medium of claim 19, wherein the instructions, when executed, cause the processor circuitry to generate the report interface by:
associating a first side of a first one of the chord connections with a first ones of the inner sections based on the shift analysis data, the first side including a first color indicative of sales growth;
associating a second side of the first one of the chord connections with a second one of the inner sections based on the shift analysis data, the second side including a second color indicative of sales decline; and
wherein the first ones of the chord connections indicates that sales volume shifted from the second one of the inner sections to the first one of the inner sections.

23. The non-transitory machine readable storage medium of claim 19, wherein the inner sections correspond to the products and the outer sections correspond to the retailers.

24. The non-transitory machine readable storage medium of claim 23, wherein the request to adjust the report interface is a request to pivot the chord chart, the instructions, when executed, to cause the processor circuitry to apply the set of interaction rules to adjust the report interface by:
adjusting the outer sections to represent the products;
adjusting the inner sections to represent the retailers; and
adjusting the chord connections based on the shift analysis data.

25.-28. (canceled)

29. A method for competitive shifting visualization comprising:
generating a report based on market shift data corresponding to multiple products and multiple retailers, the market shift data based on first market data corresponding to a first time period and second market data corresponding to a second time period that is different than the first time period;
rendering a first interface based on the report for presentation on a display, the first interface including a chord chart that identifies volume shift trends among the products and corresponding retailers; and
adjusting the first interface in response to detecting a request, the adjusting based on interactions rules that define configurable components of the chord chart.

30. (canceled)

31. (canceled)

32. The method of claim 29, further including generating the first interface.

33. The method of claim 32, wherein the chord chart includes entities representing ones of the volume shift trends, the entities including:
first entities representing ones of the products or the corresponding retailers;
second entities nested within the first entities, the second entities representing ones of the products or the corresponding retailers;
third entities connecting ones of the second entities, the third entities representing the volume shift trends; and
wherein each of the first entities, the second entities, and the third entities include a visual characteristic representative of a corresponding volume shift trend.

34. The method of claim 33, wherein the generating the first interface includes:
associating first ones of the second entities with a first color, the first ones of the second entities associated with a first volume shift trend;
associate second ones of the second entities with a second color that is different than the first color, the second ones of the second entities associated with a second volume shift trend; and
wherein the first volume shift trend corresponds sales growth, and the second volume shift trend corresponds to sales decline.

35.-41. (canceled)
